(19) United States
(12) Patent Application Publication
(10) Pub. No.: US 2026/0227599 A1
(43) Pub. Date: Aug. 6, 2026

(54) OPTICAL SYSTEM AND CAMERA MODULE

(71) Applicant: LG INNOTEK CO., LTD., Seoul (KR)

(72) Inventor: Ju Yong SHIM, Seoul (KR)

(21) Appl. No.: 19/158,294

(22) PCT Filed: Feb. 20, 2024
(86) PCT No.: PCT/KR2024/002174

§ 371 Date: Aug. 20, 2025

(30) Foreign Application Priority Data
Feb. 20, 2023 (KR) 10-2023-0022188
Feb. 23, 2023 (KR) 10-2023-0024011

(51) Int. Cl. G02B 13/00; G02B 9/12; G02B 9/34

(52) U.S. Cl. CPC G02B 13/0035; G02B 9/12; G02B 9/34; G02B 13/004

(57) ABSTRACT

An optical system disclosed in an embodiment of the invention comprises first to third lenses aligned along an optical axis from an object toward an image sensor, and an optical filter disposed between the second and third lenses, wherein a power of the first lens is negative, and at least one spherical lens adjacent to the object and at least one aspherical lens adjacent to the image sensor among the first to third lenses are includes, the number of spherical lenses among the first to third lenses is greater than the number of aspherical lenses, a center distance between the first lens and the second lens is greater than a center thickness of the first lens, the second lens has a shape in which both sides are convex on the optical axis, and the refractive index of the first to third lenses may be less than 1.9.

### CROSS-REFERENCE TO RELATED APPLICATIONS

This application is the U.S. national stage application of International Patent Application No. PCT/KR2024/002174, filed Feb. 20, 2024, which claims the benefit under 35 U.S.C. § 119 of Korean Application Nos. 10-2023-0022188, filed Feb. 20, 2023; and 10-2023-0024011, filed Feb. 23, 2023; the disclosures of each of which are incorporated herein by reference in their entirety.

### TECHNICAL FIELD

An embodiment relates to an optical system and a camera module including the same.

### BACKGROUND ART

Typically, manned or unmanned vehicles incorporate at least one sensing device, such as LiDAR, a camera, radar, a laser sensor, or an ultrasonic sensor, to perceive their surroundings in real time. Recently, with the rapid development of AI-based image analysis technology, the driving technology of a mobile object that uses only cameras, radars, ultrasonic sensors, etc., instead of using expensive LiDARs, has received a lot of attention. For example, the autopilot system for autonomous driving uses eight cameras to capture 360-degree images up to a range of 250 meters and perform driving control through real-time image analysis. However, the performance requirements of the multiple cameras installed in autonomous vehicles vary depending on their installation location and surveillance direction. For example, an autopilot system typically features three front cameras to comprehensively monitor both close-range and long-range situations. Specifically, a wide-angle camera with a maximum range of 60 meters, a main camera with a maximum range of 150 meters, and a telephoto camera with a maximum range of 250 meters are installed.

However, automotive cameras are inevitably exposed to harsh conditions such as vibration, moisture, high temperatures, and extreme cold. Temperature fluctuations can alter the refractive index of each lens in the optical system, or vibration can cause subtle changes in lens spacing and positioning. This can result in actual optical performance degrading from the designed performance. Cameras installed in autonomous vehicles, in particular, require more stable optical performance, as even slight performance degradation can lead to accidents. Furthermore, telephoto cameras typically have a significantly larger overall length relative to the focal length of their optical system, which can limit vehicle design freedom when installed in a vehicle.

The most critical element for capturing images from a camera is the imaging lens, which forms the image. Recently, interest in high-quality and high-resolution imaging has grown, and research is underway on optical systems that incorporate multiple lenses to achieve these goals. However, the optical system's characteristics can change when exposed to harsh environments inside a vehicle, such as high or low temperatures, moisture, and high humidity. In this case, the camera has the problem of difficulty in uniformly achieving excellent optical and aberration characteristics. Therefore, a new optical system and camera capable of resolving the above-described problems are required.

### DISCLOSURE

### Technical Problem

An embodiment invention provides an optical system and camera module with improved optical characteristics. The embodiment provides an optical system and camera module with superior optical performance in low-temperature to high-temperature environments. The embodiment provides an optical system and camera module capable of inhibiting or minimizing changes in optical characteristics. The embodiment may be applied to in-vehicle or exterior cameras, or to cameras for LiDAR.

### Technical Solution

A receiving optical system according to an embodiment of the invention comprises first to third lenses aligned along an optical axis from an object toward an image sensor; and an optical filter disposed between the second and third lenses, wherein the first lens has a negative power, the first to third lenses comprises at least one spherical lens adjacent to the object and at least one aspherical lens adjacent to the image sensor, a number of spherical lenses among the first to third lenses is greater than a number of aspherical lenses, a center distance between the first lens and the second lens is greater than a center thickness of the first lens, the second lens has a biconvex shape on the optical axis, and the first to third lenses have refractive indices of less than 1.9.

According to an embodiment of the invention, a center distance between the second and third lenses may be less than an edge distance between the second and third lenses. The first lens has a concave sensor-side surface on the optical axis, and the center distance between the first lens and the second lens may be greater than the edge distance between the first lens and the second lens. The third lens may have a biconvex shape on the optical axis, and the sensor-side surface of the third lens may have a critical point between the optical axis and an end of the effective region. The third lens may include an inner aperture stop STop disposed around a region between the first lens and the second lens. An object-side surface of the first lens may be convex on the optical axis, and the optical system may include an upper aperture stop disposed around a periphery of the object-side surface of the first lens. The upper aperture may be arranged between a straight line perpendicular to a apex of the object-side surface of the first lens and a straight line perpendicular to an edge of the object-side surface of the first lens.

According to an embodiment of the invention, the first to third lenses may be made of glass, the first and second lenses may be spherical lenses, and the third lens may be an aspherical lens. The optical axis distance from the center of the object-side surface of the first lens to a surface of the image sensor is TTL, and the optical axis distance from the center of the sensor-side surface of the third lens to the surface of the image sensor is BFL, and may satisfy the following Equation: 3<TTL/BFL<8. The optical axis distance from the center of the object-side surface of the first lens to the surface of the image sensor is TTL, and half of a diagonal length of the image sensor is ImgH, and may satisfy the following Equation: 5<TTL/ImgH<10.

An optical system according to an embodiment of the invention comprises first to fourth lenses aligned along an optical axis from an object toward an image sensor, wherein the first lens has a negative power, the first to fourth lenses includes at least one spherical lens adjacent to the object and at least one aspherical lens adjacent to the image sensor, wherein a number of spherical lenses among the first to fourth lenses is greater than a number of aspherical lenses, wherein a distance between the first lens and the second lens is such that a center distance is greater than an edge distance, and the third lens may include a convex object-side surface and a concave sensor-side surface on the optical axis.

According to an embodiment of the invention, the center distance between the second and third lenses may be less than the edge distance between the second and third lenses. The first lens may include a concave sensor-side surface on the optical axis, and the second lens may include a concave object-side surface on the optical axis. The fourth lens has a biconvex shape on the optical axis, and the object-side surface of the fourth lens may have a critical point between the optical axis and an end of the effective region. It may include an inner aperture stop STop disposed around a region between the second lens and the third lens. The first to fourth lenses may be made of glass, the first to third lenses may be spherical lenses, and the fourth lens may be an aspherical lens.

According to an embodiment of the invention, an optical axis distance from the center of the object-side surface of the first lens to the surface of the image sensor is TTL, and an optical axis distance from the center of the sensor-side surface of the fourth lens to the surface of the image sensor is BFL, and the following Equation may satisfy: 3<TTL/BFL<8.

### Advantageous Effects

An optical system and camera module according to an embodiment may have improved optical characteristics. Specifically, in the optical system according to an embodiment, a plurality of lenses may have set thicknesses, powers, and spacings from adjacent lenses. Accordingly, the optical system and camera module according to an embodiment may have improved MTF characteristics, aberration control characteristics, resolution characteristics, etc. within a set field of view range, and may have excellent optical performance in the periphery of the field of view.

Furthermore, the optical system and camera module according to an embodiment may have excellent optical performance within a temperature range within a moving object, such as a vehicle. Specifically, the plurality of lenses included in the optical system may have set materials, powers, and refractive indices. Accordingly, even when the focal length of each lens changes due to changes in refractive index due to temperature changes, the lenses can compensate for each other. That is, the optical system can effectively distribute power within a temperature range within a moving object, and inhibit or minimize changes in optical characteristics within the temperature range. Therefore, the optical system and camera module according to an embodiment may maintain improved optical characteristics across a variety of temperature ranges.

The optical system and camera module according to the embodiment can achieve excellent optical characteristics while satisfying a set field of view through a combination of aspherical and spherical lenses. This allows the optical system to provide a slimmer vehicle camera module. Therefore, the optical system and camera module may be used in various applications and devices, and can maintain excellent optical characteristics even in harsh temperature environments, such as when exposed to the exterior of a vehicle or in the high temperatures of a vehicle interior during summer.

The embodiment can improve the reliability of in-vehicle and exterior cameras, or LiDAR cameras.

### DESCRIPTION OF DRAWINGS

FIG. 1 is a side cross-sectional view of an optical system according to a first embodiment and a camera module including the same.

FIG. 2 is a side cross-sectional view illustrating the relationship between the n-th and n−1th lenses of FIG. 1.

FIG. 3 is a table showing lens characteristics of the optical system of FIG. 1.

FIG. 4 is a table showing the aspherical coefficient of the n-th lens in the optical system of FIG. 1.

FIG. 5 is a table showing the thickness of each lens and the spacing between adjacent lenses in the optical system of FIG. 1.

FIG. 6 is a graph showing data on the diffraction MTF (Modulation transfer function) of the optical system of FIG. 1.

FIG. 7 is a graph showing data on the aberration characteristics of the optical system of FIG. 1.

FIG. 8 is a table showing data on relative illumination (RI) according to the height of the image sensor of the optical system of FIG. 1.

FIG. 9 is a diagram comparing the incidence angles of the chief ray, upper ray, and lower ray incident on the optical filter and image sensor according to sensor height relative to the optical axis in the optical system of FIG. 1.

FIG. 10 is a cross-sectional side view of an optical system according to a second embodiment and a camera module including the same.

FIG. 11 is a cross-sectional side view illustrating the relationship between the n-th and n-1th lenses of FIG. 10.

FIG. 12 is a table showing lens characteristics of the optical system of FIG. 10.

FIG. 13 is a table showing the aspherical coefficient of the n-th lens in the optical system of FIG. 10.

FIG. 14 is a table showing the thickness of each lens and the spacing between adjacent lenses in the optical system of FIG. 10.

FIG. 15 is a graph showing data on the diffraction MTF of the optical system of FIG. 10.

FIG. 16 is a graph showing data on the aberration characteristics of the optical system of FIG. 10.

FIG. 17 is a table showing relative illumination (RI) data according to the height of the image sensor of the optical system of FIG. 10.

FIG. 18 is an example of a vehicle having an optical system according to an embodiment of the invention.

### BEST MODE

Hereinafter, preferred embodiments of the invention will be described in detail with reference to the accompanying drawings. A technical spirit of the invention is not limited to some embodiments to be described, and may be implemented in various other forms, and one or more of the components may be selectively combined and substituted for use within the scope of the technical spirit of the invention. In addition, the terms (including technical and scientific terms) used in the embodiments of the invention, unless specifically defined and described explicitly, may be interpreted in a meaning that may be generally understood by those having ordinary skill in the art to which the invention pertains, and terms that are commonly used such as terms defined in a dictionary should be able to interpret their meanings in consideration of the contextual meaning of the relevant technology.

The terms used in the embodiments of the invention are for explaining the embodiments and are not intended to limit the invention. In this specification, the singular forms also may include plural forms unless otherwise specifically stated in a phrase, and in the case in which at least one (or one or more) of A and (and) B, C is stated, it may include one or more of all combinations that may be combined with A, B, and C. In describing the components of the embodiments of the invention, terms such as first, second, A, B, (a), and (b) may be used. Such terms are only for distinguishing the component from other component, and may not be determined by the term by the nature, sequence or procedure etc. of the corresponding constituent element. And when it is described that a component is “connected”, “coupled” or “joined” to another component, the description may include not only being directly connected, coupled or joined to the other component but also being “connected”, “coupled” or “joined” by another component between the component and the other component. In addition, in the case of being described as being formed or disposed “above (on)” or “below (under)” of each component, the description includes not only when two components are in direct contact with each other, but also when one or more other components are formed or disposed between the two components. In addition, when expressed as “above (on)” or “below (under)”, it may refer to a downward direction as well as an upward direction with respect to one element.

In the description of the invention, “object-side surface” may refer to a surface of the lens facing the object side with respect to the optical axis OA, and “sensor-side surface” may refer to a surface of the lens facing the imaging surface (image sensor) with respect to the optical axis. A convex surface of the lens may mean that the lens surface on the optical axis or the paraxial region has a convex shape, and a concave surface of the lens may mean that the lens surface on the optical axis or the paraxial region has a concave shape. A curvature radius, center thickness, and distance between lenses described in the table for lens data may mean values on the optical axis, and the unit is mm. The vertical direction may mean a direction perpendicular to the optical axis, and an end of the lens or the lens surface may mean the end or edge of the effective region of the lens through which the incident light passes. The effective diameter on the lens surface may have a measurement error of up to ±0.4 mm depending on the measurement method. The paraxial region refers to a very narrow region near the optical axis, and is a region in which a distance at which a light ray falls from the optical axis OA is almost zero. Hereinafter, the optical axis may include the center of each lens or a very narrow area near the optical axis.

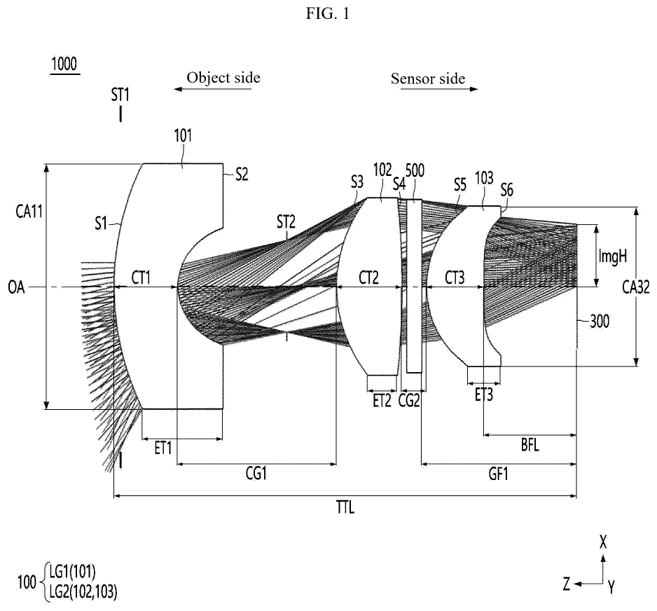

As shown in FIG. 1, the optical system 1000 according to the first embodiment of the invention may include a plurality of lens groups LG1 and LG2, and may include a first lens group LG1 and a second lens group LG2 sequentially arranged along the optical axis OA from an object toward an image sensor 300. The number of lenses of each of the first lens group LG1 and the second lens group LG2 may be different. The optical axis distance of the first lens group LG1 may be smaller than the optical axis distance of the second lens group LG2. The optical axis distance of the first lens group LG1 is a distance in the optical axis from the first surface S1 to the second surface S2, and the optical axis distance of the second lens group LG2 is a distance on the optical axis from the third surface S3 to the sixth surface S6. The first lens group LG1 may include at least one lens, for example, a single lens. The second lens group LG2 may include two or more lenses, for example, two lenses. The optical system 1000 may include n lenses, where the n-th lens is closest to the image sensor 300, and the n−1th lens is closest to the n-th lens. n is an integer less than or equal to 4, for example, 3. The lenses within the optical system 1000 or the area where the lenses are arranged may be defined as a lens unit 100.

The first lens group LG1 may include at least one glass lens. The first lens group LG1 may provide a glass lens as the lens closest to the object. This glass material exhibits minimal expansion and contraction changes due to external temperature changes and has a surface that is less susceptible to scratches, thereby inhibiting surface damage. The lenses of the first lens group LG1 may have a spherical lens surface. The second lens group LG2 may include a plurality of lenses made of glass. The second lens group LG2 may include lenses having a spherical lens surface and lenses having an aspherical lens surface. The lenses having the spherical surface may be made of glass. The lens having the aspherical surface may be made of glass or plastic, for example, glass. Here, the spherical lens is a lens in which the object-side surface and the sensor-side surface of the lens are spherical on the optical axis, and the aspherical lens is a lens in which the object-side surface and the sensor-side surface of the lens are aspherical on the optical axis. The aspherical lens in the second lens group LG2 may be made of a glass mold material. The lenses made of the glass mold material are lenses that are injection-molded to have an aspherical surface using a glass material. The optical system 1000 may include at least one spherical lens adjacent to the object and at least one aspherical lens adjacent to the image sensor 300. Furthermore, the number of spherical lenses may be greater than the number of aspherical lenses, thereby improving the assembly of the spherical lenses with the lens barrel.

The second lens group LG2 may include at least one spherical lens and at least one aspherical lens. The number of aspherical lenses in the second lens group LG2 may be equal to the number of spherical lenses. Here, the n-th lens, the lens closest to the image sensor 300, may be provided as an aspherical lens to inhibit degradation of optical performance. The aspherical lens can inhibit spherical aberration within the optical system 1000 and suppress aberration even as the effective diameter increases, thereby improving the miniaturization and weight reduction of the camera module. The optical system 1000 utilizes a combination of spherical and aspherical lenses to enable thermal compensation within the lens barrel and suppress degradation of optical characteristics due to temperature changes. Furthermore, since the optical system 1000 includes at least one aspherical lens, the occurrence of various aberrations may be suppressed.

The lenses of the optical system 1000 may have Abbe numbers ranging from 20 to 50, and refractive indices ranging from 1.5 to 2.0. The Abbe numbers and refractive indices can control chromatic dispersion by the lenses. Here, the lens with the minimum refractive index may be the last lens, and the lens with the maximum Abbe number may be the last lens. The refractive index of the i-th lens is Ndi, the Abbe number of the i-th lens is Adi, and the value of Ndi*Adi may be maximum when i is 3. Furthermore, a value of Ndi*Adi of 60 or greater may be achieved when i=4. Within the optical system 1000, a lens 102 having a minimum effective diameter may satisfy the condition that the value of Ndi*Adi is 60≤(Ndi*Adi)<85, where * represents multiplication.

Within the lens unit 100, the lens surface having the maximum effective diameter is a spherical lens and may be positioned closest to the object. The lens surface having the maximum effective diameter may refract incident light across the entire region and improve incidence efficiency. Furthermore, the lens 101 having the maximum effective diameter is a spherical lens or a glass lens. The lens 101 closest to the object may have the largest difference in effective diameter between the object-side surface and the sensor-side surface. The lens 103 having the minimum effective diameter is an aspherical lens or a glass lens. The lens 103 having the minimum effective diameter may be positioned adjacent to the sensor side of the aperture stop ST2 positioned between the lenses and the image sensor 300. The lens 103 closest to the image sensor 300 may be made of an aspherical lens or glass. The first embodiment of the invention combines spherical and aspherical lenses within the optical system 1000, thereby reducing the weight of the camera module, lowering manufacturing costs, and suppressing degradation of optical characteristics due to temperature changes.

Each of the lenses may include an effective region and an ineffective region. The effective region may be a region through which light incident on each lens passes. In other words, the effective region may be defined as an effective region or effective diameter where the incident light is refracted to realize optical characteristics. The ineffective region may be positioned around the effective region and may be defined as a flange portion. The ineffective region may be a region where effective light does not enter each of the plurality of lenses. In other words, the ineffective region may be an area unrelated to the optical characteristics. Furthermore, the end of the ineffective region may be a region fixed to a lens barrel (not shown) or the like that accommodates the lenses.

In the optical system 1000, the TTL (Total top length) may be more than 5 times, for example, more than 5 times and less than 10 times, than ImgH. Preferably, the following condition may satisfy: 5<TTL/ImgH<10. TTL is the optical axis distance from the center of the object-side surface of the first lens 101 to the surface of the image sensor 300. ImgH is a length from the optical axis to the end of the effective region in the diagonal direction of the image sensor 300. ImgH is half of the maximum diagonal length of the effective region of the image sensor 300. The optical system 1000 may have a value of TTL/(2*ImgH) greater than 2.5, for example, greater than 2.5 and less than 5. The optical system 1000 may provide a driver assistance optical system by setting the TTL/(2*ImgH) value to exceed 2.5. The total number of lenses in the first and second lens groups LG1 and LG2 is 5 or less or 4 or less. Accordingly, the optical system 1000 may provide an image without exaggeration or distortion in the formed image.

The optical system 1000 can provide an effective focal length (EFL) of 10 mm or less and a field of view (FOV) of over 80 degrees, and may be provided as a standard optical system in a vehicle camera module. The optical system 1000 may have a wide field of view and reduce the focal length to 10 mm or less. For example, the optical system and camera module according to the embodiment may be applied to a camera module for a lidar equipped in a vehicle. For example, light transmitted by a transmission module is reflected by an object, and the camera module receives the reflected light. These LiDAR camera modules may be selectively applied to devices such as collision warning avoidance systems, blind spot monitors, lane keeping assist, lane departure warning, and adaptive cruise control, and can provide functions that assist drivers and make autonomous driving safer and more comfortable.

The length of the image sensor 300 is the length of the effective region and the maximum length of the diagonal line perpendicular to the optical axis OA. Within the optical system 1000, the number of lenses with an effective diameter greater than the diagonal length of the image sensor 300 may be two or more, for example, three. The diagonal length of the image sensor 300 may be smaller than the effective diameters of the spherical and aspherical lenses.

Within the lens unit 100, the sensor-side surface of the first lens 101, which is closest to the object, may have an effective diameter smaller than the sensor-side surface of the last lens 103, which is closest to the image sensor 300. Accordingly, the center thickness CT1 of the first lens 101 of the optical system may be provided to be thicker than the center thickness CT3 of the last lens 103, and the angle of refraction and chromatic dispersion may be adjusted by the thickness difference between the lenses of the optical system. Accordingly, the deterioration of optical characteristics due to resolution and temperature change within the optical system may be compensated for, the chromatic aberration control characteristics may be improved, and the vignetting characteristics of the optical system 1000 may be improved.

The optical system 1000 may include an aperture stop that controls the amount of incident light. The aperture stop may be one or two. The two aperture stops may be spaced apart from each other. For example, as shown in FIG. 1, the aperture stop of the optical system may include an upper aperture stop ST1 disposed around the object-side surface of the first lens 101 closest to the object, and an inner aperture stop ST2 disposed between the lenses. Here, the upper aperture stop ST1 may be a light-shielding film or a light-shielding film coated around the effective region of the object-side surface of the first lens 101. As another example, the upper aperture stop ST1 may be a part of a lens barrel or a cover covering the lens barrel. The upper aperture stop ST1 may be a first aperture stop, and the inner aperture stop ST2 may be defined as a second aperture or an aperture stop.

In the optical system 1000 according to the first embodiment, the effective diameters of the lens surfaces S1 and S2 disposed between the object and the inner aperture stop ST2 tend to decrease from the object toward the inner aperture stop ST2. In the lens surfaces S3 and S4, S5, and S6 disposed between the inner aperture stop ST2 and the image sensor 300, the effective diameters of the lens surfaces tend to decrease from the inner aperture stop ST2 toward the image sensor 300. Here, the average effective diameter of each lens 102 and 103 from the inner aperture stop ST2 toward the image sensor 300 tends to decrease. Here, the average effective diameter is the average of the effective diameters of the object-side surface and the sensor-side surface of each lens. As another example, when the aperture stop is one, it may be disposed between the first lens group LG1 and the second lens group LG2. Alternatively, the peripheral surface of at least one lens selected from the plurality of lenses may function as an inner aperture stop STop. Specifically, the flange portion of the object-side or sensor-side surface of one lens selected from the lenses of the optical system 1000 may function as an inner aperture stop STop that controls the amount of light.

The first distance CG1 in the optical axis direction between the first lens group LG1 and the second lens group LG2 may be a distance in the optical axis direction between the sensor-side surface of the first lens group LG1 and the object-side surface of the second lens group LG2. The first distance CG1 may be the center distance between adjacent spherical lenses. Furthermore, the first distance CG1 may be greater than the center distance CG2 between adjacent spherical lenses and aspherical lenses. Accordingly, an increase in the effective diameter of the lens located on the sensor side of the inner aperture stop ST2 may be suppressed. Accordingly, the optical system 1000 may be suppressed from increasing in size in a direction orthogonal to the optical axis OA. Here, the first lens group LG1 may include lenses positioned closer to the object side than the inner aperture stop ST2, and the second lens group LG2 may include lenses positioned closer to the sensor side than the inner aperture stop ST2. The first lens group LG1 and the second lens group LG2 may be divided into an object-side lens group and a sensor-side lens group based on the inner aperture stop ST2. The sensor-side surface of the first lens group LG1 may be concave on the optical axis OA, and the object-side surface of the second lens group LG2 may have a convex shape on the optical axis, and the sensor-side surface of the first lens group LG1 and the object-side surface of the second lens group LG2 may face each other.

The optical axis distance of the first lens group LG1 is the optical axis distance from the object-side surface S1 to the sensor-side surface S2. That is, the optical axis distance of the first lens group LG1 is the optical axis distance between the object-side surface S1 and the sensor-side surface S2 of the first lens 101 closest to the object. The optical axis distance of the second lens group LG2 is the optical axis distance between the object-side surface S3 of the lens 102 closest to the object side of the second lens group LG2 and the sensor-side surface S6 of the lens 103 closest to the image sensor 300. The optical axis distance of the second lens group LG2 may be 1.5 times or greater than the optical axis distance of the first lens group LG1. The optical axis distance between the last lens and the image sensor 300 is the BFL, and the BFL may be less than the maximum center thickness of the lenses and may be 4.2 mm or more.

The first lens group LG1 may have negative (−) power, and the second lens group LG2 may have positive (+) power. The lens closest to the object side of the first lens group LG1 may have negative (−) power, and the lens closest to the sensor side among the lenses of the second lens group LG2 may have positive (+) power. When the focal length of the first lens group LG1 is FLG1, and the focal length of the second lens group LG2 is FLG2, the condition of the following Equation may satisfy: FLG2<|FLG1|.

In addition, the number of lenses with negative (−) power within the optical system 1000 may be smaller than the number of lenses with positive (+) power. The number of lenses with negative (−) power may be 45% or less of the total number of lenses, for example, in the range of 23% to 40%. When three or more glass lenses are arranged within the camera module, durability and heat resistance are improved, and the occurrence of internal stress during the lens manufacturing process may be suppressed, and optical performance degradation may be inhibited. In addition, chromatic aberration at a high refractive index may be improved by the glass lens. The first lens group LG1 refracts light incident through the object side in the direction of the optical axis, and the second lens group LG2 can refract light incident through the first lens group LG1 to the periphery of the image sensor 300. The optical axis distance between the first lens group LG1 and the second lens group LG2 may be greater than the minimum center thickness of the lenses.

The average Abbe number of the spherical lenses within the lens unit 100 may be less than the Abbe number of the aspherical lens. The average refractive index of the spherical lenses within the lens unit 100 may be greater than the refractive index of the aspherical lens. The lens closest to the object provides the maximum effective diameter, thereby widening the field of view relative to the focal length. The sum of the refractive indices of the lenses of the lens unit 100 may be 7 or less, for example, in the range of 3 to 7, and the average refractive index may be 1.7 or greater, for example, in the range of 1.7 to 2.0. The sum of the Abbe numbers of each of the lenses may be 150 or less, for example, in the range of 70 to 150, and the average Abbe number may be 35 or less, for example, in the range of 20 to 35. The sum of the center thicknesses of the entire lens may be 9 mm or greater, for example, in the range of 9 mm to 15 mm or 10 mm to 14 mm. The average of the center thicknesses of the entire lens may be 3 mm or greater, for example, in the range of 3 mm to 5 mm. The sum of the center distances between the lenses along the optical axis OA may be 5 mm or greater, for example, in the range of 5 mm to 14 mm or 9 mm to 13 mm, and may be less than the sum of the center thicknesses of the lenses.

Furthermore, the average effective diameter of each lens surface of the lens unit 100 may be 8 mm or greater, for example, in the range of 8 mm to 16 mm or 9 mm to 14 mm. The difference between the maximum and minimum effective diameters of each lens surface may be 7 mm or greater, for example, in the range of 7 mm to 13 mm. Therefore, in an optical system, since the average center thickness of the entire lens is 3 mm or greater and the average effective diameter is 8 mm or greater, the assembly between the lenses and the lens barrel may be improved.

The F number (F #) of the optical system or camera module according to the first embodiment of the invention may be less than 2, for example, in the range of 1.0 to 1.5 or in the range of 1.0 to 1.2. The field of view (diagonal FOV) of the optical system according to the first embodiment of the invention may be greater than 80 degrees, for example, greater than 80 degrees and less than 150 degrees, or in the range of 110 degrees to 135 degrees. Here, the horizontal field of view of the optical system is less than 110 degrees, for example, in the range of 75 degrees to 110 degrees, and may be smaller than the diagonal field of view. The vertical field of view of the optical system is less than 90 degrees, in the range of 60 degrees to 90 degrees, and may be smaller than the horizontal field of view. The horizontal field of view is a field of view measured based on the horizontal length of the image sensor 300, and the vertical field of view is a field of view measured based on the vertical length of the image sensor 300. The image sensor 300 may have, for example, a diagonal sensor length of 8.0 mm+0.5 mm, a horizontal sensor length of 6.400 mm+0.5 mm, and a vertical sensor height of 4.80 mm+0.5 mm. Accordingly, the focus position may be suppressed from changing due to temperature changes, and a vehicle camera may be provided in which various aberrations are well corrected.

When the optical system 1000 has a diagonal FOV of 110 degrees to 135 degrees and includes at least one spherical lens and at least one aspherical lens, the center thickness of the aspherical third lens 103 closest to the image sensor 300 may be the thinnest. Accordingly, the number of glass lenses in the optical system 1000 and the center thickness of the glass lenses can reduce the influence on optical performance, i.e., the change in optical performance due to temperature change from low temperature to high temperature.

The optical system 1000 or camera module may include an image sensor 300. The image sensor 300 may detect light and convert it into an electrical signal. The image sensor 300 may detect light sequentially passing through the lens unit 100. The image sensor 300 may include an element capable of detecting incident light, such as a CCD (Charge coupled device) or a CMOS (Complementary metal oxide semiconductor). Here, the diagonal length of the image sensor 300 may be 50% or less of the maximum effective diameter of the lens surfaces, for example, in the range of 35% to 50% or 35% to 45%.

The optical system 1000 or camera module may include an optical filter 500. The optical filter 500 may be disposed within the second lens group LG2. The optical filter 500 may be disposed between the n-th lens and the n−1th lens. For example, the optical filter 500 may be disposed between the second lens 102 and the third lens 103. In the first embodiment of the invention, at least one lens may be disposed between the inner aperture stop ST2 and the optical filter 500. In addition, at least one lens may be disposed between the optical filter 500 and the image sensor 300. The optical filter 500 may include an infrared filter or an infrared cut-off filter (IR cut-off). The optical filter 500 may pass light of a set wavelength band and filter light of a different wavelength band. When the optical filter 500 includes an infrared filter, it may block radiant heat emitted from external light from being transmitted to the image sensor 300. In addition, the optical filter 500 may transmit visible light and reflect infrared light. The optical filter 500 may pass wavelengths greater than 920 nm, for example, a wavelength band between 920 nm and 960 nm. As another example, the optical filter 500 may pass at least one of the LIDAR wavelengths, for example, 905 nm±20 nm or 1550 nm±20 nm.

A cover glass (not shown) may be disposed on the image sensor 300. The cover glass is disposed between the image sensor 300 and the third lens 103, protecting the upper portion of the image sensor 300 and inhibiting degradation of the image sensor's 300 reliability. The cover glass may be removed.

Since the embodiment is an optical system applied to a vehicle camera, the first lens 101 may be made of glass, even though it is designed using both aspherical and spherical lenses. This is because glass, compared to plastic, is more scratch-resistant and less sensitive to external temperatures. The first lens 101 has a convex shape inside the vehicle, facing the driver, which effectively inhibits foreign matter from accumulating or scratching, and improves the incidence efficiency. This improves the reliability of the driver monitoring camera module. The last lens within the lens unit 100 may be an aspherical lens. Because the last lens is an aspherical lens, its influence on optical characteristics may be reduced. Furthermore, because the last lens is an aspherical lens, chromatic aberration may be corrected and light may be refracted across the entire region of the image sensor 300.

The optical system 1000 according to the embodiment may further include a reflective member (not shown) for modifying the path of light. The reflective member may be implemented as a prism that reflects light incident on the first lens group LG1 toward the lenses. As another example, the optical system 1000 may include a first reflective member positioned on the object side and a second reflective member positioned between the last lens and the image sensor 300. The reflective member, which changes the optical path, may reduce the thickness of the camera module.

The optical system according to the first embodiment of the invention will now be described.

Referring to FIGS. 1 to 3, the optical system 1000 according to the first embodiment includes a lens unit 100, which may include first lenses 101 to third lenses 103 sequentially aligned along an optical axis OA from the object toward the sensor side. Light corresponding to object information may pass through the first lenses 101 to the third lenses 103 and be incident on the image sensor 300. The first lens 101 is a lens of the first lens group LG1 and is the lens closest to the object. The second and third lenses 102 and 103 are lenses of the second lens group LG2, and the third lens 103 is the lens closest to the image sensor 300.

The focal lengths of the first to third lenses 101-103 are F1, F2, and F3. The focal length of the first and second lenses 101 is F1. The composite focal length of the second and third lenses 102 and 103 is F23. The effective focal length of the optical system 1000 is F. Each focal length may satisfy at least one of the following conditions.

$$\vert F 1 \vert < F 3 < F 2. \qquad Condition 1$$

$$F 23 < F 3. \qquad Condition 2$$

$$F < \vert F 1 \vert . \qquad Condition 3$$

$$F * 2 < F 2. \qquad Condition 4$$

Each of the first to third lenses 101, 102, and 103 can have a positive (+) or negative (−) power. The first lens 101 may have negative power. The first lens 101 may include a plastic material or a glass material, and may be, for example, a glass material. The first lens 101 made of a glass material can reduce changes in the center position and the radius of curvature due to temperature changes according to the surrounding environment, and can protect the incident side surface of the optical system 1000. On the optical axis OA, the object-side first surface S1 of the first lens 101 may have a convex shape, and the sensor-side second surface S2 may have a concave shape. The first lens 101 may have a meniscus shape that is convex toward the object on the optical axis. The first lens 101 may be a spherical lens made of a glass material, and the first surface S1 and the second surface S2 may have spherical surfaces. In contrast, the first surface S1 may have a concave shape and the second surface S2 may have a convex shape on the optical axis OA. The first lens 101 may have the thickest thickness among spherical lenses, thereby inhibiting a decrease in rigidity due to external impact, and suppressing a change in optical performance when the temperature changes due to the glass material. In addition, since the spherical surface is applied to the glass material, even if the lens is designed to be thick, the change in the refractive index of light may not be large. Here, the thickness of the lens may be the center thickness. Since the first surface S1 of the first lens 101 has a convex shape and the second surface S2 has a concave shape on the optical axis, the incident light can be refracted in a direction close to the optical axis, and the effective diameter of the second lens 102 may be reduced. At least one or both of the first surface S1 and the second surface S2 may be provided without a critical point from the optical axis OA to the end of the effective region.

The upper aperture stop ST1 may be disposed around the periphery of the first surface S1 of the first lens 101. The position of the upper aperture stop ST1 may be disposed lower than the apex of the first surface S1 of the first lens 101. That is, the position of the upper aperture stop ST1 may be disposed between a straight line perpendicular to the optical axis OA at the apex of the first surface S1 of the first lens 101 and a straight line perpendicular to the optical axis OA at the edge of the first surface S1. The hole diameter of the upper aperture stop ST1 may be larger than the effective diameter of the first surface S1. When the hole diameter of the upper aperture stop ST1 is CA_ST1 and the effective diameter of the first surface S1 is CA11, the following condition may be satisfied.

$$1 < CA\_ST1 / CA 11 < 1.6 \qquad Condition$$

The upper aperture stop ST1 adjusts the incident angle of light incident on the edge of the first surface S1 of the first lens 101, and by adjusting the incident angle, light incident outside the 1.0 field of the image sensor 300, that is, the 1.1 field, may be blocked. That is, since the upper aperture stop ST1 is provided within the above range, it can block invalid light incident outside the 1.0 field, thereby significantly lowering the relative illuminance value incident on the 1.1 field of the image sensor 300. The second lens 102 may be arranged between the first lens 101 and the third lens 103.

The second lens 102 may have positive (+) power on the optical axis OA. The second lens 102 may include a plastic or glass material. For example, the second lens 102 may be provided as a glass material. On the optical axis OA, the object-side third surface S3 of the second lens 102 may have a convex shape, and the sensor-side fourth surface S4 may have a convex shape. The second lens 102 may have a convex shape on both sides on the optical axis. Alternatively, the third surface S3 may be convex, and the fourth surface S4 may be concave. Alternatively, the second lens 102 may have a concave shape on both sides. Alternatively, the third surface S3 may be concave and the fourth surface S4 may be convex. The second lens 102 may be provided as a spherical lens made of glass. The third surface S3 and the fourth surface S4 may be spherical. At least one or both of the third surface S3 and the fourth surface S4 may be provided without a critical point from the optical axis OA to the end of the effective region.

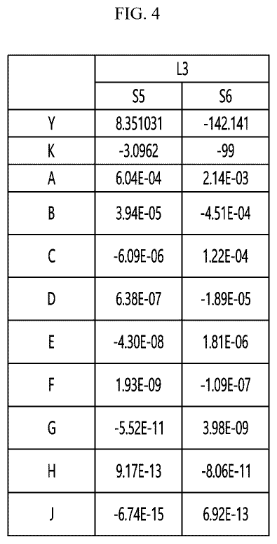

The third lens 103 may have positive (+) power. The third lens 103 may include a plastic or glass material. For example, the third lens 103 may be made of glass. On the optical axis OA, the fifth surface S5 on the object side of the third lens 103 may have a convex shape, and the sixth surface S6 on the sensor side may have a convex shape. The third lens 103 may have a convex shape on both sides on the optical axis OA. Alternatively, the third lens 103 may have a meniscus shape convex toward the sensor side. Alternatively, the third lens 103 may have a concave shape on both sides, or a meniscus shape convex toward the object side. The fifth surface S5 and the sixth surface S6 of the third lens 103 may be aspherical on the optical axis, and the aspherical coefficients may be provided as L3S5 and L3S6 of FIG. 4. At least one or both of the fifth surface S5 and the sixth surface S6 may have at least one critical point from the center to the end of the effective region. For example, the fifth surface S5 may be provided without a critical point from the center to the end of the effective region, and the sixth surface S6 may have a critical point from the center to the end of the effective region. The position of the critical point may be arranged closer to the center than to the end of the effective region of the sixth surface S6. The critical point is a point where the trend of the sag value changes. That is, it is a point where the sag value increases and then decreases, or a point where the sag value decreases and then increases.

The inner aperture stop ST2 is a member that controls the amount of light and may be arranged around the sensor-side surface of the first lens 101. The inner aperture stop ST2 may be disposed around the region between the first lens 101 and the second lens 102. The hole diameter of the inner aperture stop ST2 may have a difference of less than ±35% of the effective diameter of the sensor-side second surface S2 of the first lens 101. Accordingly, the amount of light passing through the first lens 101 may be controlled. For example, the hole diameter of the inner aperture stop ST2 may be smaller than the effective diameter of the second surface S2. When the hole diameter of the inner aperture stop ST2 is CA_ST2 and the effective diameter of the second surface S2 is CA12, the following condition may be satisfied.

$$0.7 < CA\_ST2 / CA 12 < 1.3 or \qquad Condition$$

$$0.73 < CA\_ST2 / CA 12 < 1 , or \qquad Condition$$

$$0.75 < ST1\_CA / CA 12 < 0.9 may satisfy .$$

Since the hole diameter of the inner aperture stop ST2 is provided within the above range, the amount of light passing through the first lens 101 may be controlled, and an increase in the effective diameter of the third surface S3 of the second lens 102 may be suppressed. Since the inner aperture stop ST2 is positioned on the perimeter between the first and second lenses 101 and 102, the difference in effective diameter between the second and third surfaces S2 and S3 of the first and second lenses 101 and 102 may be reduced. The first lens 101 and the second lens 102 on either side of the inner aperture stop ST2 may have opposite powers.

The third lens 103 may be an aspherical lens closest to the image sensor 300. By positioning the aspherical lens closest to the image sensor 300, deterioration of optical performance may be inhibited, aberration characteristics may be improved, and the impact on resolution may be controlled. Furthermore, by positioning the aspherical lens closest to the image sensor 300, it may be less sensitive to assembly tolerances compared to a spherical lens. In other words, being less sensitive to assembly tolerances means that even if assembly is slightly different from the design, optical performance may not be significantly affected. Furthermore, the third lens 103 may provide a small difference between the center thickness CT3 and the edge thickness ET3, thereby improving assembly tolerances.

The center thickness CT1 of the first lens 101 may be thicker than the center thicknesses of the second and third lenses 102 and 103. The edge thickness ET1 of the first lens 101 may be the thickest among the edge thicknesses of the lenses. Since the first lens 101 has a thick thickness and a meniscus shape convex toward the object on the optical axis, the effective diameter of the second surface S2 of the first lens 101 may be reduced, and the center distance CG1 between the first and second lenses 101 and 102 may be increased. Since the second lens 102 has a biconvex shape, the center distance CG2 between the second lens 102 and the third lens 103 may be reduced, and also, in the region between the second lens 102 and the third lens 103, the convex fourth surface S4 and the convex fifth surface S5 can face each other. Since the third lens 103 has a biconvex shape and the center of the sixth surface S6 of the third lens 103 is positioned closer to the object side than the edge, the optical axis distance (i.e., BFL) between the third lens 103 and the image sensor 300 may be increased, and the effective diameter of the third lens 103 may be provided to be larger than the diagonal length of the image sensor 300.

The center distance CG2 between the second and third lenses 102 and 103 may be larger than the thickness of the optical filter 500. In addition, the center distance CG2 between the second and third lenses 102 and 103 may be more than 1 time and less than 2 times the thickness of the optical filter 500. Here, the optical axis distance between the sensor-side sixth surface S6 of the third lens 103 in the image sensor 300 is BFL, the optical axis distance between the lower surface (sensor-side surface) of the optical filter 500 in the image sensor 300 is GF1, and the center distance CG2 between the second and third lenses 102 and 103 is CG2. The following conditions may be satisfied:

$$BFL < GF 1 \qquad Condition 1$$

$$CG 2 < BFL \qquad Condition 2$$

$$FT 1 < CG 2 \qquad Condition 3$$

FT1 is the thickness of the optical filter 500, and the following condition may satisfy: 1<CG2/FT1<2. Accordingly, a space for inserting the optical filter 500 may be secured between the second and third lenses 102 and 103.

The optical filter 500 can output incident light in a parallel manner. If the light is not output in a parallel manner, aberrations may occur. The hole position of the inner aperture stop ST2 may be located in a region similar to the positions of the focal lengths of the first and second lenses 101 and 102. When the focal lengths of the first and second lenses 101 and 102 are F1 and F2, and the center distance between the first and second lenses 101 and 102 is CG1, the conditions for providing the incident light parallel to the object-side surface of the optical filter 500 may satisfy the following.

$$0.5 < \frac{\vert F 1 \vert + \vert F 2 \vert}{CG 1} < 2 \qquad Condition$$

If the condition is less than the lower limit, the center distance CG1 between the first and second lenses 101 and 102 increases, increasing the effective diameter of the second lens 102 and reducing the incidence efficiency of parallel light onto the optical filter 500. If the condition is greater than the upper limit, the effective diameter of the second lens 102 decreases or the radius of curvature of the second surface S2 decreases, making it difficult to control parallel light, and increasing the space required for installing the optical filter 500. Preferably, the condition 0.5< (|F1|+|F2|)/CG1<1.5 may be satisfied. Specifically, 0.5<(|F1|+F2)/CG1<1 may be satisfied.

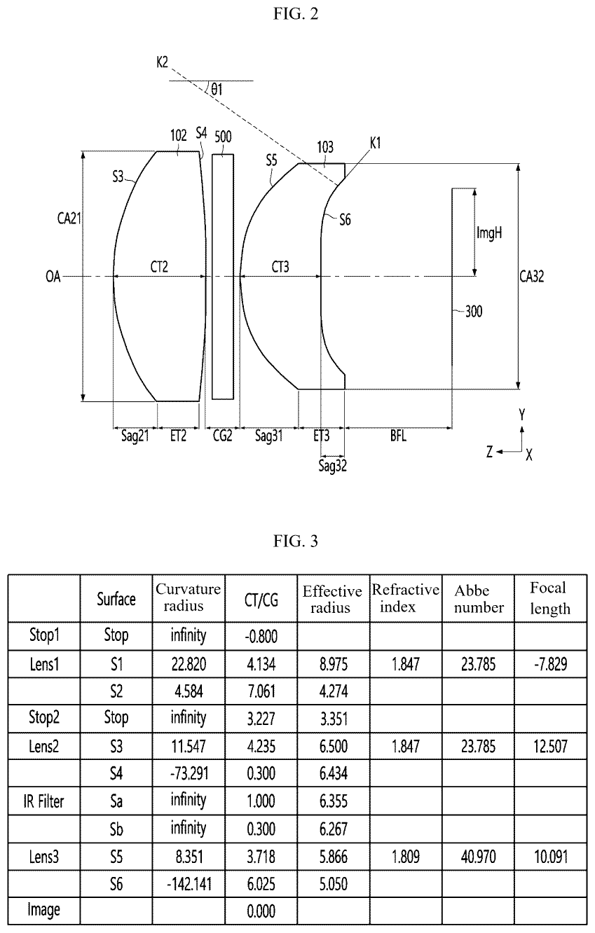

Referring to FIG. 2, the distance in the direction of the optical axis from a straight line perpendicular to the optical axis from the center of the object-side third surface S3 of the second lens 102 to the third surface S3 is Sag21, and the value of Sag21 is the distance between the lens surface disposed on the sensor side with respect to the straight line and the straight line, and may have a positive value. The distance in the direction of the optical axis from a straight line perpendicular to the optical axis from the center of the sensor-side sixth surface S6 of the third lens 103 to the sixth surface S6 is Sag32, and the value of Sag32 is the distance between the lens surface arranged on the object side with respect to the straight line and the straight line, and may have positive or negative value depending on the region. In this manner, the Sag value of the sensor-side fourth surface S4 of the second lens 102 may be defined as Sag22, and has a negative value. The Sag value of the object-side fifth surface S5 of the third lens 103 may be defined as Sag31 and may have a positive value.

The maximum Sag values of the second and third lenses 102 and 103 may satisfy at least one of the following conditions.

$$Max\_Sag31 > Max\_Sag32 \qquad Condition 1$$

$$Max\_Sag31 > Max\_Sag21 \qquad Condition 2$$

$$Max\_Sag21 > Max\_Sag22 \qquad Condition 3$$

Here, the Max_Sag value is the maximum distance in the optical axis direction from a straight line perpendicular to the center of the object-side or sensor-side surface of each lens to the lens surface. The Sag value can have a negative value when located on the object-side surface relative to the straight line perpendicular to the center, and a positive value when located on the sensor-side surface relative to the straight line perpendicular to the center. The Sag value of the object-side first surface S1 of the first lens 101 may be defined as Sag11, and the Sag value of the second surface S2 may be defined as Sag12, and the condition of Max_Sag11<Max_Sag12 may be satisfied. The value of Max_Sag12 may have the largest value among the Max_Sag values of the object-side surface and the sensor-side surface of the lenses.

The BFL (Back focal length) is the optical axis distance from the image sensor 300 to the center of the sensor-side surface of the last lens 103. A tangent line K1 passing through an arbitrary point of the sixth surface S6 of the third lens 103 and a normal line K2 perpendicular to the tangent line K1 may have a predetermined tangent angle θ1 with the optical axis OA. The maximum tangent angle θ1 on the sixth surface S6 in the first direction (X) may be 15 degrees or more, for example, in the range of 15 degrees to 60 degrees or in the range of 20 degrees to 40 degrees, based on an axis parallel to the optical axis.

As shown in FIGS. 1 and 2, CT1, CT2, and CT3 represent the center thicknesses or the thicknesses at the optical axis of the first, second, and third lenses 101-103, and ET1, ET2, and ET3 represent the thicknesses along the optical axis at the edges of the first, second, and third lenses 101-103. The center distance between the first and second lenses 101 and 102 is CG1, and the center distance between the second and third lenses 102 and 103 is CG2. The edge thickness of each lens is the distance along the optical axis between the object-side and the sensor-side at the ends of the effective regions of each lens.

The center thickness and edge thickness of the lenses may satisfy at least one of the following conditions:

$$CT 3 < CT 1 \qquad Condition 1$$

$$CT 1 < CT 2 \qquad Condition 2$$

$$ET 3 < ET 1 \qquad Condition 3$$

$$ET 2 < ET 3 \qquad Condition 4$$

$$CT 2 < ET 1 \qquad Condition 5$$

$$ET 3 * 2 < ET 1 \qquad Condition 6$$

The effective diameters of the first lens 101 to the third lens 103 are the average of the effective diameters of the object-side and sensor-side surfaces, and are defined as CA1, CA2, and CA3. The effective diameters of the object-side and sensor-side surfaces of the first lens 101 to the third lens 103 may be defined as CA11, CA12, CA21, CA22, CA31, and CA32. When the inner aperture stop ST2 is positioned on the sensor-side surface of the first lens 101, at least one of the following conditions may be satisfied:

$$CA 3 < CA 2 < CA 1 \qquad Condition 1$$

$$( ImgH * 2 ) < CA 3 \qquad Condition 2$$

$$CA 12 < CA 31 < CA 22 \qquad Condition 3$$

$$CA 12 < CA 32 < CA 11 \qquad Condition 4$$

Since the first lens 101, positioned on the object side of the inner aperture stop ST2, has a negative power (F1<0) and a convex meniscus shape toward the object, the first lens 101 can refract incident light in a direction closer to the optical axis. Furthermore, since the second and third lenses 102 and 103 have convex shapes on both sides, the edge distance between the second and third lenses 102 and 103 may be greater than the center distance. Accordingly, the center distance CG2 between the second and third lenses 102 and 103 may be reduced, inhibiting a decrease in the yield by weight of the optical system and improving production efficiency. Furthermore, an increase in the effective diameter of the second lens 102, positioned on the sensor side of the inner aperture stop ST2, may be inhibited, and the camera module may be slimmed down within the field of view range.

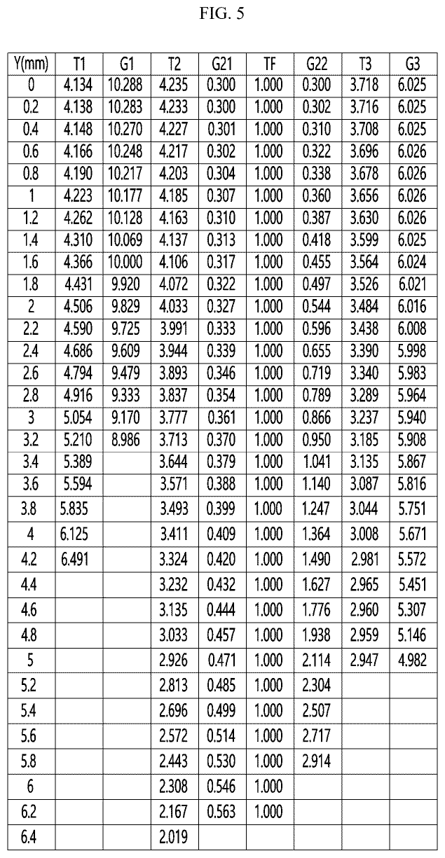

The distance G1 (See FIG. 5) between the first lens 101 and the second lens 102 may gradually decrease from the center to the edge. This distance G1 may gradually decrease from the optical axis toward the edge due to the concave sensor-side surface of the first lens 101 and the convex object-side surface of the second lens 102. That is, the distance G1 between the first and second lenses 101 and 102 may have the largest center distance CG1 and the smallest edge distance. The difference between the center distance CG1 and the edge distance G1 between the first and second lenses 101 and 102 may be 20% or less of the center distance or 3 mm or less. Since the center distance CG1 between the first lens 101 and the second lens 102 is greater than the maximum center thickness of the lenses and is provided as a large gap of 6 mm or more, the change in the Sag value of the third surface S4 of the second lens 102 may be set to be gentle so that the edge distance between the first and second lenses 101 and 102 does not increase abruptly.

The distance G2 (see FIG. 5) between the second lens 102 and the third lens 103 may gradually increase from the center to the edge. This distance G2 may gradually increase from the optical axis toward the edge due to the convex shape of the sensor-side surface of the second lens 102 and the convex shape of the object-side surface of the third lens 103. That is, the distance between the second lens 102 and the third lens 103 can have the smallest center distance and the largest edge distance.

FIG. 3 is an example of lens data of the optical system of the first embodiment of FIG. 1. As shown in FIG. 3, the radius of curvature of the first to third lenses 101-103 on the optical axis OA, the center thickness (CT) of the lenses, the center distance (CG) between adjacent lenses, the refractive index at the d-line, the Abbe number, the semi-aperture, and the focal length may be set. The radii of curvature of the first and second surfaces S1 and S2 of the first lens 101 are L1R1, L1R2, the radii of curvature of the third and fourth surfaces S3 and S4 of the second lens 102 are L2R1, L2R2, and the radii of curvature of the fifth and sixth surfaces S5 and S6 of the third lens 103 may be expressed as L3R1, L3R2. These radii of curvature are radii of curvature on the optical axis of each lens surface, and may satisfy at least one of the following conditions.

$$L 1 R 2 < L 1 R 1 \qquad Condition 1$$

$$L 1 R 2 < \vert L 2 R 1 \vert < \vert L 2 R 2 \vert \qquad Condition 2$$

$$L 2 R 2 < \vert L 3 R 2 \vert \qquad Condition 3$$

$$L 3 R 1 * 5 < L 2 R 2 < L 3 R 2 \qquad Condition 4$$

If the third lens 103 is designed as an aspherical surface, thermal compensation may be satisfied and optical performance may be improved, but assembly may not be as easy as with a spherical lens, and the aspherical third lens 103 may affect the optical characteristics of lenses positioned closer to the object side than the third lens 103 due to the assembling characteristics of the aspherical third lens 103. The invention facilitates assembly by adjusting the thickness and radius of curvature of the aspherical third lens 103.

In addition, since the first lens 101 having a spherical surface is disposed on the object side of the inner aperture stop ST2 and is the lens most sensitive to optical characteristics, the effective diameter of the second lens 102 is made larger than the effective diameter of the sensor-side surface of the first lens 101, and the difference in the radius of curvature between the second surface S2 of the first lens 101 and the third surface S3 of the second lens 102 may be set to 10 mm or less. In addition, the difference in the center thicknesses of the first lens 101 and the second lens 102 may be set to 1 mm or less. In addition, the difference in the center thicknesses of the second lens 102 and the third lens 103 may be set to 1 mm or less. Accordingly, an optical system having a low CRA (Chief ray angle) may be implemented by the inner aperture stop ST2 between the first and second lenses 101 and 102.

When explaining the thickness of the lenses, the sum of the center thicknesses of the first to third lenses 101-103 may be defined as ΣCT, and the sum of the edge thicknesses of the first to third lenses 101-103 may be defined as ΣET. The center thickness CT2 of the second lens 102 may be greater than the center thicknesses CT1 and CT3 of the first and third lenses 101 and 103. Preferably, the maximum thickness among the lenses may be the center thickness CT2 of the second lens 102. Since the center thickness CT1 of the first lens 101 is thicker than 3 mm and the radius of curvature of the sensor-side second surface S2 is provided at a minimum, light incident through the glass lens may be refracted to the end of the effective region of the last lens. The ratio of the center thickness and the edge thickness of each lens may satisfy the following condition.

$$0.5 < CT 1 / ET 1 < 1.5 \qquad Condition 1$$

$$1.2 < CT 2 / ET 2 < 3 \qquad Condition 2$$

$$1 < CT 3 / ET 3 < 2.5 \qquad Condition 3$$

$$1 < Σ CT / Σ ET < 2 \qquad Condition 4$$

Here, the sum of the center thicknesses of the lenses is ΣCT, and the sum of the edge thicknesses is ΣET.

Furthermore, the thicknesses of each lens may satisfy the following conditions:

$$0.5 < CT 1 / CT 2 < 1.5 \qquad Condition 1$$

$$0.5 < CT 2 / CT 3 < 1.5 \qquad Condition 2$$

$$0.2 < CT 1 / Σ CT < 0.5 \qquad Condition 3$$

$$0.1 < CT 3 / Σ CT < 0.4 \qquad Condition 4$$

In the conditions, if CTi/ETi (i=1~3) is present, it may be minimized when i is 1. The difference between the center thickness and the edge thickness of each lens may be set to be greater than 0.5 mm and less than 3 mm. This allows the aspherical lens to be disposed on the third lens 103 to refract incident light to the periphery of the image sensor 300 without increasing the difference between the center thickness and the edge thickness of each lens. Furthermore, by setting the center thickness and edge thickness difference of the third lens 103 to 2.5 mm or less, the difference in the radius of curvature between the object-side and sensor-side surfaces may be designed to be minimal, improving the assembling performance of the aspherical third lens 103 and reducing the impact on optical characteristics.

Furthermore, the difference between the maximum and minimum center thicknesses of the lenses may be 1.5 mm or less, for example, in the range of 0.1 mm to 1.5 mm or 0.2 mm to 1 mm. In other words, even if the center thickness difference of the glass lenses is designed to be small, optical performance may be maintained without significant degradation, and the camera module may be slimmed down. Furthermore, since the difference between the center and edge thicknesses of each lens is not significant, even if at least one lens is tilted, the influence on optical characteristics may be reduced. Furthermore, the influence on thermal characteristics between the center and edge of the lenses may be reduced.

The center distance between the first to third lenses 101-103 is defined as CG1 and CG2, and the sum of the center distances between the first to third lenses 101-103 may be defined as ECG. The center distance CG2 between the second lens 102 and the third lens 103 is the center distance between the spherical lens and the aspherical lens and may be smaller than the center distance CG1 between the first and second lenses 101 and 102. The center thickness and center distance of the lenses may satisfy at least one of the following conditions:

$$Σ CG < Σ CT \qquad Condition 1$$

$$1 < Σ CG / CG 1 < 1.5 \qquad Condition 2$$

$$CG 2 * 4 < CG 1 \qquad Condition 3$$

Regarding the refractive indices, the refractive indices of the first to third lenses 101-103 may be 1.5 or greater. The first to third lenses 101-103 may be made of glass and have a refractive index of 1.65 or greater. The refractive indices of the first to third lenses 101-103 may be 1.9 or less, for example, less than 1.9. The first and second lenses 101 and 102 may be made of the same glass material, and may be made of a different glass material from the third lens 103. That is, the first and second lenses 101 and 102 may have the same refractive index. The first and second lenses 101 and 102 may have the same Abbe number. The first and second lenses 101 and 102 may be spherical lenses, and the third lens 103 may be an aspherical lens.

The difference in refractive indices between the first and third lenses 101 and 103 is 0.20 or less. The first lens 101 is the glass lens closest to the object and is arranged with a thick thickness. Accordingly, the first lens 101 made of glass exhibits less lens shrinkage and movement as the ambient temperature changes from room temperature to low or high temperatures. Therefore, the resolution deterioration is less than that of a plastic lens even when the temperature changes. The fact that the first lens 101, which is arranged at the front end of the optical system, is made of glass with a high refractive index affects the reduction of the resolution change of the entire optical system as the ambient temperature changes from room temperature to low or high temperatures. The third lens 103 may be an aspherical lens to inhibit resolution deterioration due to temperature changes.

The focal lengths F2 and F3 of the second and third lenses 102 and 103 have positive power, and the focal length F1 of the first lens 101 may have negative power. Accordingly, when each lens repeatedly contracts and expands as the temperature changes from low to high, chromatic aberration may be corrected by the high-temperature glass lenses.

When the focal length is expressed as an absolute value, the focal length of the second lens 102 is the largest among the lenses and can have a difference of 10 mm or less from the focal lengths of the first and third lenses 101 and 103. By making the absolute value difference in the focal lengths of the first and second lenses 101 and 102, which are spherical lenses, greater than the difference in the focal lengths of the second and third lenses 102 and 103, the optical system can have improved MTF characteristics, aberration control characteristics, and resolution characteristics within the set field of view range, and may have excellent optical performance at the periphery of the field of view.

As shown in FIG. 4, the lens surface of the third lens 103 among the lenses of the lens unit 100 may include an aspherical surface having a 20th-order aspherical coefficient. For example, the third lens 103 may include a lens surface having a 20th-order aspheric coefficient. As such, an aspheric surface having a 20th-order aspheric coefficient (a non-zero value) can significantly change the aspheric shape of the periphery, thereby effectively compensating for the optical performance of the periphery of the FOV.

As shown in FIG. 5, the thicknesses T1-T3 of the first to third lenses 101-103 and the distance G1, G2, and G3 between adjacent lenses may be set. As shown in FIG. 5, the thicknesses T1-T3 of each lens may be set at intervals of 0.1 mm or more in the Y-axis direction from the optical axis toward the edge of each lens, and the distance G1 and G2 between adjacent lenses may be set at intervals of 0.1 mm or more. The distance G3 is a gap between the third lens 103 and the image sensor 300, and may represent the distance from the optical axis to the edge.

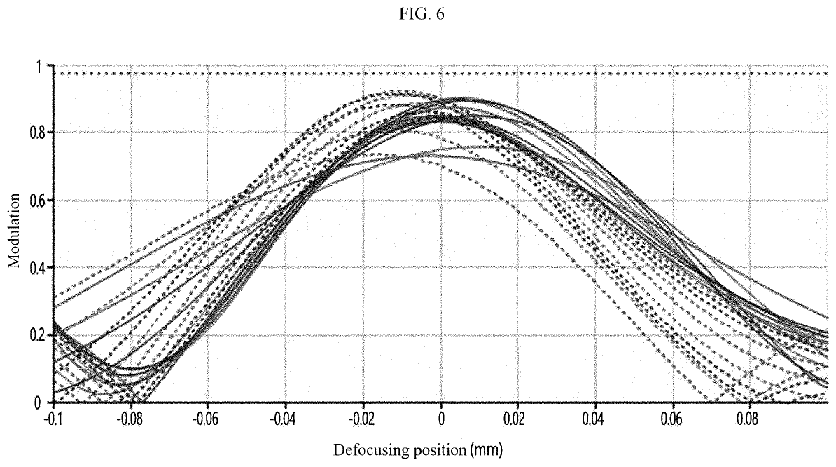

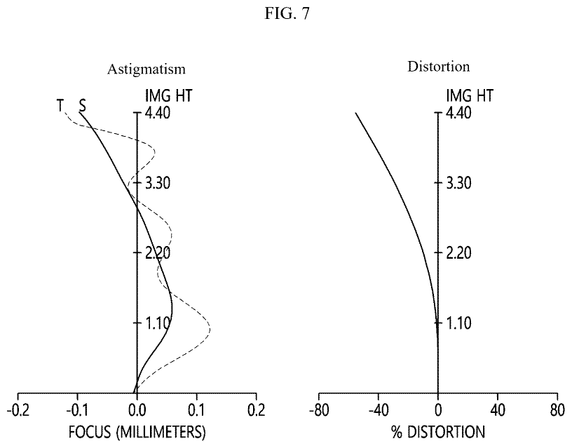

FIG. 6 is a graph showing the diffraction MTF at room temperature in the optical system of FIG. 1, and is a graph showing the modulation according to the spatial frequency. As in FIG. 6, the x-axis represents the defocusing position, and the y-axis represents the MTF, and the graphs are measured from 0.000 mm to 4.400 mm from F1 to F23 in units of 0.400 mm. FIG. 7 is a graph showing the aberration characteristics in the optical system of FIG. 1. In the aberration graph of FIG. 7, astigmatic field curves and distortion are measured from left to right. In FIG. 7, the X-axis may represent the focal length (mm) and distortion (%), and the Y-axis may represent the height of the image. In addition, the graph for astigmatism and distortion is a graph for light in a wavelength band of about 940 nm. In the aberration diagram of FIG. 7, the closer each curve is to the Y-axis, the better the aberration correction function may be interpreted. It may be seen that the optical system 1000 according to the embodiment has measured values close to the Y-axis in almost all regions. That is, the optical system 1000 according to the embodiment has improved resolution and can have good optical performance in the center and periphery of the FOV. Here, the low temperature is −20 degrees or lower, for example, in the range of −20 to −40 degrees, the room temperature is in the range of 22 degrees±5 degrees or in the range of 18 degrees to 27 degrees, and the high temperature is 80 degrees or higher, for example, in the range of 80 degrees to 105 degrees. Accordingly, it may be seen that the reduction in luminance ratio (modulation) from low to high temperatures is less than 10%, for example, 5% or less, or is almost unchanged.

The optical system 1000 may be designed to enable temperature compensation for the aspherical lens even if at least one aspherical lens is used within the lens unit 100, thereby inhibiting a decrease in the reliability of optical characteristics. Furthermore, it may be seen that the effective focal length, TD, BFL, F number (F #), and diagonal FOV are almost unchanged even when the temperature changes from room temperature to low or high. Here, TD is the optical axis distance from the center of the object-side surface of the first lens 101 to the center of the sensor-side surface of the last lens 103.

When the center wavelength of the infrared wavelength is 940 nm±20 nm and the distance from the first lens 101 of the camera module to the subject is 5000 mm, the optical system of the embodiment can effectively control various aberration characteristics and achieve excellent optical performance at both the center and periphery of the FOV.

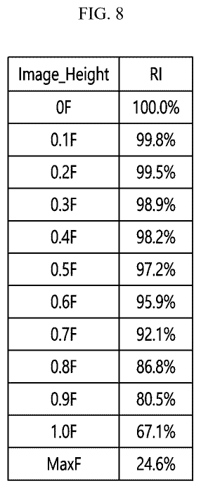

FIG. 8 is a table showing the peripheral illumination ratio or relative illumination from the center of the image sensor to the image height, that is, from 0 to the maximum height (MaxF=1.1 F), in the optical system according to the first embodiment, and it can be seen that the ambient light ratio from the center of the image sensor to the diagonal end (1.0 F) is greater than 60%, for example, 64% or more. In other words, the difference in peripheral illumination at low, room, and high temperatures is virtually identical from the optical axis to the edge of the effective region. Accordingly, since the minimum light quantity from the center to the edge of the image sensor exceeds 60%, more accurate sensing values may be obtained across the entire region of the image sensor. Here, 60%<1.0 F_RI<100% is satisfied, so the minimum light quantity for sensor accuracy may be secured in 1.0 field. 1.0 F_RI represents the relative illuminance value in 1.0 field. Since 0%<Max_RI<30% is satisfied, the relative illuminance value in Max_RI, which is 1.1 field, is set to less than 30%, which may be set as the minimum condition to suppress measurement errors.

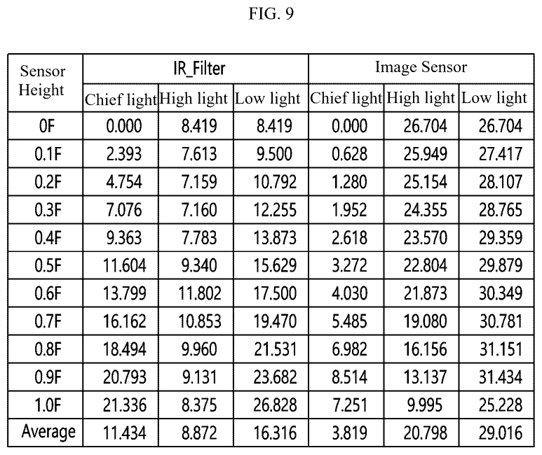

As shown in FIG. 9, the incident angle incident on the optical filter and the image sensor may not have a large difference between the upper and lower light rays based on the chief light rays depending on the sensor height (mm). For example, at 0. F, based on the chief ray, the incident angles of the upper and lower rays of the optical filter are 10 degrees or less, and the incident angles of the upper and lower rays of the image sensor are 30 degrees or less.

The optical system 1000 according to the first embodiment may satisfy at least one or more of the mathematical equations described below. For example, when the optical system 1000 satisfies at least one mathematical equation, the optical system 1000 can effectively control aberration characteristics such as chromatic aberration and distortion aberration, and can exhibit excellent optical performance at the center and periphery of the FOV. Furthermore, the optical system 1000 may exhibit improved resolution. Furthermore, the meanings of the thickness of the lens along the optical axis OA and the spacing between adjacent lenses along the optical axis OA described in the mathematical equations may refer to the embodiments disclosed above.

$$0.5 < CT 1 / CT 2 < 1.5 \qquad [ Equation 1 ]$$

CT1 means a center thickness of the first lens 101, and CT2 means a center thickness of the second lens 102. Equation 1 may control chromatic aberration of the optical system by setting the difference in the center thicknesses of the first and second lenses to a small value. Preferably, 0.8<CT1/CT2<1.2 may be satisfied. By setting the center thicknesses of each of the first and second lenses 101 and 102 having spherical surfaces, the optical performance of the central and peripheral regions of the FOV may be improved.

$$1 < CG 1 / CT 1 < 3 \qquad [ Equation 2 ]$$

CG1 means the center distance between the first lens 101 and the second lens 102. The effective diameter of the second lens 102 may be suppressed from increasing due to the center distance between the first and second lenses 101 and 102 and the shape of the first lens 101. Preferably, 2<CG1/CT1<3 may be satisfied.

$$Po 1 < 0 \qquad [ Equation 3 ]$$

In Equation 3, Po1 means a power of the first lens 101 and may be set to have an effective focal length (F) smaller than TTL in the optical system for the performance of the optical system. Accordingly, the following condition may satisfy: TTL>F. In addition, a wide field of view may be set by the focal length and effective focal length of the first lens 101. That is, the focal length of the first lens 101 is F1, and F1<0 may be satisfied.

$$1.75 < Nd 3 < 2.2 \qquad [ Equation 4 ]$$

Nd3 is the refractive index of the third lens 103 at the d-line. Equation 4 sets the refractive index of the third lens 103 high, thereby controlling factors affecting the reduction of third-order aberration (Seidel aberration) of the optical system, and reducing aberrations that may occur as the TTL length increases. Equation 4 preferably satisfies: 1.8<Nd3<2. If the design is lower than the lower limit of Equation 4, performance may be achieved by reducing aberrations, but the power of the third lens 103 may be weakened, inhibiting it from refracting light efficiently, thereby degrading the performance of the optical system. If the design is higher than the upper limit of Equation 4, there is a disadvantage in that materials become difficult to obtain. Furthermore, if the refractive index of the third lens 103 is designed to be lower than the lower limit of Equation 4, the radius of curvature of the third lens must be increased to increase the power of the second lens. This can make lens manufacturing more difficult, increase the lens defect rate, and lower the yield.

$$1.75 < Aver ( Nd 1 : Nd 3 ) < 1.95 \qquad [ Equation 4 - 1 ]$$

In Equation 4-1, Aver(Nd1:Nd3) is the average of the refractive index values at the d-line of the first to third lenses. If the optical system 1000 according to the embodiment satisfies Equation 4-1, the optical system can set the resolution and suppress the influence of TTL.

$$L 1 R 1 > 0 \qquad [ Equation 5 ]$$

L1R1 means the radius of curvature of the first surface S1 of the first lens 101 and may be set to be greater than 0. When the radius of curvature of the first surface S1 of the first lens 101 satisfies Equation 5, the shape of the optical system may be restricted. The object-side surface of the first lens 101 has a convex shape from the optical axis toward the object, which can increase the amount of incident light. In addition, since the condition of L1R1*L1R2>0 is satisfied, the incident light may be refracted in a direction closer to the optical axis. Accordingly, the first embodiment can increase the center distance between the first and second lenses 101 and 102, thereby providing an effective diameter of the third surface S3 of the second lens 102 larger than the effective diameter of the second surface S2 of the first lens 101.

$$L 1 R 1 / L 1 R 2 < \vert L 1 R 2 / L 2 R 1 \vert \qquad [ Equation 6 ]$$

L1R2 is the radius of curvature of the sensor-side surface of the first lens 101, L2R1 is the radius of curvature of the object-side surface of the second lens 102, and L2R2 is the radius of curvature of the sensor-side surface of the second lens 102. By making the difference in the radius of curvature between the object-side surface and the sensor-side surface of the first lens 101 smaller than the difference in the radius of curvature between the sensor-side surface and the object-side surface of the second lens 102, the incidence efficiency of the second lens 102 for light passing through the first lens 101 may be improved.

$$L 2 R 1 < \vert L 2 R 2 \vert \qquad [ Equation 6 - 1 ]$$

L2R1 is the radius of curvature of the object-side surface of the second lens 102, and L2R2 is the radius of curvature of the sensor-side surface of the second lens. Since the first lens has a meniscus shape convex toward the object side, and the second lens has a biconvex shape, the increase in the effective diameter of the third lens 103 may be suppressed, and the radius of curvature of the object-side surface of the third lens 103 may be reduced. In addition, since the condition |L3R2|>L3R1 is satisfied, the radius of curvature of the sensor-side surface of the third lens 103, which is an aspherical lens, may be set to be large, thereby reducing the distance between the image sensor 300 and the third lens 103. Accordingly, the position of the optical filter 500 may be arranged between the second and third lenses 102 and 103.

$$1 < CG 1 / BFL < 3 \qquad [ Equation 7 ]$$

BFL (Back Focal Length) is the optical axis distance from the center of the sensor-side surface of the last lens, i.e., the third lens 103 to the surface of the image sensor 300. When the optical system satisfies Equation 7, the diagonal length of the image sensor 300 is set to be less than 50% of the TTL, for example, less than 40%, thereby setting the conditions for manufacturing a vehicle camera module. In addition, the BFL can minimize the space in which a component such as a cover glass located between the image sensor 300 and the third lens 103 may be placed. When the range of Equation 7 is smaller than the lower limit, the space for placing circuit structures such as the image sensor becomes more restricted, and the process of assembling the circuit structures into the optical system may become difficult. When the range of Equation 7 is larger than the upper limit, the process of assembling circuit structures such as the image sensor into the optical system becomes easy, but the TTL becomes longer, making it difficult to miniaturize the optical system. Preferably, 1.2<CG1/BFL<2.5 may be satisfied.

$$1 < CA 11 / CA 12 < 4 \qquad [ Equation 8 ]$$

CA11 is the effective diameter of the object-side surface of the first lens 101, and CA12 is the effective diameter of the sensor-side surface of the first lens. By setting the effective diameter of the concave sensor-side surface of the first lens 101 to be smaller than the effective diameter of the convex object-side surface of the first lens, the distance between the first and second lenses 101 and 102 and the effective diameter of the second lens 102 may be adjusted. Preferably, 1.5<CA11/CA12<2.5 may be satisfied. The effective diameter of the object-side first surface S1 of the first lens 101 may be more than 1.5 times, i.e., more than 2 times, the effective diameter of the second surface S2. The effective diameter of the object-side first surface S1 of the first lens 101 may be 1.1 times or more and 2 times or less than the effective diameter of the third surface S3 of the second lens 102.

$$0 < ( CA 12 * CT 1 ) / ( CA 21 * CT 2 ) < 1 \qquad [ Equation 9 ]$$

CA21 is the effective diameter of the object-side surface of the second lens 102. In Equation 9, the difference between the values of (CA12*CT1) and (CA21*CT2) may be designed to be small, thereby improving spherical aberration. Preferably, 0.3<(CA12*CT1)/(CA21*CT2)<1 may be satisfied.

$$0.1 < CT 1 / ( CT 2 + CT 3 ) < 1 \qquad [ Equation 10 ]$$

Equation 10 may be designed so that the difference between the sum of the center thickness CT1 of the first lens 101 and the center thicknesses CT2 and CT3 of the second and third lenses 102 and 103 is not large. In this case, since the first and second lenses 101 and 102 are spherical lenses, assembly performance may be improved, and since the last third lens 103 is an aspherical lens, spherical aberration caused by the spherical lenses may be corrected. Furthermore, since the third lens is an aspherical lens made of glass, thermal compensation may be satisfied and optical performance may be improved. Preferably, 0.2<CT1/(CT2+CT3)<0.9 may be satisfied.

$$0.5 < CT 2 / CT 3 < 1.5 \qquad [ Equation 11 ]$$

Equation 11 inhibits assembly degradation, improves aberration characteristics, and suppresses the influence on optical characteristics by ensuring that the difference in center thickness between the second lens 102, which is the final spherical lens, and the third lens 103, which is an aspherical lens, is not too large. Preferably, 0.8<CT2/CT3<1.4 may be satisfied.

$$1 < CA 11 / CA 31 < 3 \qquad [ Equation 12 ]$$

CA11 means the effective diameter of the first surface S1 of the first lens 101, and CA31 means the effective diameter of the fifth surface S5 of the third lens 103. When Equation 12 is satisfied, the size of the optical system 1000 may be set to control the incident light path and adjust factors affecting aberration. Preferably, Equation 12 may satisfy: 1<CA11/CA31<2. Since the first and third lenses satisfy Equation 12, the difference in effective diameters between the first and third lenses is not large, which can reduce the influence of assembly and reduce the optical influence of temperature change.

$$1 < CA 2 / CT 2 < 5 \qquad [ Equation 13 ]$$

CA2 is the average of the effective diameters of the object-side and sensor-side surfaces of the second lens 102. If the optical system satisfies Equation 13, the center thickness of the second lens 102 having an effective diameter greater than 8 mm may be set. Preferably, 2<CA2/CT2<4 may be satisfied.

$$1.5 < CA 3 / CT 3 < 5 \qquad [ Equation 13 - 1 ]$$

CA3 is the average of the effective diameters of the object-side and sensor-side surfaces of the third lens 103. If the optical system satisfies Equation 13-1, the center thickness of the third lens 103 having an effective diameter greater than 8 mm may be set. Preferably, 2.5<CA3/CT3 <3.5 may be satisfied.

$$0.5 < CA 22 / CA 31 < 1.5 \qquad [ Equation 14 ]$$

CA22 means the effective diameter of the fourth surface S4 of the second lens 102, and CA31 means the effective diameter of the fifth surface S5 of the third lens 103. When the optical system 1000 according to the embodiment satisfies Equation 14, light traveling within the second lens group LG2 may be controlled, and factors affecting lens sensitivity may be set. Equation 14 preferably satisfies: 0.8<CA22/CA31<1.2. Since the second and third lenses satisfy Equation 14, the size for assembling the spherical lenses may be set.

$$1 < CT 2 / CG 2 < 4 \qquad [ Equation 15 ]$$

CG2 is the center distance between the second and third lenses 102 and 103. In Equation 15, the TTL may be adjusted by setting the center thickness of the second lens 102 and the center distance between the second and third lenses 102 and 103.

$$0 < CT 3 / CG 2 < 1 \qquad [ Equation 16 ]$$

In Equation 16, the TTL may be adjusted by setting the center thickness of the third lens 103 and the center distance between the second and third lenses 102 and 103. Furthermore, CT2 and CT3 can each be 3 mm or greater.

$$0.5 < Max\_Sag11 / Max\_Sag12 < 1.5 \qquad [ Equation 17 ]$$

Max_Sag11 is the maximum optical axis distance from the center of the object-side first surface S1 of the first lens 101 to the first surface S1 along a straight line perpendicular to the optical axis OA. Max_Sag12 is the maximum optical axis distance from a straight line perpendicular to the optical axis from the center of the sensor-side second surface S2 of the first lens 101 to the second surface S2. When the first lens 101 satisfies Equation 17, the radius of curvature and the effective diameter of the object-side surface and the sensor-side surface of the first lens 101 may be set. Preferably, 0.3<Max_Sag11/Max_Sag12<1 may be satisfied.

$$2 < CG 1 / Max\_Sag12 < 5 \qquad [ Equation 18 ]$$

When the optical system satisfies Equation 18, the center distance CG1 between the first and second lenses 101 and 102 may be set according to the size of the maximum Sag value of the concave sensor-side surface of the first lens 101, i.e., the concave depth of the sensor-side surface. Preferably, 3<CG1/Max Sag12<4 may be satisfied.

$$0 < \vert Max\_Sag32 / Max\_Sag31 \vert < 1 \qquad [ Equation 19 ]$$

Max_Sag31 is the maximum optical axis distance from the center of the object-side fifth surface S5 of the third lens 103 to the fifth surface S5 from a straight line perpendicular to the optical axis OA. Max_Sag32 is the maximum optical axis distance from the center of the sensor-side sixth surface S6 of the third lens 103 to the sixth surface S6. When the third lens 103 satisfies Equation 19, the radius of curvature and the effective diameter of the object-side surface and the sensor-side surface of the third lens may be set. In addition, the object-side surface and the sensor-side surface of the third lens can have a Sag value for refracting light to the entire region of the image sensor 300.

$$\vert Max\_Sag22 \vert < \vert Max\_Sag31 \vert \qquad [ Equation 20 ]$$

Max_Sag22 is the maximum optical axis distance from the center of the sensor-side fourth surface S4 of the second lens 102 to the fourth surface S4 from a straight line perpendicular to the optical axis OA. By setting the maximum Sag value of the sensor-side surface of the second lens 102 to be smaller than the maximum Sag value of the object-side surface of the third lens 103, the distance between the second and third lenses 102 and 103 may be reduced, and light refracted through the second lens 102 may be uniformly incident on the entire region of the third lens 103.

$$CA 2 / ( Imgh * 2 ) > CA 3 / ( Imgh * 2 ) \qquad [ Equation 21 ]$$

The Imgh value is half of the diagonal length of the image sensor 300, and the average effective diameter of the third lens 103 may be set to be larger than the average effective diameter of the second lens 102. Furthermore, (Imgh*2)<CA2 and CA3<(Imgh*2) may be satisfied.

$$( Imgh * 2 ) < CA 12 < CA 21 \qquad [ Equation 22 ]$$

CA12 is the effective diameter of the second surface S2 of the first lens 101, and CA21 is the effective diameter of the third surface S3 of the second lens 102. The diagonal length of the image sensor 300 may be set to be smaller than the effective diameters of the second surface S2 of the first lens 101 and the third surface S3 of the second lens 102.

$$0 < DLG 1 / DLG 2 < 1 \qquad [ Equation 23 ]$$

DLG1 is the optical axis distance of the first lens group LG1, for example, the optical axis distance from the object-side surface of the first lens 101 to the sensor-side surface. DLG2 is the optical axis distance of the second lens group LG2, for example, the optical axis distance from the object-side surface of the second lens 102 to the sensor-side surface of the third lens 103. When the optical system satisfies Equation 23, the optical axis distances of four or fewer lenses may be set based on the position of the inner aperture stop ST2. In Equation 23, the optical axis distance DLG1 of the first lens group arranged on the object side of the inner aperture stop ST1 is provided to be smaller than the optical axis distance of the second lens group LG2, thereby correcting distortion and chromatic aberration caused by the first lens 101. Preferably, 0.2<DLG1/DLG2 <0.8 may be satisfied. Since Equation 23 is satisfied, aberrations and distortions that may occur in an optical system with a TTL of 20 mm or more may be reduced.

$$0 < CG 1 / TTL < 0.6 \qquad [ Equation 24 ]$$

In Equation 24, by setting the center distance CG1 between the first and second lenses 101 and 102 relative to the overall length (TTL), the effective diameter, radius of curvature, refractive index, Abbe number, etc. of the first and second lenses may be set. Preferably, 0<CG1/TTL<0.5 may be satisfied.

$$0 < CT 3 / TTL < 0.3 \qquad [ Equation 25 ]$$

In Equation 25, by setting the center thickness of the third lens 103 within the above range relative to TTL, light incident through the first and second lenses 101 and 102 may be refracted to the entire region of the image sensor 300, thereby improving chromatic aberration of the optical system. Preferably, 0<CT3/TTL<0.2 may be satisfied.

$$0.5 < CT 3 / ImgH < 1.5 \qquad [ Equation 25 - 1 ]$$

In Equation 25-1, by setting the center thickness of the third lens 103 within the above range relative to ImgH, changes in optical characteristics due to temperature changes may be reduced.

$$0 < \vert L 2 R 1 / L 3 R 2 \vert < 1 \qquad [ Equation 26 ]$$

L2R1 means a radius of curvature of the third surface S3 of the second lens 102, and L3R2 means a radius of curvature of the sixth surface S6 of the third lens 103. In Equation 26, the power of the second and third lenses may be controlled by setting the radius of curvature of the object-side surface of the second lens and the sensor-side surface of the third lens. Accordingly, excellent optical performance may be achieved at the center and periphery portions of the field of view. Preferably, Equation 26 satisfies: 0.2<|L2R1/L3R2|<0.7.

$$1 < L 3 R 1 / CT 3 < 10 \qquad [ Equation 27 ]$$

L3R1 means the radius of curvature of the fifth surface S5 of the third lens 103. When the optical system satisfies Equation 27, the power of the aspherical third lens 103 may be controlled and assembly degradation may be inhibited by setting the radius of curvature and the center thickness of the object-side surface of the third lens 103. Preferably, 1.5<L3R1/CT3<5 may be satisfied.

$$1 < L 1 R 1 / L 1 R 2 < 10 \qquad [ Equation 28 ]$$

L1R1 means the radius of curvature of the object-side surface S1 of the first lens 101, and L1R2 means the radius of curvature of the sensor-side surface S2 of the first lens 101. When the first lens 101 satisfies Equation 28, the refraction angle of light incident on the object-side surface of the first lens 101 may be adjusted. Preferably, 3<L1R1/L1R2<6 may be satisfied.

$$0 < \vert L 2 R 2 / L 3 R 1 \vert < 0.5 \qquad [ Equation 29 ]$$

L2R2 and L3R1 may have radii of curvature with opposite signs on the optical axis. For example, the radius of curvature of the sensor-side surface of the second lens 102 may be negative, and the radius of curvature of the object-side surface of the third lens 103 may be positive. Accordingly, by setting the radii of curvature of the two lens surfaces facing each other in the second lens group, spherical aberration may be controlled. Preferably, 0<|L2R2/L3R1|<0.3 may be satisfied.

$$( Nd 1 * Vd 1 ) < ( Nd 3 * Vd 3 ) \qquad [ Equation 30 ]$$

Nd1 and Nd3 are the refractive indices of the first and third lenses 101 and 103 at the d-line, and Vd1 and Vd3 are the Abbe numbers of the first and third lenses. The relationship between the refractive index and Abbe number of the spherical first lens 101 and the refractive index and Abbe number of the aspherical third lens 103 may be set. By setting the refractive index and Abbe number of the aspherical third lens, incident light may be guided to the third lens. Here, the refractive indices of the first to third lenses may be 1.9 or less, for example, less than 1.9.

$$0 < CT\_Max / CG\_Max < 1 \qquad [ Equation 31 ]$$

Equation 31 may set the relationship between the maximum center thickness (CT_Max) among lenses and the maximum center distance (CG_Max) between adjacent lenses. When Equation 31 is satisfied, the optical system can exhibit good optical performance at the focal length at the set field of view and can reduce the TTL. Preferably, 0.2<CT_Max/CG_Max<0.8 may be satisfied.

$$0.8 < CT\_Max / CT\_Min < 3 \qquad [ Equation 32 ]$$

CT_Max is the maximum center thickness of the lenses, and CT_Min is the minimum center thickness of the lenses. Equation 32 sets the difference in the center thicknesses of the lenses to less than 3, thereby improving lens assembly. Preferably, 1<CT_Max/CT_Min<1.5 may be satisfied.

$$( CT\_Max / CT\_Min ) < ( CA\_Max / CA\_Min ) \qquad [ Equation 33 ]$$

CA_Max is the maximum effective diameter of the lens surfaces, and CA_Min is the minimum effective diameter of the lens surfaces. Equation 33 sets the difference in the effective diameters of the lens surfaces to be greater than the difference in the center thicknesses of the lenses, thereby reducing the influence of optical characteristics in optical systems with four or fewer lenses and inhibiting deterioration in assembly.

$$0.5 < \sum CT / \sum CG < 1.5 \qquad [ Equation 34 ]$$

In Equation 34, ΣCT is the sum of the center thicknesses of the lenses, and ΣCG is the sum of the center distances between adjacent lenses. When Equation 34 is satisfied, the optical system can achieve good optical performance at a set focal length and a set field of view, and can reduce the TTL. Preferably, ΣCT>ΣCG may be satisfied.

$$1 < \sum Nd < 10 \qquad [ Equation 35 ]$$

>Nd means the sum of the refractive indices of each of the multiple lenses at the d-line. When Equation 35 is satisfied, the TTL may be controlled and improved resolution may be achieved in an optical system 1000 comprising a mixture of aspherical and spherical lenses. Furthermore, by arranging glass lenses with relatively high refractive indices and spherical lenses with relatively large center distances along the optical axis, the number of lenses may be reduced. Equation 35 preferably satisfies: 3<ΣNd<7.

$$10 < \sum Vd / \sum Nd < 30 \qquad [ Equation 36 ]$$

ΣVd represents the sum of the Abbe numbers of each of the plurality of lenses. When Equation 36 is satisfied, the optical system 1000 can have improved aberration characteristics and resolution. In Equation 36, the optical characteristics may be controlled by setting the Abbe sum and the sum of the refractive indices of the lenses, and preferably satisfies: 13<ΣVd/ΣNd<24.

$$1 < CA 11 / CA\_Min < 4 \qquad [ Equation 37 ]$$

CA11 means the effective diameter of the object-side surface of the first lens 101, and CA_Min represents the minimum effective diameter between the object-side and sensor-side surfaces of the lenses. When Equation 37 is satisfied, the optical system can control incident light, maintain optical performance, and provide a slimmer module. Equation 37 preferably satisfies: 1.5<CA11/CA_Min<3.5. Furthermore, since CA11 is CA_Max, the following condition may satisfy: 1<CA_Max/CA_Min<4 or 1.5<CA_Max/CA_Min<3.5.

$$1 < CA\_ST1 / CA\_ST2 < 4 \qquad [ Equation 38 ]$$

CA_ST1 is the hole diameter of the upper aperture stop ST1 arranged around the object-side surface of the first lens 101, and CA_ST2 is the hole diameter of the inner aperture stop ST2 arranged around the perimeter between the first and second lenses 101 and 102. By adjusting the hole diameters of the upper and inner apertures ST1 and ST2, unnecessary light may be blocked and the amount of internal light may be controlled. Preferably, 2<CA_ST1/CA_ST2<4 may be satisfied.

$$1 < CA\_ST 1 / CA 11 < 1.6 \qquad [ Equation 39 ]$$

Equation 39 can set the relationship between the hole diameter of the upper aperture stop ST1 and the effective diameter of the object-side surface of the first lens 101. Accordingly, the upper aperture stop ST1 may block light that exceeds the 1.0 field region of the image sensor 300 on the object-side surface of the first lens 101. Preferably, 1.1<CA_ST1/CA11<1.5 may be satisfied.

$$0.5 < CA\_ST2 / CA 12 < 1.5 \qquad [ Equation 40 ]$$

Equation 40 can set the relationship between the hole diameter of the inner aperture stop ST2 and the effective diameter of the sensor-side surface of the first lens 101. Accordingly, the inner aperture stop ST2 can control the amount of light passing through the sensor-side surface of the first lens 101. Preferably, 0.5<CA_ST2/CA12<1 may be satisfied.

$$1 < CA\_Max / ( 2 * ImgH ) < 3 \qquad [ Equation 41 ]$$

Equation 41 may be set by the maximum effective diameter (CA_Max) among the lens surfaces and the diagonal length of the image sensor. If this is satisfied, the optical system can maintain good optical performance and be sized for a slim and compact structure. Preferably, 1.6<CA_Max/(2*ImgH)<2.6 may be satisfied.

$$1 < T D / CA\_Max < 3 \qquad [ Equation 42 ]$$

TD is the optical axis distance from the center of the object-side surface of the first lens 101 to the center of the sensor-side surface of the third lens 103. Specifically, TD is the maximum optical axis distance of the lenses. When Equation 42 is satisfied, the total optical axis distance of the lenses and the maximum effective diameter of the lens surfaces may be set, thereby setting the size for good optical performance. Equation 42 preferably satisfies: 1<TD/CA_Max<2.

$$TD > S D 1 \qquad [ Equation 42 - 1 ]$$

The SD1 is the optical axis distance from the position of the upper aperture stop ST1 to the center of the sensor-side surface of the last lens. The position of the upper aperture stop ST1 may be lower than the apex of the object-side surface of the first lens 101. The position of the upper aperture stop ST1 may be between a straight line perpendicular to the apex of the object-side surface of the first lens 101 and the edge of the object-side surface of the first lens 101.

$$TD > SD 1 > S D 2 \qquad [ Equation 42 - 2 ]$$

The SD2 is the optical axis distance from the position of the inner aperture stop ST2 to the center of the sensor-side surface of the last lens.

$$0 < CT\_Max / TD < 0.7 \qquad [ Equation 43 ]$$

In Equation 43, the maximum center thickness and maximum optical axis distance (TD) of the lenses may be set, thereby improving optical performance. Preferably, 0.1<CT_Max/TD<0.5 may be satisfied.

$$0 < F / C A 31 < 0.5 \qquad [ Equation 44 ]$$

F represents the effective focal length (EFL) of the optical system and may be 10 mm or less, for example, in the range of 1 mm to 10 mm. In Equation 44, the relationship between the effective focal length and the effective diameter of the object-side surface of the last aspherical lens may be set, thereby controlling the effect on optical system demagnification, such as TTL. Equation 44 preferably satisfies: 0<F/CA31<0.2.

$$0 < F / L 1 R 1 < 0.3 \qquad [ Equation 45 ]$$

In Equation 45, the effective focal length of the optical system and the radius of curvature of the object-side surface of the first lens are set to control the influence on incident light and TTL. Equation 45 preferably satisfies: 0<F/L1R1<0.2.

$$1 < Max ( C T / E T ) < 3 \qquad [ Equation 46 ]$$

Max (CT/ET) means the maximum value of the ratio of the center thickness to the edge thickness of each lens. When Equation 46 is satisfied, the optical system can control the influence on the effective focal length and improve assembly. Equation 46 preferably satisfies: 1.8<Max (CT/ET)<3.

$$0 < E PD / L 1 R 1 < 1 \qquad [ Equation 47 ]$$

EPD means a size (mm) of the entrance pupil diameter of the optical system 1000. When the optical system 1000 according to the embodiment satisfies Equation 47, the optical system 1000 can control incident light. Equation 47 preferably satisfies: 0<EPD/L1R1<0.5. Furthermore, EPD<BFL may be satisfied.

$$0.5 < \vert F 1 / F 3 \vert < 1.5 \qquad [ Equation 48 ]$$

F1 is the focal length of the first lens, and F3 is the focal length of the third lens. When Equation 48 is satisfied, the power of the first and third lenses may be controlled to improve resolution, and this can affect the TTL and effective focal length (F). Preferably, 0.5<|F1/F3|<1 may be satisfied. Accordingly, the power of each lens may be controlled to effectively guide light through the aspherical lens. The composite focal length (F23) of the second and third lenses 102 and 103 can have positive power. That is, the composite focal length (F23) of the two lenses positioned closer to the sensor than the inner aperture stop ST2 is designed to be greater than 0. In this case, the optical system may be miniaturized by reducing the TTL at horizontal field of view (FOV_H) of 90° or greater.

$$Po 2 * Po 3 > 0 \qquad [ Equation 49 ]$$

Po2 is the power value of the second lens, and Po3 is the power value of the third lens. That is, the power of the second and third lenses has the same positive power, which can improve aberrations and effectively guide light through the aspherical lens.

$$10 < Vd 3 - Vd 2 < 30 \qquad [ Equation 50 ]$$

In Equation 50, Vd2 is the Abbe number of the second lens, and Vd3 is the Abbe number of the third lens. When Equation 50 is satisfied, the difference in Abbe numbers between adjacent lenses may be maintained above a certain value, thereby improving chromatic aberration. Equation 50 preferably satisfies: Vd2<Vd3.

$$0.5 < \vert F 1 / F 23 \vert < 2 \qquad [ Equation 51 ]$$

In Equation 51, the relationship between the focal length (F1) of the first lens and the combined focal length (F23) of the second and third lenses is established, thereby controlling the power of the lenses to improve resolution and provide a slim and compact optical system. Equation 51 preferably satisfies: 0.8<F1/F23<1.5.

$$20 mm < TTL < 40 mm \qquad [ Equation 52 ]$$

TTL (Total Track Length) refers to the distance (mm) from the center of the first surface S1 of the first lens 101 to the surface of the image sensor 300 in the optical axis OA. By setting the TTL in Equation 52 to less than 40 mm, a miniaturized vehicle optical system may be provided. Preferably, 23 mm<TTL<37 mm may be satisfied.

$$2 mm < ImgH \qquad [ Equation 53 ]$$

Equation 53 can set the diagonal length of the image sensor 300 to half, providing an optical system having a vehicle sensor size. Equation 53 can preferably satisfy: 3 mm<ImgH<5 mm.

$$3 mm < B F L < 8 mm \qquad [ Equation 54 ]$$

In Equation 54, the BFL (Back Focal Length) is set to be greater than 3 mm and less than 8 mm, thereby securing installation space for the optical filter 500 or cover glass. Furthermore, the distance between the image sensor 300 and the last lens can improve the assembling of components and enhance joint reliability. Equation 54 can preferably satisfy: 4 mm<BFL<7.5 mm. If the BFL falls below the range of Equation 54, some of the light traveling to the image sensor may not be transmitted to the image sensor, which may cause resolution degradation. If the BFL exceeds the range of Equation 54, stray light may be introduced, degrading the aberration characteristics of the optical system.

$$0 < B F L / C G 1 < 1 \qquad [ Equation 55 ]$$

In Equation 55, by setting the BFL (Back Focal Length) and the center distance CG1 between the first and second lenses, the joint reliability of the components may be improved depending on the installation space of the cover glass and the spacing between the glass lenses. In Equation 55, 0.2<BFL/CG1<0.8 may be satisfied. The center distance CG1 between the first and second lenses may be the largest among the center distances between the lenses.

$$0 < C T 1 / B F L < 1 \qquad [ Equation 56 ]$$

In Equation 56, BFL (Back focal length) is set to be greater than the center thickness of the first lens 101, thereby securing the installation space for the cover glass, improving the assembly of components through the distance between the image sensor 300 and the last lens, and enhancing joint reliability. If the BFL does not satisfy Equation 56, some of the emitted light may not be transmitted to the effective region of the image sensor, thereby degrading the resolution. Preferably, 0.3<CT1/BFL<0.9 may be satisfied.

$$2 mm < F < 8 mm \qquad [ Equation 57 ]$$

Equation 57 can set the overall effective focal length (F) to suit the vehicle optical system. Equation 57 may satisfy the ranges: 2 mm<F<6 mm or 2 mm<F<5 mm.

$$80 degrees < FOV < 150 degrees \qquad [ Equation 58 ]$$

In Equation 58, FOV (Field of View) means the diagonal field of view (Degree) of the optical system 1000, and a vehicle optical system with an angle exceeding 80 degrees may be provided. Preferably, 90 degrees<FOV<135 degrees may be satisfied. The FOV may be a minimum value for the reception performance range. Here, the horizontal field of view of the optical system 1000 may be less than the diagonal field of view and greater than 90 degrees, and the vertical field of view may be less than the horizontal field of view and greater than 70 degrees.

$$1 < T T L / CA\_Max < 3 \qquad [ Equation 59 ]$$

CA_Max means the largest effective diameter (mm) among the object-side and sensor-side surfaces of the plurality of lenses. Equation 59 establishes a relationship between the overall optical axis length of the optical system and the maximum effective diameter, thereby providing an improved vehicle optical system. Equation 59 preferably satisfies: 1.2<TTL/CA_Max<2. Here, CA_Max is the effective diameter of the object-side surface of the first lens.

$$5 < TTL / ImgH < 10 \qquad [ Equation 60 ]$$

Equation 60 may establish the overall optical axis length (TTL) of the optical system and the diagonal length (ImgH) from the optical axis of the image sensor 300. When the optical system 1000 according to the embodiment satisfies Equation 60, the optical system 1000 may have a TTL for application to the vehicle image sensor 300, thereby providing improved image quality. Equation 60 preferably satisfies: 6<TTL/ImgH<9.

$$1 < BFL / ImgH < 3 \qquad [ Equation 61 ]$$

Equation 61 can set the relationship between the optical axis distance (BFL) between the image sensor 300 and the last lens and the length in the diagonal direction from the optical axis of the image sensor 300. When the optical system 1000 according to the embodiment satisfies Equation 61, the optical system 1000 may secure a BFL (Back Focal Length) for applying the size of the vehicle image sensor 300, set the distance between the last lens and the image sensor 300, and have good optical characteristics in the center and periphery of the FOV. Equation 61 preferably satisfies: 1.2<BFL/ImgH<2, and may satisfy the condition of BFL>ImgH.

$$1 < TTL / BFL < 10 \qquad [ Equation 62 ]$$

Equation 62 can set the overall optical axis length (TTL) of the optical system and the optical axis distance (BFL) between the image sensor 300 and the last lens. If the optical system 1000 according to the embodiment satisfies Equation 62, the optical system 1000 can secure BFL. That is, by setting the TTL to less than 40 mm, a sufficient BFL may be secured to provide an optical system for a vehicle. Equation 62 preferably satisfies: 3<TTL/BFL<8.

$$5 < TTL / F < 15 \qquad [ Equation 63 ]$$

Equation 63 can set the overall focal length (F) and overall optical axis length (TTL) of the optical system 1000. Accordingly, an optical system for a driver assistance system or driver monitoring may be provided. Equation 63 preferably satisfies: 6<TTL/F<10. When the optical system 1000 according to the embodiment satisfies Equation 63, the optical system 1000 can have an appropriate focal length within a set TTL range and can provide an optical system that can form an image while maintaining an appropriate focal length even when the temperature changes from low to high. If it is below the lower limit of Equation 63, the power of the lenses needs to be increased, making it difficult to correct spherical aberration or distortion aberration. If it is above the upper limit of Equation 63, the effective diameter or TTL of the lenses may become longer, which may cause a problem of the imaging lens system becoming larger.

$$0 < F / BFL < 2 \qquad [ Equation 64 ]$$

Equation 64 may set the overall effective focal length (F) of the optical system 1000 and the optical axis distance (BFL) between the image sensor 300 and the last lens. When the optical system 1000 according to the embodiment satisfies Equation 64, the optical system 1000 can have a set field of view and an appropriate focal length, and may be provided as an optical system for a vehicle. In addition, the optical system 1000 can minimize the distance between the last lens and the image sensor 300, thereby providing excellent optical characteristics at the periphery of the FOV. Equation 64 preferably satisfies: 0.4<F/BFL<1.

$$0 < F / ImgH < 2 \qquad [ Equation 65 ]$$

Equation 65 can set the total effective focal length (F) of the optical system 1000 and a value (ImgH) that is half of the diagonal length of the image sensor 300. Such an optical system 1000 can have improved aberration characteristics in the size of the image sensor 300 for a vehicle. Equation 65 preferably satisfies: 0.5<F/ImgH<1.2.

$$0 < F / EPD < 2 \qquad [ Equation 66 ]$$

Equation 66 can set the overall effective focal length (F) and entrance pupil size of the optical system 1000. Accordingly, the overall brightness of the optical system may be controlled. Equation 66 preferably satisfies: 0.5<F/EPD<1.5.

$$0 < BFL / TD < 0.5 \qquad [ Equation 67 ]$$

Equation 67 may set the relationship between the optical axis distance (TD) and the back focal length (BFL) of the lenses of the optical system 1000. Accordingly, the overall size of the optical system may be controlled while maintaining the resolution. Equation 67 preferably satisfies: 0.1<BFL/TD<0.4. If the conditional value of BFL/TD exceeds 0.5, the BFL is designed to be large relative to the TD, which increases the size of the entire optical system, making it difficult to miniaturize the optical system. Furthermore, the distance between the third lens and the image sensor increases, which can increase the amount of unnecessary light passing between the third lens and the image sensor, resulting in deteriorated aberration characteristics and reduced resolution.

$$0 < EPD / ImgH / FOV < 0.2 \qquad [ Equation 68 ]$$

Equation 68 can establish the relationship between the entrance pupil diameter (EPD), the half (ImgH) of the diagonal length of the image sensor, and the diagonal field of view. Accordingly, the overall size and brightness of the optical system may be controlled. Preferably, Equation 68 satisfies: 0<EPD/ImgH/FOV<0.05.

$$50 < FOV / F \# \qquad [ Equation 69 ]$$

Equation 69 may set the relationship between the diagonal field of view and the F number of an optical system. Preferably, Equation 69 satisfies: 70<FOV/F #. Here, F # is provided to be 2.0 or less, thereby providing a bright image.

$$70 < TTL * nL < 110 \qquad [ Equation 70 ]$$

Equation 70 may set the number of lenses by multiplying the total length of the optical system by the total number nL of lenses. Preferably, Equation 70 satisfies: 80<TTL*nL<100. Color dispersion and refraction angles may be controlled by glass lenses in an optical system with a TTL of less than 40 mm.

$$70 < TTL * nGL < 110 \qquad [ Equation 70 - 1 ]$$

Equation 72 may set the number of TTL and glass lenses, and can control chromatic dispersion and refraction angles using glass lenses in an optical system with a TTL of less than 40 mm.

$$8 < ImgH * nL < 15 \qquad [ Equation 71 ]$$

Equation 71 is a value obtained by multiplying half of the diagonal length of the image sensor by the number nL of lenses, and can set the length of the image sensor according to the number of lenses. Preferably, Equation 71 satisfies: 10<ImgH*nL<14. Color dispersion and refraction angles may be controlled using glass lenses in an optical system with an ImgH of less than 5 mm.

$$1 < Nss / Nass < 3 \qquad [ Equation 72 ]$$

Equation 72 may set the number Nss of spherical surfaces and the number Nass of aspherical surfaces among the lens surfaces. If Equation 73 is satisfied, light may be guided to the entire region of the image sensor by adjusting the spherical and aspherical lens surfaces of the lenses.

$$[ Equation 73 ]$$

$$Z = \frac{c {Y}^{2}}{1 + \sqrt{1 - ( 1 + K ) {c}^{2} {Y}^{2}}} + {AY}^{4} + B {Y}^{6} + {CY}^{8} + {DY}^{10} + {EY}^{12} + {FY}^{14} + …$$

In Equation 73, Z represents Sag, which can refer to the distance along the optical axis from an arbitrary location on the aspherical surface to the apex of the aspherical surface. Y can refer to the distance from an arbitrary location on the aspherical surface to the optical axis in a direction perpendicular to the optical axis. c can refer to the curvature of the lens, and K can refer to the conic constant. Additionally, A, B, C, D, E, and F can refer to aspheric coefficients.

The optical system 1000 according to the embodiment may satisfy at least one or two or more mathematical equations from Equations 1 to 36. At least one or two or more of Equations 1 to 36 may satisfy at least one or two or more of Equations 37 to 72. By satisfying the mathematical equations, the optical system 1000 has improved optical characteristics and improved resolution, and can improve aberration and distortion characteristics. In addition, the optical system 1000 can secure a BFL (Back focal length) for applying a vehicle image sensor 300, can compensate for optical characteristic degradation due to temperature change, and can minimize the distance between the last lens and the image sensor 300, thereby providing good optical performance at the center and periphery portions of the FOV.

Table 1 shows the items of the Equations described above in the optical system 1000 of the first embodiment, including the TTL (Total track length) (mm), BFL (Back focal length), effective focal length F (mm), ImgH (mm), effective diameter CA (mm), thickness (mm), TTL (mm), TD (mm), which is the optical axis distance from the first surface S1 to the sixth surface S6, the focal lengths F1, F2, and F3 (mm) of each of the first to third lenses, the sum of the refractive indices, the sum of the Abbe numbers, the sum (mm) of the center thicknesses of each lens, the sum of the distances between adjacent lenses, the diagonal FOV (Degree), the edge thickness ET, the focal lengths of the first and second lens groups, and the F number, etc. of the optical system 1000.

TABLE 1

| Items | Embodiment | Items | Embodiment |
|---|---|---|---|
| F | 3.831 | ET1 | 5.071 |
| F1 | −7.829 | ET2 | 1.949 |
| F2 | 12.507 | ET3 | 2.126 |
| F3 | 10.091 | F-number | 123.333 |
| FLG1 | −7.829 | FOV (Diagonal) | 3.482 |
| FLG2 | 6.587 | EPD | 6.025 |
| ΣNd | 5.502 | BFL | 23.975 |
| ΣAd | 88.539 | TD | 4.000 |
| ΣCT | 12.087 | ImgH | 12.781 |
| ΣCG | 11.888 | SD | 123.333 |
| ΣET | 9.147 | TTL | 3.482 |

Table 2 shows the results for the Equations 1 to 72 described above in the optical system 1000 of the first embodiment. Referring to Table 2, it may be seen that the optical system 1000 satisfies at least one or two or more of Equations 1 to 36. It may be seen that the optical system 1000 satisfies at least one or two or more of Equations 37 to 72. The optical system may satisfy at least one or two or more of Equations 1 to 72. Accordingly, the optical system 1000 can have good optical performance and superior optical characteristics at the center and periphery portion of the FOV.

TABLE 2

| Equations | | Values |
|---|---|---|
| 1 | 0.5 < CT1/CT2 < 1.5 | 0.976 |
| 2 | 1 < CG1/CT1 < 3 | 2.489 |
| 3 | Po1 < 0 | Satisfaction |
| 4 | 1.75 < Nd3 < 2.2 | 1.847 |
| 5 | L1R1 > 0 | 22.82 |
| 6 | L1R1/L1R2 < \|L1R2/L2R1\| | Satisfaction |
| 7 | 1 < CG1/BFL < 3 | 1.708 |
| 8 | 1 < CA11/CA12 < 4 | 2.1 |
| 9 | 0 < (CA12*CT1)/(CA21*CT2) < 1 | 0.642 |
| 10 | 0.1 < CT1/(CT2 + CT3) < 1 | 0.52 |
| 11 | 0.5 < CT2/CT3 < 1.5 | 1.139 |
| 12 | 1 < CA11/CA31 < 3 | 1.53 |
| 13 | 1 < CA2/CT2 < 5 | 3.054 |
| 14 | 0.5 < CA22/CA31 < 1.5 | 1.097 |
| 15 | 1 < CT2/CG2 < 4 | 2.647 |
| 16 | 0 < CT3/CG2 < 1 | 0.625 |
| 17 | 0.5 < Max_Sag11/Max_Sag12 < 1.5 | 0.658 |
| 18 | 2 < CG1/Max_Sag12 < 5 | 3.745 |
| 19 | 0 < \|Max_Sag32/Max_Sag31\| < 1 | 0.399 |
| 20 | \|Max_Sag22\| < \|Max_Sag31\| | Satisfaction |
| 21 | CA2/(Imgh*2) > CA3/(Imgh*2) | Satisfaction |
| 22 | (Imgh*2) < CA12 < CA21 | Satisfaction |
| 23 | 0 < DLG1/DLG2 < 1 | 0.433 |
| 24 | 0 < CG1/TTL < 0.6 | 0.343 |
| 25 | 0 < CT3/TTL < 0.3 | 0.124 |
| 26 | 0 < \|L2R1/L3R2\| < 1 | 0.516 |
| 27 | 1 < L3R1/CT3 < 10 | 2.246 |
| 28 | 1 < L1R1/L1R2 < 10 | 4.978 |
| 29 | 0 < \|L2R2/L3R1\| < 0.5 | 0.114 |
| 30 | (Nd1*Vd1) < (Nd3*Vd3) | Satisfaction |
| 31 | 0 < CT_Max/CG_Max < 1 | 0.412 |
| 32 | 0.8 < CT_Max/CT_Min < 3 | 1.139 |
| 33 | (CT_Max/CT_Min) < (CA_Max/CA_Min) | Satisfaction |
| 34 | 0.5 < ΣCT/ΣCG < 1.5 | 1.017 |
| 35 | 1 < ΣNd < 10 | 5.502 |
| 36 | 10 < ΣVd/ΣNd < 30 | 16.092 |
| 37 | 1 < CA11/CA_Min < 4 | 2.1 |
| 38 | 1 < CA_ST1/CA_ST2 < 4 | 3.253 |
| 39 | 1 < CA_ST1/CA11 < 1.6 | 1.214 |
| 40 | 0.5 < CA_ST2/CA12 < 1.5 | 0.784 |
| 41 | 1 < CA_Max/(2*ImgH) < 3 | 2.244 |
| 42 | 1 < TD/CA_Max < 3 | 1.336 |
| 43 | 0 < CT_Max/TD < 0.7 | 0.177 |
| 44 | 0 < F/CA31 < 0.5 | 0.094 |
| 45 | 0 < F/L1R1 < 0.3 | 0.048 |
| 46 | 1 < Max (CT/ET) < 3 | 2.173 |
| 47 | 0 < EPD/L1R1 < 1 | 0.153 |
| 48 | 0.5 < \|F1/F3\| < 1.5 | 0.776 |
| 49 | Po2 * Po3 > 0 | Satisfaction |
| 50 | 10 < Vd3 − Vd2 < 30 | 17.186 |
| 51 | 0.5 < \|F1/F23\| < 2 | 1.188 |
| 52 | 20 < TTL < 40 | 30 |
| 53 | 2 < ImgH | 4 |
| 54 | 3 < BFL < 8 | 6.025 |
| 55 | 0 < BFL/CG1 < 1 | 0.586 |
| 56 | 0 < CT1/BFL < 1 | 0.686 |
| 57 | 2 < F < 8 | 3.831 |
| 58 | 80 < FOV < 150 | 123.33 |
| 59 | 1 < TTL/CA_Max < 3 | 1.671 |
| 60 | 5 < TTL/ImgH < 10 | 7.5 |
| 61 | 1 < BFL/ImgH < 3 | 1.506 |
| 62 | 1 < TTL/BFL < 10 | 4.979 |
| 63 | 5 < TTL/F < 15 | 7.831 |
| 64 | 0 < F/BFL < 2 | 0.636 |
| 65 | 0 < F/ImgH < 2 | 0.958 |
| 66 | 0 < F/EPD < 2 | 1.1 |
| 67 | 0 < BFL/TD < 0.5 | 0.251 |
| 68 | 0 < EPD/Imgh/FOV < 0.2 | 0.009 |
| 69 | 50 < FOV/F# | 112.121 |
| 70 | 70 < TTL*nL < 110 | 90 |
| 71 | 8 < ImgH*nL < 15 | 12 |
| 72 | 1 < Nss/Nass < 3 | 2 |

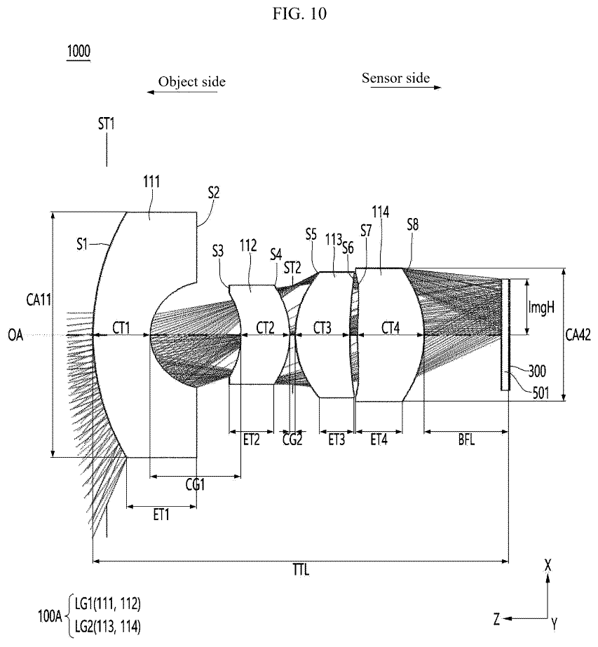

FIGS. 10 to 17 are drawings illustrating an optical system and a camera module having the same according to a second embodiment.

Referring to FIG. 10, a first lens group LG1 and a second lens group LG2 of an optical system 1000 according to a second embodiment of the invention may be sequentially arranged along an optical axis OA from an object toward an image sensor 300. The number of lenses of each of the first lens group LG1 and the second lens group LG2 may be the same. The number of lenses of the first lens group LG1 or the second lens group LG2 may be 1 or 2 or more. The optical axis distance of the first lens group LG1 may be greater than the optical axis distance of the second lens group LG2. The optical axis distance of the first lens group LG1 is the distance along the optical axis from the first surface S1 to the fourth surface S4, and the optical axis distance of the second lens group LG2 is the distance along the optical axis from the fifth surface S5 to the eighth surface S8. The first lens group LG1 may include two or fewer lenses, for example, two lenses. The second lens group LG2 may include two or more lenses, for example, two lenses. The optical system 1000 may include n lenses, where the n-th lens may be the lens closest to the image sensor 300, and the n−1th lens may be the lens closest to the n-th lens. “n” is an integer less than or equal to 5, for example, 4.

The first lens group LG1 may include at least one lens made of glass. The first lens group LG1 may provide a lens closest to the object side as a glass lens. The lenses of the first lens group LG1 may have a spherical lens surface. The second lens group LG2 may include a plurality of lenses made of glass. The second lens group LG2 may include lenses having a spherical lens surface and lenses having an aspherical lens surface. The lenses having the spherical surface may be made of glass. The lenses having the aspherical surface may be made of glass or plastic, for example, glass. The aspherical lenses in the second lens group LG2 may be made of a glass mold material. The lenses made of the glass mold material are injection-molded lenses having an aspherical surface.

The optical system 1000 may include at least one spherical lens adjacent to the object and at least one aspherical lens adjacent to the image sensor 300. Additionally, the number of spherical lenses may be greater than the number of aspherical lenses. The second lens group LG2 may include at least one spherical lens and at least one aspherical lens. The number of aspherical lenses in the second lens group LG2 may be equal to the number of spherical lenses. Here, the n-th lens, which is closest to the image sensor 300, may be provided as an aspherical lens to inhibit degradation of optical performance. The aspherical lens can inhibit spherical aberration within the optical system 1000 and suppress aberration even when the effective diameter increases, thereby improving the miniaturization and weight reduction of the camera module. The optical system 1000 combines spherical and aspherical lenses to enable thermal compensation within the lens barrel, thereby suppressing degradation of optical characteristics due to temperature changes. Furthermore, since the optical system 1000 includes at least one aspherical lens, various aberrations may be suppressed.

The Abbe number of the lenses of the optical system 1000 may be in the range of 20 to 50, and the refractive index may be in the range of 1.5 to 2.0. The Abbe number and the refractive index may control the chromatic dispersion by the lenses. Here, the lens with the maximum refractive index may be the last lens, and the lens with the maximum Abbe number may be the last lens. The refractive index of the i-th lens is Ndi, the Abbe number of the i-th lens is Adi, and the value of Ndi*Adi may be maximum when i is 4. In addition, the value of Ndi*Adi of 60 or more may be i=4. The lens 112 having the minimum effective diameter within the optical system 1000 may satisfy the condition that the value of Ndi*Adi is 40<(Ndi*Adi)<60, and * represents multiplication.

The lens surface having the maximum effective diameter within the lens unit 100A is a spherical lens and may be arranged closest to the object. A lens surface with a maximum effective diameter can refract incident light across the entire region and improve incidence efficiency. Furthermore, the lens 111 with the maximum effective diameter is a spherical lens or a glass lens. The lens 111 closest to the object may have the largest difference in effective diameter between the object-side surface and the sensor-side surface. The lens 112 with the minimum effective diameter is a spherical lens or a glass lens. The lens 112 with the minimum effective diameter may be located on the object side of the aperture ST2 disposed between the lenses.

The lens closest to the image sensor 300 may be an aspherical lens or glass. Embodiments of the invention can reduce the weight of the camera module, lower manufacturing costs, and suppress degradation of optical characteristics due to temperature changes by combining spherical and aspherical lenses within the optical system 1000.

Within the optical system 1000, the TTL (Total top length) may be more than 5 times, for example, more than 5 times and less than 10 times, than the ImgH. Preferably, the condition of 5<TTL/ImgH<10 may be satisfied. The TTL (Total track length) is the optical axis distance from the center of the object-side surface of the first lens 111 to the surface of the image sensor 300. The ImgH is the length from the optical axis to the end of the effective region in the diagonal direction of the image sensor 300. The ImgH is half of the maximum diagonal length of the effective region of the image sensor 300. Within the optical system 1000, the effective focal length (EFL) may be provided to be 10 mm or less and the FOV may be provided to be more than 80 degrees, and may be provided as a standard optical system in a vehicle camera module. That is, the optical system 1000 has a wide field of view and can reduce the focal length to 10 mm or less. For example, the optical system and camera module according to the embodiment may be applied to a camera module for LiDAR equipped in a vehicle. For example, light transmitted by a transmission module is reflected by an object, and the camera module receives the reflected light. Such a camera module for LiDAR may be selectively applied to devices such as a collision warning avoidance system, a blind spot monitor, lane keeping assist, lane departure warning, and adaptive cruise control, and can provide functions that assist drivers and make autonomous driving safer and more comfortable. The total number of lenses in the first and second lens groups LG1 and LG2 is 5 or less or 4 or less. Accordingly, the optical system 1000 can provide an image formed without exaggeration or distortion.

The number of lenses having an effective diameter greater than the diagonal length of the image sensor 300 within the optical system 1000 may be 2 or more or 3 or less. The diagonal length of the image sensor 300 may be smaller than the maximum effective diameter of the lenses and larger than the minimum effective diameter. The diagonal length of the image sensor 300 may be smaller than the diameter of the aspherical lens.

The sensor-side surface of the first lens 111, which is closest to the object within the lens unit 100A, may have an effective diameter smaller than the sensor-side surface of the last lens, which is closest to the image sensor 300. Accordingly, the center thickness of the first lens of the optical system may be thicker than the center thickness of the last lens, and the angle of refraction and chromatic dispersion may be adjusted. Accordingly, the optical system can compensate for the degradation of optical characteristics due to resolution and temperature changes, improve chromatic aberration control characteristics, and improve the vignetting characteristics of the optical system 1000.

The optical system 1000 may include an aperture stop that controls the amount of incident light. The aperture stop may have one or two aperture stops. The two aperture stops may be spaced apart from each other. For example, as illustrated in FIG. 10, the aperture stop of the optical system may include an upper aperture stop ST1 positioned around the object-side surface of the first lens 111 closest to the object, and an inner aperture stop ST2 positioned between the lenses.

For the lenses positioned between the object and the inner aperture stop ST2, the average effective diameter of the lenses tends to decrease from the object toward the inner aperture stop ST2. For the lenses positioned between the inner aperture stop ST2 and the image sensor 300, the average effective diameter of the lenses tends to decrease from the inner aperture stop ST2 toward the image sensor 300. Here, the average effective diameter is the average of the effective diameters of the object-side and sensor-side surfaces of each lens. As another example, if the aperture stop is a single element, it may be positioned between the first lens group LG1 and the second lens group LG2. In contrast, the peripheral surface of at least one lens selected from among the plurality of lenses may function as an inner aperture stop ST. In detail, the flange portion of the object-side surface or the sensor-side surface of one lens selected from among the lenses of the optical system 1000 may function as an inner aperture stop ST for controlling the amount of light.

The second distance CG2 between the first lens group LG1 and the second lens group LG2 in the optical axis direction may be the distance between the sensor-side surface of the first lens group LG1 and the object-side surface of the second lens group LG2 in the optical axis direction. The second distance CG2 may be the center distance between adjacent spherical lenses. In addition, the second distance CG2 may be smaller than the center distance CG3 between adjacent spherical lenses and aspherical lenses. Accordingly, the effective diameter of the lens located on the sensor side of the inner aperture stop ST2 may be suppressed from increasing. Accordingly, the optical system 1000 may be suppressed from increasing in size in a direction orthogonal to the optical axis OA.

Here, the first lens group LG1 may include lenses positioned closer to the object side than the inner aperture stop ST2, and the second lens group LG2 may include lenses positioned closer to the sensor side than the inner aperture stop ST2. The first lens group LG1 and the second lens group LG2 may be divided into an object-side lens group and a sensor-side lens group based on the inner aperture stop ST2. The sensor-side surface of the first lens group LG1 may have a convex shape on the optical axis, and the object-side surface of the second lens group LG2 may have a convex shape on the optical axis, and the sensor-side surface of the first lens group LG1 and the object-side surface of the second lens group LG2 may face each other.

The optical axis distance of the first lens group LG1 is the optical axis distance from the object-side surface S1 to the sensor-side surface S4. That is, the optical axis distance of the first lens group LG1 is the optical axis distance between the object-side surface S1 of the first lens 111 closest to the object and the sensor-side surface S4 of the lens located closer to the object than the inner aperture stop ST2. The optical axis distance of the second lens group LG2 is the optical axis distance between the object-side surface S5 of the lens 113 closest to the object side of the second lens group LG2 and the sensor-side surface S8 of the lens 114 closest to the image sensor 300. The optical axis distance of the second lens group LG2 is the optical axis distance between the object-side surface S5 of the lens closest to the first lens group and the sensor-side surface S8 of the last lens. The optical axis distance of the first lens group LG1 may be greater than the optical axis distance of the second lens group LG2.

The optical axis distance between the last lens and the image sensor 300 is the BFL, which may be greater than the maximum center thickness of the lenses and may be 4.2 mm or greater.

The first lens group LG1 may have negative (−) power, and the second lens group LG2 may have positive (+) power. The lens closest to the object side of the first lens group LG1 may have negative (−) power, and the lens closest to the sensor side of the second lens group LG2 may have positive (+) power. When the focal length of the first lens group LG1 is FLG1 and the focal length of the second lens group LG2 is FLG2, the condition of the Equation: FLG2<|FLG1| may be satisfied.

Additionally, within the optical system 1000, the number of lenses with negative (−) power may be smaller than the number of lenses with positive (+) power. The number of lenses with negative (−) power may be 40% or less of the total number of lenses, for example, in the range of 20% to 40%. When three or more glass lenses are arranged within a camera module, durability and heat resistance are improved, internal stress generated during the lens manufacturing process may be suppressed, and optical performance degradation may be inhibited. Furthermore, the use of glass lenses can improve chromatic aberration at high refractive indices.

The first lens group LG1 refracts light incident through the object side toward the optical axis, and the second lens group LG2 refracts light incident through the first lens group LG1 toward the periphery of the image sensor 300. The optical axis distance between the first lens group LG1 and the second lens group LG2 may be smaller than the minimum center thickness of the lenses.

The average Abbe number of the spherical material lenses within the lens unit 100A may be smaller than the Abbe number of the aspherical lens. The average refractive index of the spherical material lenses within the lens unit 100A may be smaller than the refractive index of the aspherical lens. Since the lens closest to the object provides the maximum effective diameter, the field of view may be widened compared to the focal length. The sum of the refractive indices of the lenses of the lens unit 100A may be 9 or less, for example, in the range of 6 to 9, and the average refractive index may be 1.5 or more, for example, in the range of 1.5 to 1.75. The sum of the Abbe numbers of each of the lenses may be 200 or less, for example, in the range of 130 to 200, and the average Abbe number may be 45 or less, for example, in the range of 20 to 45. The sum of the center thicknesses of the entire lens may be 12 mm or greater, for example, in the range of 12 mm to 20 mm or 14 mm to 18 mm. The average of the center thicknesses of the entire lens may be 3 mm or greater, for example, in the range of 3 mm to 5 mm. The sum of the center distances between the lenses along the optical axis OA may be 5 mm or greater, for example, in the range of 5 mm to 9 mm or 6 mm to 8.5 mm, and may be less than the sum of the center thicknesses of the lenses.

Furthermore, the average effective diameter of each lens surface of the lens unit 100A may be 8 mm or greater, for example, in the range of 8 mm to 16 mm or 8 mm to 13 mm. The difference between the maximum and minimum effective diameters of each lens surface may be 10 mm or greater, for example, in the range of 10 mm to 15 mm. Accordingly, in the optical system, since lenses having an average center thickness of the entire lens of 3 mm or more and an average effective diameter of 8 mm or more are provided, the assemblability between the lenses and the lens barrel may be improved.

The F number (F #) of the optical system or camera module may be less than 2, for example, in the range of 1.0 to 1.5 or in the range of 1.0 to 1.2. In the optical system according to an embodiment of the invention, the field of view (diagonal FOV) may be greater than 80 degrees, for example, greater than 80 degrees and less than 150 degrees, or in the range of 110 degrees to 135 degrees. Here, the horizontal field of view of the optical system is less than 110 degrees, for example, in the range of 75 degrees to 110 degrees, and may be smaller than the diagonal field of view. The vertical field of view of the optical system is less than 90 degrees, in the range of 60 degrees to 90 degrees, and may be smaller than the horizontal field of view. The horizontal field of view is a field of view measured based on the horizontal length of the image sensor 300, and the vertical field of view is a field of view measured based on the vertical length of the image sensor 300. The image sensor 300 may have, for example, a diagonal sensor length of 8.0 mm+0.5 mm, a horizontal sensor length of 6.400 mm+0.5 mm, and a vertical sensor height of 4.80 mm+0.5 mm. Accordingly, it is possible to suppress changes in the focus imaging position due to temperature changes, and provide a vehicle camera in which various aberrations are well corrected.

When the optical system 1000 has a diagonal FOV of 110 to 135 degrees and includes at least one spherical lens and at least one aspherical lens, the center thickness of the aspherical fourth lens 114 closest to the image sensor 300 may be the thickest. Accordingly, the number of glass lenses and the center thickness of the glass lenses within the optical system 1000 can reduce the influence on optical performance, i.e., changes in optical performance due to temperature changes from low to high temperatures.

The optical system 1000 or camera module may include an image sensor 300. The description of the image sensor 300 will be described in the first embodiment. The diagonal length of the image sensor 300 may be 50% or less of the maximum effective diameter of the lens surfaces, for example, 35% to 50% or 35% to 45%.

The optical system 1000 or camera module may include an optical filter 501. The optical filter 501 may be disposed between the second lens group LG2 and the image sensor 300. The optical filter 501 may be disposed between the lens closest to the sensor side among the lenses of the lens unit 100A and the image sensor 300. For example, the optical filter 501 may be disposed between the last lens and the image sensor 300. The optical filter 501 may include an infrared filter or an infrared cut-off filter (IR cut-off). The optical filter 501 may allow light of a set wavelength band to pass through and filter light of a different wavelength band. When the optical filter 501 includes an infrared filter, it may block radiant heat emitted from external light from being transmitted to the image sensor 300. In addition, the optical filter 501 can transmit visible light and reflect infrared light. The optical filter 501 can transmit a wavelength of 920 nm or more, for example, a wavelength band of 920 nm to 960 nm. As another example, the optical filter 501 may transmit at least one wavelength of a lidar, for example, 905 nm±20 nm or 1550 nm±20 nm. A cover glass (not shown) may be placed between the optical filter 501 and the image sensor 300.

The second embodiment may provide the first lens 111 as a glass material. Since the first lens 111 has a convex shape facing the driver from inside the vehicle, it can more effectively inhibit foreign matter accumulation and scratches, and improve the incidence efficiency. This can improve the reliability of the driver monitoring camera module. The last lens within the lens unit 100A may be an aspherical lens. The optical system 1000 may further include a reflective member (not shown) for changing the path of light. Reference will now be made to the description of the first embodiment.

The optical system according to the second embodiment of the invention will now be described.

Referring to FIGS. 10 to 12, the optical system 1000 according to the second embodiment includes a lens unit 100A, which may include the first lens 111 to the fourth lens 114. The first and second lenses 111 and 112 are lenses of the first lens group LG1 and are the closest lenses to the object. The third and fourth lenses 113 and 114 are lenses of the second lens group LG2, and the fourth lens 114 is the closest lens to the image sensor 300. The focal lengths of the first to fourth lenses 111-114 are F1, F2, F3, and F4, the composite focal length of the first and second lenses 111 and 112 is F12, and the composite focal length of the third and fourth lenses is F34, and at least one of the following conditions may be satisfied.

$$\vert F 1 \vert < F 3 < F 2 \qquad Condition 1$$

$$F 34 < \vert F 12 \vert \qquad Condition 2$$

$$( \vert F 12 \vert + F 3 ) < F 2 \qquad Condition 3$$

$$F 34 < F 4 < F 3 \qquad Condition 4$$

Each of the first to fourth lenses 111-114 may have positive (+) or negative (−) power. The first lens 111 may have negative (−) power. The first lens 111 may be made of plastic or glass, for example, glass. The glass-based first lens 111 can reduce changes in center position and radius of curvature due to temperature changes in the surrounding environment and can protect the incident surface of the optical system 1000. On the optical axis OA, the object-side first surface S1 of the first lens 111 may be convex, and the sensor-side second surface S2 may be concave. The first lens 111 may have a meniscus shape convex toward the object on the optical axis. The first lens 111 may be a spherical lens made of glass, and the first surface S1 and the second surface S2 may be spherical. Alternatively, the first surface S1 may have a concave shape and the second surface S2 may have a convex shape on the optical axis OA. The first lens 111 may have the thickest thickness among the spherical lenses, thereby inhibiting a decrease in rigidity against external impact, and suppressing a change in optical performance when the temperature changes due to the glass material. In addition, since the spherical shape is applied to the glass material, even if the lens is designed to be thick, the change in the refractive index of light may not be large. Here, the thickness of the lens may be the center thickness. The first lens 111 has a convex first surface S1 and a concave second surface S2 on the optical axis, thereby refracting incident light in a direction closer to the optical axis and reducing the effective diameter of the second lens 112. At least one or both of the first surface S1 and the second surface S2 may be provided without a critical point from the optical axis OA to the end of the effective region.

The upper aperture stop ST1 may be arranged around the periphery of the first surface S1 of the first lens 111. The position of the upper aperture stop ST1 may be arranged lower than the apex of the first surface S1 of the first lens 111. That is, the position of the upper aperture stop ST1 may be arranged between a straight line perpendicular to the optical axis OA at the apex of the first surface S1 of the first lens 111 and a straight line perpendicular to the optical axis at the edge of the first surface S1. The hole diameter of the upper aperture stop ST1 may be larger than the effective diameter of the first surface S1. When the hole diameter of the upper aperture stop ST1 is CA_ST1 and the effective diameter of the first surface S1 is CA11, the following condition may be satisfied.

$$1 < CA\_ST1 / CA 11 < 1.6 \qquad Condition$$

The upper aperture stop ST1 adjusts the incident angle of light incident on the edge of the first surface S1 of the first lens 111, and by adjusting the incident angle, light incident on the outside of the 1.0 field of the image sensor 300, i.e., the 1.1 field, may be blocked. That is, since the upper aperture stop ST1 is provided within the above range, it can significantly reduce the relative illuminance value incident on the 1.1 field of the image sensor 300 by blocking invalid light incident outside the 1.0 field.

The second lens 112 may be disposed between the first lens 111 and the third lens 113. The second lens 112 may have positive power on the optical axis OA. The second lens 112 may be made of plastic or glass. For example, the second lens 112 may be made of glass. The object-side third surface S3 of the second lens 112 on the optical axis OA may be concave, and the sensor-side fourth surface S4 may have a convex shape. The second lens 112 may have a convex meniscus shape facing the sensor along the optical axis. Alternatively, the third surface S3 may be convex, and the fourth surface S4 may be concave. Alternatively, the second lens 112 may have a concave shape on both sides. Alternatively, the third surface S3 may be convex, and the fourth surface S4 may be convex. The second lens 112 may be provided as a spherical lens made of glass. The third surface S3 and the fourth surface S4 may be spherical. At least one or both of the third surface S3 and the fourth surface S4 may be provided without a critical point from the optical axis OA to the end of the effective region.

The third lens 113 may have positive (+) power. The third lens 113 may include a plastic or glass material. For example, the third lens 113 may be a spherical lens made of glass. On the optical axis OA, the fifth surface S5 on the object side of the third lens 113 may have a convex shape, and the sixth surface S6 on the sensor side may have a concave shape. The third lens 113 may have a meniscus shape that is convex toward the object on the optical axis OA. Alternatively, the third lens 113 may have a meniscus shape that is convex toward the sensor side. Alternatively, the third lens 113 may have a convex shape on both sides, or a concave shape on both sides. The fifth surface S5 and the sixth surface S6 of the third lens 113 may be spherical on the optical axis, and at least one or both of the fifth surface S5 and the sixth surface S6 may be provided without a critical point from the optical axis OA to the end of the effective region.

The inner aperture stop ST2 serves as a member for controlling the amount of light and may be positioned around the sensor-side surface of the second lens 112. The inner aperture stop ST2 may be positioned around the area between the second lens 112 and the third lens 113. The hole diameter of the inner aperture stop ST2 may have a difference of less than ±20% of the effective diameter of the sensor-side fourth surface S4 of the second lens 112. Accordingly, the amount of light passing through the second lens 112 may be controlled. When the hole diameter of the inner aperture stop ST2 is CA_ST2 and the effective diameter of the fourth surface S4 is CA22, the following condition may be satisfied.

$$0.8 < CA\_ST2 / CA 22 < 1.2 \qquad Condition$$

Preferably, 0.8<CA_ST2/CA22≤1 may be satisfied. Specifically, 0.9<ST1_CA/CA22<1 may be satisfied. Since the hole diameter of the inner aperture stop ST2 is provided within the above range, the amount of light passing through the second lens 112 may be controlled, and an increase in the effective diameter of the seventh surface S7 of the third lens 113 may be suppressed. Since the inner aperture stop ST2 is arranged on the periphery between the second and third lenses 112 and 113, the difference in effective diameter between the second and third lenses 112 and 113 may be reduced. The second lens 112 and the third lens 113 on either side of the inner aperture stop ST2 may have the same power.

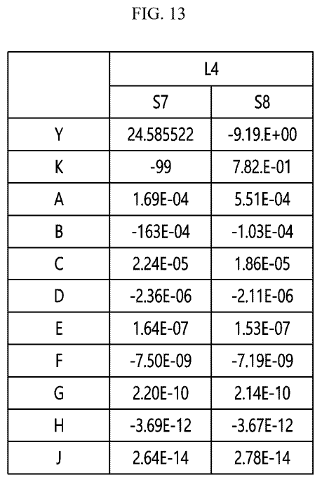

The fourth lens 114 may have positive power. The fourth lens 113 may be made of plastic or glass. For example, the fourth lens 114 may be an aspherical lens made of glass. As another example, the fourth lens 114 may be an aspherical lens made of plastic. The seventh surface S7 on the object side of the fourth lens 114 may be convex on the optical axis OA, and the eighth surface S8 on the sensor side may be convex. The fourth lens 114 may have a convex shape on both sides of the optical axis OA. Alternatively, the fourth lens 114 may have a meniscus shape that is convex toward the sensor side. In contrast, the fourth lens 114 may have a meniscus shape convex toward the object side, or may have a concave shape on both sides. The seventh surface S7 and the eighth surface S8 of the fourth lens 114 may be aspherical on the optical axis, and aspherical coefficients may be provided as L4S7 and L4S8 of FIG. 13. At least one or both of the seventh surface S7 and the eighth surface S8 may have a critical point from the optical axis OA to the end of the effective region. For example, the seventh surface S7 may have at least one critical point, and the eighth surface S8 may be provided without a critical point from the optical axis to the end of the effective region. The critical point is a point where the trend of the Sag value changes. That is, it is a point where the Sag value increases and then decreases, or a point where the Sag value decreases and then increases.

The fourth lens 114 may have the thickest center thickness CT4 among the lenses. The fourth lens 114 may be an aspherical lens closest to the image sensor 300. By positioning the aspherical lens closest to the image sensor 300, a deterioration in optical performance may be inhibited, and aberration characteristics and an impact on resolution may be controlled. In addition, by positioning the aspherical lens closest to the image sensor 300, it may be insensitive to assembly tolerances compared to a spherical lens. In other words, being insensitive to assembly tolerances means that even if the assembly is slightly different from the design during assembly, the optical performance may not be significantly affected. In addition, the fourth lens 114 may provide a small difference between the center thickness CT4 and the edge thickness ET4, thereby improving the assembly tolerances.

The center thickness CT1 of the first lens 111 may be thicker than the center thicknesses of the second and third lenses 112 and 113. The edge thickness ET1 of the first lens 111 may be the thickest among the edge thicknesses of the lenses. Since the first lens 111 has a thick thickness and a meniscus shape convex toward the object on the optical axis, the effective diameter of the second surface S2 of the first lens 111 may be reduced, and the center distance CG1 between the first and second lenses 111 and 112 may be increased.

Since the second lens 112 has a convex meniscus shape toward the sensor, the center distance CG2 between the second lens 112 and the third lens 113 may be reduced, and also, in the region between the second lens 112 and the third lens 113, the convex fourth surface S4 and the convex fifth surface S5 can face each other. Since the third lens 113 has a convex meniscus shape toward the object and the fourth lens 114 has a double-sided convex shape, the optical axis distance (i.e., BFL) between the eighth surface S8 of the fourth lens 114 and the image sensor 300 may be increased, and the effective diameter of the fourth lens 114 may be provided to be greater than the diagonal length of the image sensor 300.

Referring to FIG. 11, the distance in the direction of the optical axis from the straight line perpendicular to the optical axis from the center of the object-side fifth surface S5 of the third lens 113 to the fifth surface S5 is Sag31, and the value of Sag3 1 is the distance between the lens surface arranged on the sensor side based on the straight line and the straight line, and may have a positive value. The distance in the direction of the optical axis from the straight line perpendicular to the optical axis from the center of the sensor-side eighth surface S8 of the fourth lens 114 to the eighth surface S8 is Sag42, and the value of Sag42 is the distance between the lens surface arranged on the object side based on the straight line and the straight line, and may have a negative value. In this manner, the Sag value of the sensor-side sixth surface S6 of the third lens 113 may be defined as Sag32 and has a positive value. The Sag value of the object-side seventh surface S7 of the fourth lens 114 may be defined as Sag41 and can have positive or negative values depending on the region. The maximum Sag values of the third and fourth lenses 113 and 114 may satisfy the following conditions:

$$Max\_Sag 31 > Max\_Sag32 \qquad Condition 1$$

$$\vert Max\_Sag42 \vert > \vert Max\_Sag41 \vert \qquad Condition 2$$

$$Max\_Sag31 > \vert Max\_Sag42 \vert \qquad Condition 3$$

The Sag value of the object-side third surface S3 of the second lens 112 may be defined as Sag21, and the sag value of the fourth surface S4 may be defined as Sag22, satisfying the condition: |Sag21|<|Sag22|. Similarly, the Sag value of the object-side first surface S1 of the first lens 111 may be defined as Sag11, and the Sag value of the second surface S2 may be defined as Sag12, satisfying the condition: Max_Sag12>Max_Sag11. The value of Max_Sag12 can have the largest value among the Sag values of the object-side and sensor-side surfaces of the lenses.

A tangent line K3 passing through an arbitrary point on the eighth surface S8 of the fourth lens 114 and a normal line K4 perpendicular to the tangent line K3 may have a predetermined tangential angle θ2 with the optical axis OA. The maximum tangential angle θ2 on the eighth surface S8 in the first direction X may be 35 degrees or less, for example, 5 to 35 degrees or 10 to 25 degrees, with respect to an axis parallel to the optical axis. The maximum tangential angle on the fifth surface S5 of the first direction X may be 45 degrees or less, for example, in the range of 10 degrees to 45 degrees or in the range of 19 degrees to 35 degrees, with respect to an axis parallel to the optical axis. Here, the maximum tangential angle of the lens surfaces is 51 degrees or more, and is the tangential angle of the second surface S2, and may be in the range of 51 degrees to 85 degrees.

As shown in FIGS. 10 and 11, CT1, CT2, CT3, and CT4 are the center thicknesses or optical axis thicknesses of the first, second, third, and fourth lenses 111-114, and ET1, ET2, ET3, and ET4 are the thicknesses in the optical axis direction at the edges of the first, second, third, and fourth lenses 111-114. The center distance between the first and second lenses 111 and 112 is CG1, the center distance between the second and third lenses 112 and 113 is CG2, and the center distance between the third and fourth lenses 113 and 114 is CG3. The edge thickness of each lens is the distance along the optical axis between the object side and the sensor side at the end of the effective region of each lens.

The center thickness and edge thickness of the lenses may satisfy the following conditions:

$$CT 1 < CT 4 \qquad Condition 1$$

$$CT 2 < CT 3 < CT 1 \qquad Condition 2$$

$$ET 4 < ET 1 \qquad Condition 3$$

$$ET 3 < ET 2 < ET 4 \qquad Condition 4$$

The effective diameters of the first lens 111 to the fourth lens 114 are the average of the effective diameters of the object-side and sensor-side surfaces, and are defined as CA1, CA2, CA3, and CA4. The effective diameters of the object-side and sensor-side surfaces of the first lens 111 to the fourth lens 114 may be defined as CA11, CA12, CA21, CA22, CA31, CA32, CA41, and CA42. When the inner aperture stop ST2 is positioned on the sensor-side surface of the second lens 112, at least one of the following conditions may be satisfied.

$$CA 2 < CA 3 < CA 1 \qquad Condition 1$$

$$CA 2 < ( ImgH * 2 ) < CA 3 \qquad Condition 2$$

$$CA 21 < CA 22 < CA 31 \qquad Condition 3$$

$$CA 32 < CA 31 \qquad Condition 4$$

Since the second lens 112, positioned on the object side of the inner aperture stop ST2, has a positive power (F2>0) and a convex meniscus shape toward the sensor, the second lens 112 can refract incident light away from the optical axis. Furthermore, since the second and third lenses 112 and 113 have opposing meniscus shapes, the edge distance between the second and third lenses 112 and 113 may be greater than the center distance. Accordingly, the center distance CG2 between the second and third lenses 112 and 113 may be reduced, inhibiting a decrease in the yield by weight of the optical system and improving production efficiency. Furthermore, an increase in the effective diameter of the third lens 113 positioned on the sensor side of the inner aperture stop ST2 may be inhibited, and the thickness of the camera module may be slimmed down within the field of view range.

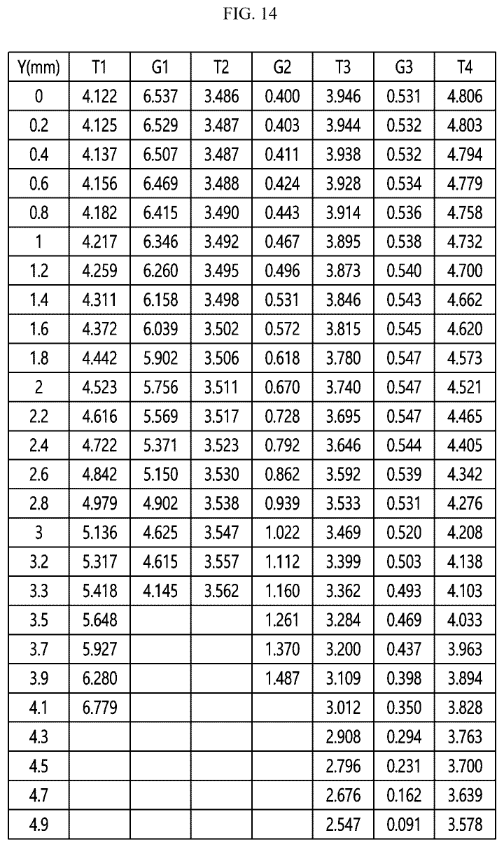

The distance G1 (See FIG. 14) between the first lens 111 and the second lens 112 can gradually decrease from the center to the edge. This distance G1 may gradually decrease from the optical axis toward the edge due to the concave shape of the sensor-side surface of the first lens 111 and the concave shape of the object-side surface of the second lens 112. That is, the distance between the first and second lenses 111 and 112 may have the largest center distance CG1 and the smallest edge distance. The distance G2 (See FIG. 14) between the second lens 112 and the third lens 113 may gradually increase from the center toward the edge. This distance G2 may gradually increase from the optical axis toward the edge due to the convex shape of the sensor-side surface of the second lens 112 and the convex shape of the object-side surface of the third lens 113. That is, the distance between the second lens 112 and the third lens 113 may have the smallest center distance and the largest edge distance.

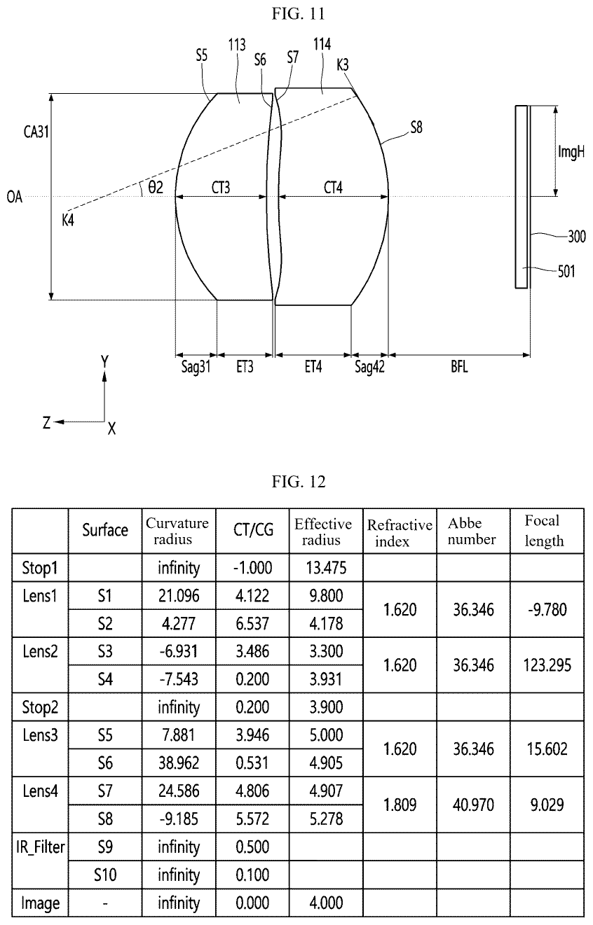

FIG. 12 is an example of lens data of the optical system of the embodiment of FIG. 10. As shown in FIG. 12, the radius of curvature on the optical axis OA of the first to fourth lenses 111-114, the center thickness CT of the lenses, the center distance CG between adjacent lenses, the refractive index at the d-line, the Abbe number, the semi-aperture, and the focal length may be set. The radii of curvature of the first and second surfaces S1 and S2 of the first lens 111 are L1R1 and L1R2, the radii of curvature of the third and fourth surfaces S3 and S4 of the second lens 112 are L2R1, L2R2, the radii of curvature of the fifth and sixth surfaces S5 and S6 of the third lens 113 are L3R1 and L3R2, and the radii of curvature of the seventh and eighth surfaces S7 and S8 of the fourth lens 114 may be expressed as L4R1 and L4R2. These radii of curvature are radii of curvature on the optical axis of each lens surface, and may satisfy at least one of the following conditions.

$$L 1 R 2 < L 1 R 1 \qquad Condition 1$$

$$L 1 R 2 < \vert L 2 R 1 \vert < \vert L 2 R 2 \vert \qquad Condition 2$$

$$L 1 R 2 < L 3 R 1 < L 3 R 2 \qquad Condition 3$$

$$L 4 R 1 < L 3 R 2 \qquad Condition 4$$

$$L 3 R 1 < \vert L 4 R 1 \vert < \vert L 4 R 1 * 2 \vert < L 4 R 1 \qquad Condition 5$$

When the fourth lens 114 is designed as an aspherical surface, thermal compensation may be satisfied and optical performance may be improved, but it may not be as easy to assemble as a spherical lens, and the aspherical fourth lens 114 may affect the optical characteristics of lenses arranged on the object side more than the fourth lens 114 due to the aspherical assemblability. The invention can facilitate assembly by the thickness and curvature radius of the fourth lens 114 having an aspherical surface. Since the second lens 112 having a spherical surface is arranged on the object side of the inner aperture stop ST2 and is the lens most sensitive to optical characteristics, the effective diameter of the third lens 113 may be made larger than that of the second lens 112, and the difference in the curvature radius between the fourth surface S4 of the second lens 112 and the fifth surface S5 of the third lens 113 may be set to 1 mm or less. Additionally, the difference in center thickness between the second lens 112 and the third lens 113 may be set to 1 mm or less. Accordingly, an optical system with a low Chief ray angle (CRA) may be implemented by the inner aperture stop ST2 between the second and third lenses 112 and 113.

Regarding the thicknesses of the lenses, the sum of the center thicknesses of the first to fourth lenses 111-114 may be defined as ΣCT, and the sum of the edge thicknesses of the first to fourth lenses 111-114 may be defined as ΣET. The center thickness CT1 of the first lens 111 may be greater than the center thicknesses CT2 and CT3 of the second and third lenses 112 and 113. Preferably, the maximum thickness among the lenses is the center thickness CT4 of the fourth lens 114. Since the center thickness CT1 of the first lens 111 is 3 mm or thicker and the radius of curvature of the sensor-side second surface S2 is minimal, light incident through the glass lens may be refracted to the edge of the effective region of the last lens. The ratio of the center thickness to the edge thickness of each lens may satisfy the following conditions:

$$0.5 < CT 1 / ET 1 < 1.5 \qquad Condition 1$$

$$0.5 < CT 2 / ET 2 < 1.5 \qquad Condition 2$$

$$1 < CT 3 / ET 3 < 2 \qquad Condition 3$$

$$1 < CT 4 / ET 4 < 2 \qquad Condition 4$$

$$0.8 < \sum CT / \sum ET < 1.3 \qquad Condition 5$$

Here, the sum of the center thicknesses of the lenses is ΣCT, and the sum of the edge thicknesses is ΣET. Furthermore, the thickness of each lens may satisfy the following conditions:

$$0.5 < CT 1 / CT 2 < 1.5 \qquad Condition 1$$

$$0.5 < CT 4 / CT 3 < 1.5 \qquad Condition 2$$

$$0.5 < CT 2 / CT 3 < 1.5 \qquad Condition 3$$

$$0.1 < CT 1 / \sum CT < 0.4 \qquad Condition 4$$

$$0.1 < CT 4 / \sum CT < 0.4 \qquad Condition 5$$

In the above conditions, if CTi/ETi (i=1~4), it may be minimum when i is 1. The difference between the center thickness and the edge thickness of each lens may be set to be greater than 0.01 mm and less than 1.5 mm. This allows the aspherical lens to be placed on the fourth lens 114 to refract the incident light to the periphery of the image sensor 300 without increasing the difference between the center thickness and the edge thickness of each lens. Furthermore, by setting the difference between the center thickness and the edge thickness of the fourth lens 114 to 2 mm or less, the curvature radius difference between the object-side and sensor-side surfaces may be designed to be minimal, improving the assembly of the aspherical fourth lens 114 and reducing the impact on optical characteristics.

Furthermore, the difference between the maximum and minimum center thicknesses of the lenses may be 2.5 mm or less, for example, in the range of 1 mm to 2.5 mm or 1 mm to 2 mm. In other words, even if the center thickness difference between the glass lenses is designed to be minimal, optical performance may be maintained without deterioration, and the camera module may be slimmed down. Furthermore, since the difference between the center and edge thicknesses of each lens is kept small, the impact on optical characteristics may be reduced even if at least one lens is tilted. Furthermore, the impact on thermal characteristics between the center and edge of the lenses may be reduced.

The center distance between the first to fourth lenses 111-114 is defined as CG1, CG2, and CG3, and the sum of the center distances between the first to fourth lenses 111-114 may be defined as ΣCG. The center distance CG3 between the third lens 113 and the fourth lens 114 is the center distance between a spherical lens and an aspherical lens, and may be smaller than the center distance CG1 between the first and second lenses 111 and 112.

Refractive indices are described. The refractive indices of the first to fourth lenses 111-114 may be 1.5 or greater. The first to third lenses 111, 112, and 113 may be made of glass and have a refractive index of 1.65 or less. The first to third lenses 111, 112, and 113 may be made of the same glass material, and may be made of a different glass material from the fourth lens 114. That is, the first to third lenses 111, 112, and 113 may have the same refractive index. The first to third lenses 111, 112, and 113 may have the same Abbe number. The first to third lenses 111, 112, and 113 may be spherical lenses, and the fourth lens 114 may be an aspherical lens.

The difference in refractive index between the first and fourth lenses 111 and 114 is 0.30 or less. The first lens 111 is the glass lens closest to the object and may be thicker than the center thickness of the second and third lenses 112 and 113. The first lens 111 made of glass exhibits less lens shrinkage and movement as the ambient temperature changes from room temperature to low or high temperatures. Therefore, resolution degradation is less severe compared to a plastic lens, even with temperature changes. The first lens 111, located at the very front of the optical system, is made of high-refractive-index glass, which helps minimize changes in resolution of the entire optical system as the ambient temperature changes from room temperature to low or high temperatures. The fourth lens 114, an aspherical lens, can inhibit resolution degradation due to temperature changes.

The focal lengths F2, F3, and F4 of the second to fourth lenses 112, 113, and 114 have positive power, while the focal length F1 of the first lens 111 can have negative power. Accordingly, when each lens repeatedly contracts and expands as the temperature changes from low to high, chromatic aberration may be corrected by the heat-resistant glass lenses.

If the focal lengths are expressed in absolute values, the focal length of the second lens 112 is the largest among the lenses and may be 40 mm or greater, for example, 50 mm or greater. The focal length of the fourth lens 114 is the smallest among the lenses. The absolute difference between the maximum focal length and the minimum focal length may be 35 mm or less. By making the absolute difference in the focal lengths of the first and second lenses 111 and 112, which are spherical lenses, greater than the difference in the focal lengths of the third and fourth lenses 113 and 114, the optical system can have improved MTF characteristics, aberration control characteristics, and resolution characteristics within the set field of view range, and can have good optical performance in the periphery of the field of view.

As shown in FIG. 13, among the lenses of the lens unit 100A in the embodiment, the lens surface of the fourth lens 114 may include an aspherical surface having a 20th-order aspherical surface coefficient. For example, the fourth lens 114 may include a lens surface having a 20th-order aspherical surface coefficient. As described above, an aspherical surface having a 20th-order aspherical surface coefficient (a non-zero value) can significantly change the aspherical shape of the periphery, thereby effectively compensating for the optical performance in the periphery of the FOV.

As shown in FIG. 14, the thicknesses T1-T4 of the first to fourth lenses 111-114 and the distances between adjacent lenses G1, G2, and G3 may be set. As shown in FIG. 14, the thicknesses T1-T4 of each lens may be indicated at intervals of 0.1 mm or more in the Y-axis direction from the optical axis toward the edge of each lens, and the distances between adjacent lenses G1, G2, and G3 may be indicated at intervals of 0.1 mm or more.

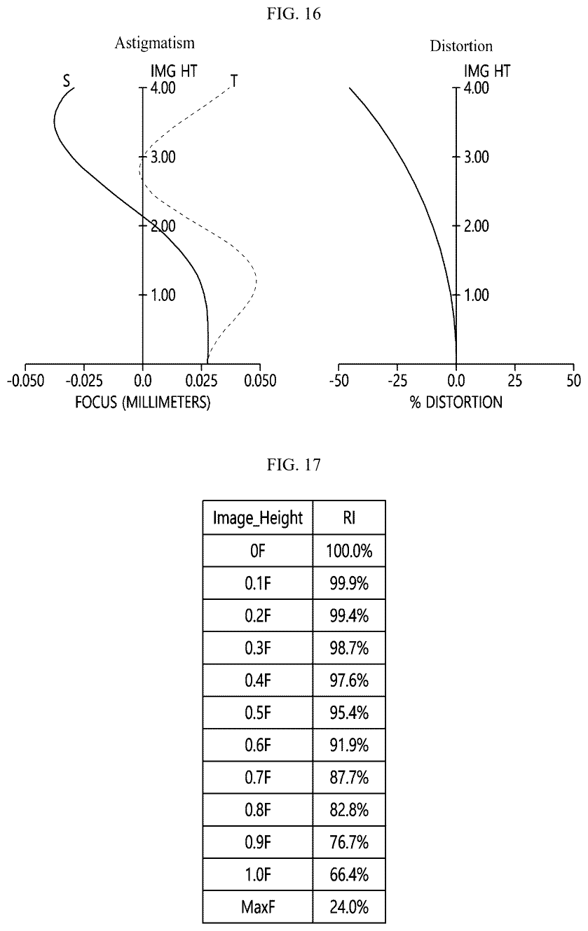

FIG. 17 is a table showing the peripheral illumination ratio or relative illumination from the center of the image sensor to the image height, that is, from 0 to the maximum height (MaxF=1.1 F), in the optical system according to the second embodiment. It may be seen that the ambient light ratio from the center of the image sensor to the diagonal end (1.0 F) is greater than 60%, for example, greater than 64%. That is, it may be seen that the difference in ambient illuminance according to low temperature, room temperature, and high temperature is almost the same from the optical axis to the end of the effective region. Accordingly, since the minimum amount of light from the center to the end of the image sensor exceeds 60%, a more accurate sensing value may be obtained in the entire region of the image sensor. Here, 60%<1.0 F_RI<100% is satisfied, so the minimum amount of light for sensor accuracy may be secured in 1.0 field. 1.0 F_RI represents the relative illuminance value in 1.0 field. Since 0%<Max_RI<30% is satisfied, the relative illuminance value in Max_RI, which is 1.1 field, is set to less than 30%, which may be set as the minimum condition for suppressing measurement errors.

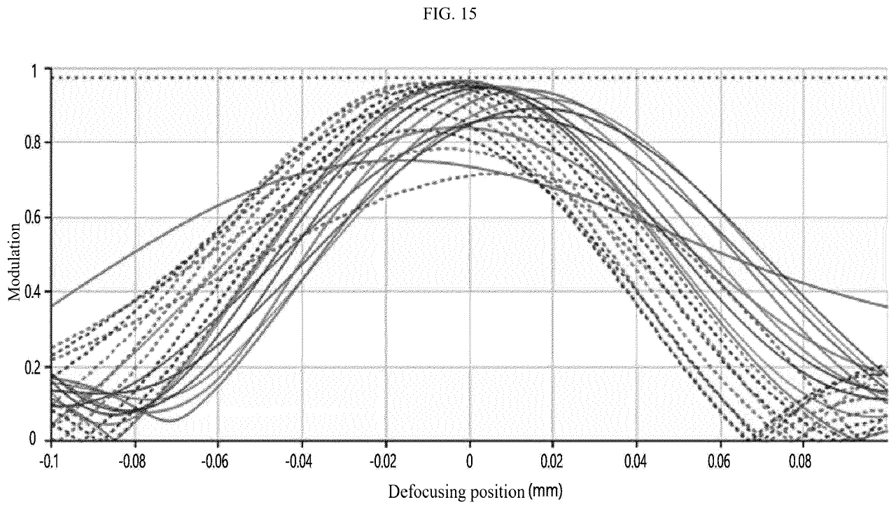

FIG. 15 is a graph showing the diffraction MTF at room temperature in the optical system of FIG. 10, and is a graph showing the modulation ratio according to the spatial frequency. As in FIG. 15, the x-axis represents the defocusing position, and the y-axis represents the MTF, and the graphs are measured in 0.400 mm increments from 0.000 mm to 4.400 mm from F1 to F23.

FIG. 16 is a graph showing the aberration characteristics in the optical system of FIG. 10. In the aberration graph of FIG. 16, astigmatic field curves and distortion are measured from left to right.

In FIG. 16, the x-axis can represent the focal length (mm) and distortion (%), and the y-axis can represent the height of the image. In addition, the graph for astigmatism and distortion aberration is a graph for light in the wavelength band of approximately 940 nm. In the aberration diagram of FIG. 16, the closer each curve is to the Y-axis, the better the aberration correction function may be interpreted. It may be seen that the optical system 1000 according to the embodiment has measured values close to the Y-axis in almost all areas. That is, the optical system 1000 according to the embodiment has improved resolution and can have good optical performance even in the center and periphery portions of the FOV. Here, the low temperature is −20 degrees or lower, for example, in the range of −20 to −40 degrees, the room temperature is in the range of 22 degrees±5 degrees or in the range of 18 degrees to 27 degrees, and the high temperature may be 80 degrees or higher, for example, in the range of 80 degrees to 105 degrees. Accordingly, it may be seen that the decrease in the luminance ratio (modulation) from low temperature to high temperature is less than 10%, for example, 5% or lower, or is almost unchanged.

The optical system 1000 may be designed to enable temperature compensation for the aspherical lens even if at least one aspherical lens is used in the lens unit 100A, and can inhibit a decrease in the reliability of the optical characteristics. In addition, it may be seen that the effective focal length, TD, BFL, F number (F #), diagonal FOV, etc. hardly change even when the temperature changes from room temperature to low or high. Here, TD is the optical axis distance from the center of the object-side surface of the first lens 111 to the center of the sensor-side surface of the last lens 114. The optical system 1000 according to the second embodiment may satisfy at least one or two or more of the mathematical equations described below. For example, when the optical system 1000 satisfies at least one mathematical equation, the optical system 1000 can effectively control aberration characteristics such as chromatic aberration and distortion aberration, and can exhibit excellent optical performance at the center and periphery portions of the FOV. In addition, the optical system 1000 can exhibit improved resolution. Furthermore, the thickness of the lenses along the optical axis OA and the spacing between adjacent lenses along the optical axis OA described in the mathematical equations may refer to the embodiments disclosed above.

$$1 < C T 1 / C T 2 < 2 \qquad [ Equation 1 ]$$

Equation 1 can control chromatic aberration of the optical system by setting the difference in the center thickness of the first and second lenses to a small value. Preferably, 1<CT1/CT2<1.5 may be satisfied. By setting the center thickness of each of the first and second lenses 111 and 112 having a spherical surface, the optical performance at the center and periphery of the FOV may be improved.

$$1 < C G 1 / C T 1 < 3 \qquad [ Equation 2 ]$$

The center distance between the first and second lenses 111 and 112 and the shape of the first lens 111 may suppress an increase in the effective diameter of the second lens 112.

$$Po 1 < 0 \qquad [ Equation 3 ]$$

In Equation 3, Po1 may be set to have an effective focal length (F) smaller than the TTL for the performance of the optical system. Accordingly, the condition TTL>F may be satisfied. Furthermore, a wide field of view may be set by the focal length and effective focal length of the first lens 111. In other words, the focal length of the first lens 111 is F1, and F1<0 may be satisfied.

$$1.75 < N d 4 < 2.2 \qquad [ Equation 4 ]$$

Nd4 is the refractive index of the fourth lens 114 at the d-line. Equation 4 sets the refractive index of the fourth lens 114 high, thereby controlling the factors affecting the reduction of the third-order aberration (Seidel aberration) of the optical system, and reducing aberrations that may occur as the TTL becomes somewhat longer. Equation 4 can preferably satisfy: 1.75<Nd4<2. If it is designed to be lower than the lower limit of Equation 4, performance may be obtained by reducing aberrations, but the power of the fourth lens 114 may be weakened, making it difficult to refract light efficiently, thereby degrading the performance of the optical system. If it is designed to be higher than the upper limit of Equation 4, there is a disadvantage in that it becomes difficult to obtain materials. In addition, if the refractive index of the fourth lens 114 is designed to be lower than the lower limit of Equation 4, in order to increase the power of the third lens, the radius of curvature of the fourth lens must be increased, which makes lens manufacturing more difficult, increases the lens defect rate, and may lower the yield.

$$1.5 < A v e r ( Nd 1 : Nd 4 ) < 1.8 \qquad [ Equation 4 - 1 ]$$

In Equation 4-1, Aver(Nd1:Nd4) is the average of the refractive index values at the d-line of the first to fourth lenses. If the optical system 1000 according to the embodiment satisfies Equation 4-1, the optical system can set the resolution and suppress the influence of TTL.

$$L 1 R 1 > 0 \qquad [ Equation 5 ]$$

L1R1 may be set to be greater than 0. If the radius of curvature of the first surface S1 of the first lens 111 satisfies Equation 5, the shape of the optical system may be restricted. The object-side surface of the first lens 111 has a convex shape toward the object from the optical axis, which can increase the amount of incident light. In addition, since the condition of L1R1*L1R2>0 is satisfied, the incident light may be refracted in a direction closer to the optical axis. Accordingly, the embodiment can increase the center distance between the first and second lenses 111 and 112, and provide the effective diameter of the third surface S3 of the second lens 112 to be smaller than the effective diameter of the second surface S2 of the first lens 111.

$$L 1 R 1 / L 1 R 2 > \vert L 2 R 2 / L 2 R 1 \vert \qquad [ Equation 6 ]$$

The difference in curvature radius between the object-side surface and the sensor-side surface of the first lens 111 is provided to be larger than the difference in curvature radius between the sensor-side and object-side surfaces of the second lens 112, thereby improving the incidence efficiency and suppressing an increase in the effective diameter of the second lens 112.

$$L 3 R 1 < L 3 R 2 \qquad [ Equation 6 - 1 ]$$

L3R1 is the radius of curvature of the object-side surface of the third lens 113, and L3R2 is the radius of curvature of the sensor-side surface of the third lens. Since the second lens has a meniscus shape convex toward the sensor, and the third lens has a meniscus shape convex toward the object, an increase in the effective diameter of the fourth lens 114 may be suppressed, and a decrease in the radius of curvature of the object-side surface of the fourth lens 114 may be suppressed. Furthermore, since the condition: |L4R2|<L4R1 is satisfied, the radius of curvature of the sensor-side surface of the aspherical fourth lens 114 may be set small, thereby increasing the distance between the image sensor 300 and the fourth lens 114.

$$0.5 < C G 1 / B F L < 1.5 \qquad [ Equation 7 ]$$

BFL (Back Focal Length) is the optical axis distance from the center of the sensor-side surface of the last lens, i.e., the fourth lens 114 to the surface of the image sensor 300. If the optical system satisfies Equation 7, the diagonal length of the image sensor 300 may be set to be less than 50%, for example, less than 40%, of the TTL, thereby setting the conditions for manufacturing a vehicle camera module. In addition, BFL can set the space in which components such as an optical filter 501 or an optical filter/cover glass located between the image sensor 300 and the fourth lens 114 may be placed. If the range of Equation 7 is smaller than the lower limit, the space for placing circuit structures such as optical filters and image sensors becomes more restricted, making the process of assembling circuit structures such as filters and image sensors into the optical system difficult. If the range of Equation 7 exceeds the upper limit, the process of assembling circuit structures such as filters and image sensors into the optical system becomes easier, but the TTL becomes longer, making miniaturization of the optical system difficult. Preferably, the relationship 0.8<CG1/BFL<1.4 may be satisfied.

$$1 < CA 11 / CA 12 < 4 \qquad [ Equation 8 ]$$

By setting the effective diameter of the concave sensor-side surface of the first lens 111 to be smaller than the effective diameter of the convex object-side surface of the first lens, the distance between the first and second lenses 111 and 112 and the effective diameter of the second lens 112 may be adjusted. Preferably, the relationship 1.5<CA11/CA12<2.5 may be satisfied. Specifically, the relationship 2≤CA11/CA12<2.5 may be satisfied.

The effective diameter of the object-side first surface S1 of the first lens 111 may be more than 1.5 times, i.e., 2 times or more, of the effective diameter of the second surface S2. The effective diameter of the object-side first surface S1 of the first lens 111 may be more than 2 times, i.e., 2.5 times or more, of the effective diameter of the third surface S3 of the second lens 112. The effective diameter of the object-side first surface S1 of the first lens 111 may be more than 2 times the effective diameter of the fourth surface S4 of the second lens 112.

$$1 < ( CA 12 * CT 1 ) / ( CA 21 * CT 2 ) < 3 \qquad [ Equation 9 ]$$

In Equation 9, the difference between the values of (CA12*CT1) and (CA21*CT2) is designed to be small, thereby improving spherical aberration. Preferably, 1.2<(CA12*CT1)/(CA21*CT2)<2 may be satisfied. The difference in effective diameter between the object-side surface and the sensor-side surface of each of the second to fourth lenses 112, 113, and 114 may be less than 2 times, for example, 0.5 times or more and 1.5 times or less.

$$0.1 < C T 1 / ( C T 3 + C T 4 ) < 1 \qquad [ Equation 10 ]$$

Equation 10 may be designed so that the difference between the sum of the center thickness CT1 of the first lens 111 and the center thicknesses CT3 and CT4 of the third and fourth lenses 113 and 114 is not significant. In this case, since the first and third lenses 111 and 113 are spherical lenses, assembly performance may be improved. Furthermore, since the fourth lens 114 is an aspherical lens, spherical aberration caused by the spherical lenses may be corrected. Furthermore, since the fourth lens is an aspherical lens made of glass, thermal compensation may be satisfied and optical performance may be improved. Preferably, 0.2<CT1/(CT3+CT4)<0.9 may be satisfied.

$$0.5 < C T 4 / C T 3 < 1.5 \qquad [ Equation 11 ]$$

Equation 11 inhibits assembly degradation, improves aberration characteristics, and suppresses the influence on optical characteristics by ensuring that the difference in center thickness between the third lens 113, the final spherical lens, and the fourth lens 114, the aspherical lens, is not too large. Preferably, 1<CT4/CT3<1.4 may be satisfied.

$$1 < CA 11 / CA 41 < 3 \qquad [ Equation 12 ]$$

CA11 means an effective diameter of the first surface S1 of the first lens 111, and CA41 means the effective diameter of the seventh surface S7 of the fourth lens 114. When Equation 12 is satisfied, the size of the optical system 1000 may be set to control the incident light path and adjust factors affecting aberration. Preferably, Equation 12 satisfies: 1.5<CA11/CA41<2.5. Since the first and fourth lenses satisfy Equation 12, the difference in effective diameters between the first and fourth lenses is not significant, which reduces the influence of assembly and the optical influence of temperature changes.

$$1 < C A 2 / C T 2 < 5 \qquad [ Equation 13 ]$$

If the optical system satisfies Equation 13, the center thickness of the second lens 112 with an effective diameter of 10 mm or less may be set. Preferably, 1.5<CA2/CT2<2.5 may be set.

$$1.5 < C A 3 / C T 3 < 5 \qquad [ Equation 13 - 1 ]$$

If the optical system satisfies Equation 13-1, the center thickness of the third lens 113 with an effective diameter of 8 mm or greater may be set. Preferably, 2<CA3/CT3<3 may be satisfied.

$$0.5 < C A 22 / C A 31 < 1.5 \qquad [ Equation 14 ]$$

When the optical system 1000 according to the embodiment satisfies Equation 14, light traveling within the second lens group LG2 may be controlled, and factors affecting lens sensitivity may be set. Equation 14 preferably satisfies 0.5<CA22/CA31<1. Since the second and third lenses satisfy Equation 14, the size for assembling the spherical lenses may be set.

$$3 < C T 2 / C G 2 < 12 \qquad [ Equation 15 ]$$

In Equation 15, the TTL may be adjusted by setting the center thickness of the second lens 112 and the center distance between the second and third lenses 112 and 113. Here, CG2<CT2<CG1 may be satisfied.

$$3 < C T 3 / C G 3 < 12 \qquad [ Equation 16 ]$$

In Equation 16, the TTL may be adjusted by setting the center thickness of the third lens 113 and the center distance between the third and fourth lenses 113 and 114. Here, CG3<CT3<CG1 may be satisfied. Additionally, CT2 and CT3 can each be 3 mm or greater.

$$0.5 < Max\_Sag11 / Max\_Sag12 < 1.5 \qquad [ Equation 17 ]$$

When the first lens 111 satisfies Equation 17, the radius of curvature and effective diameter of the object-side and sensor-side surfaces of the first lens 111 may be set. Preferably, 0.5<Max_Sag11/Max_Sag12<1 may be satisfied.

$$1.5 < CG 1 / Max\_Sag12 < 3 \qquad [ Equation 18 ]$$

When the optical system satisfies Equation 18, the center distance CG1 between the first and second lenses 111 and 112 may be set based on the maximum sag value of the concave sensor-side surface of the first lens 111, i.e., the concave depth of the sensor-side surface. Preferably, 1.8<CG1/Max_Sag12<2.5 may be satisfied.

$$5 < \vert Max\_Sag42 / Max\_Sag41 \vert < 20 \qquad [ Equation 19 ]$$

Max_Sag41 is the maximum optical axis distance from the center of the object-side seventh surface S7 of the fourth lens 114 to the seventh surface S7 from a straight line perpendicular to the optical axis OA. Max_Sag42 is the maximum optical axis distance from a straight line perpendicular to the optical axis from the center of the sensor-side eighth surface S8 of the fourth lens 114 to the eighth surface S8. When the fourth lens 114 satisfies Equation 19, the radius of curvature and effective diameter of the object-side surface and the sensor-side surface of the fourth lens may be set. In addition, the object-side surface and the sensor-side surface of the fourth lens can have a Sag value for refracting light to the entire region of the image sensor 300.

$$\vert Max\_Sag22 \vert < \vert Max\_Sag31 \vert \qquad [ Equation 20 ]$$

By setting the maximum sag value of the sensor-side surface of the second lens 112 to be smaller than the maximum sag value of the object-side surface of the third lens 113, the distance between the second and third lenses 112 and 113 may be reduced, and light refracted through the second lens 112 may be uniformly incident on the entire region of the third lens 113.

$$C A 2 / ( Imgh * 2 ) < C A 3 / ( Imgh * 2 ) \qquad [ Equation 21 ]$$

The Imgh value is half of the diagonal length of the image sensor 300, and the average effective diameter of the third lens 113 may be set to be larger than the average effective diameter of the second lens 112. Furthermore, CA2<(Imgh*2) and (Imgh*2)<CA3 may be satisfied.

CA21<(Imgh*2)<CA12 [Equation 22]

CA12 is the effective diameter of the second surface S2 of the first lens 111, and CA21 is the effective diameter of the third surface S3 of the second lens 112. The diagonal length of the image sensor 300 may be set to be greater than the effective diameter of the second surface S2 of the first lens 111 and less than the effective diameter of the third surface S3 of the second lens 112.

$$1 < D L G 1 / D L G 2 < 2 \qquad [ Equation 23 ]$$

DLG1 is the optical axis distance of the first lens group LG1, for example, the optical axis distance from the object-side surface of the first lens 111 to the sensor-side surface of the second lens 112. DLG2 is the optical axis distance of the second lens group LG2, for example, the optical axis distance from the object-side surface of the third lens 113 to the sensor-side surface of the fourth lens 114. When the optical system satisfies Equation 23, the optical axis distances of five or fewer lenses may be set based on the position of the inner aperture stop ST2. In Equation 23, the optical axis distance of the first lens group DLG1 disposed on the object side of the inner aperture stop ST1 is provided to be greater than the optical axis distance of the second lens group LG2, thereby correcting distortion and chromatic aberration caused by the first lens 111. Preferably, 1.2<DLG1/DLG2<1.8 may be satisfied. Since Equation 23 is satisfied, aberrations and distortions that may occur in optical systems with a TTL of 20 mm or more may be reduced.

$$0 < CG 1 / TTL < 0.3 \qquad [ Equation 24 ]$$

In Equation 24, by setting the center distance CG1 between the first and second lenses 111 and 112 relative to the overall length (TTL), the effective diameter, radius of curvature, refractive index, Abbe number, etc. of the first and second lenses may be set. Preferably, 0<CG1/TTL<0.2 may be satisfied.

$$0 < C T 3 / TTL < 0.3 \qquad [ Equation 25 ]$$

In Equation 25, by setting the center thickness of the third lens 113 within the above range relative to TTL, light incident through the first and second lenses 111 and 112 may be refracted across the entire region of the image sensor 300, thereby improving chromatic aberration of the optical system. Preferably, 0<CT3/TTL<0.2 may be satisfied.

$$0.5 < CT 3 / ImgH < 1.5 \qquad [ Equation 25 - 1 ]$$

In Equation 25-1, by setting the center thickness of the third lens 113 within the above range relative to ImgH, changes in optical characteristics due to temperature changes may be reduced.

$$0 < \vert L 2 R 1 / L 3 R 2 \vert < 1 \qquad [ Equation 26 ]$$

In Equation 26, the curvature radii of the object-side surface of the second lens and the sensor-side surface of the third lens may be set to control the power of the second and third lenses. Accordingly, excellent optical performance may be achieved at the center and periphery portions of the field of view. Preferably, Equation 26 satisfies: 0<|L2R1/L3R2|<0.4.

$$0.5 < \vert L 3 R 1 / L 4 R 2 \vert < 1.5 \qquad [ Equation 26 - 1 ]$$

L4R2 means the curvature radius of the eighth surface S8 of the fourth lens 114. In Equation 26-1, the curvature radii of the object-side surface of the third lens and the sensor-side surface of the fourth lens may be set to control the power of the third and fourth lenses. Accordingly, excellent optical performance may be achieved at the center and periphery portions of the field of view. Preferably, Equation 26-1 satisfies: 0.5<|L3R1/L4R2|<1.2.

$$1 < L 4 R 1 / C T 4 < 10 \qquad [ Equation 27 ]$$

L4R1 is the radius of curvature of the seventh surface S7 of the fourth lens 114. When the optical system satisfies Equation 27, the power of the aspherical fourth lens 114 may be controlled and assembly degradation may be inhibited by setting the radius of curvature and center thickness of the object-side surface of the fourth lens 114. Preferably, 3<L4R1/CT4<8 may be satisfied.

$$1 < L 1 R 1 / L 1 R 2 < 10 \qquad [ Equation 28 ]$$

When the first lens 111 satisfies Equation 28, the angle of refraction of light incident on the object-side surface of the first lens 111 may be adjusted. Preferably, 3<L1R1/L1R2<6 may be satisfied.

$$0.5 < \vert L 2 R 2 / L 3 R 1 \vert < 1.5 \qquad [ Equation 29 ]$$

The radius of curvature of the sensor-side surface of the second lens 112 may be a negative value, and the radius of curvature of the object-side surface of the third lens 113 may be a positive value. Accordingly, by setting the radius of curvature of the two lens surfaces facing each other in the first and second lens groups, spherical aberration may be controlled. Preferably, 0.8<|L2R2/L3R1|<1.2 may be satisfied.

$$( Nd 1 * Vd 1 ) < ( Nd 4 * Vd 4 ) \qquad [ Equation 30 ]$$

In the optical system, Nd1 and Nd4 are the refractive indices of the first and fourth lenses 111 and 114 at the d-line, and Vd1 and Vd4 are the Abbe numbers of the first and fourth lenses. The relationship between the refractive index and Abbe number of the spherical first lens 111 and the refractive index and Abbe number of the aspherical fourth lens 114 may be set. By setting the refractive index and Abbe number of the aspherical fourth lens, incident light may be guided to the fourth lens.

$$0 < CT\_Max / CG\_Max < 1 \qquad [ Equation 31 ]$$

Equation 31 can set the relationship between the maximum center thickness CT_Max among lenses and the maximum center distance CG_Max between adjacent lenses. When Equation 31 is satisfied, the optical system can exhibit good optical performance at a focal length within a set field of view and can reduce the TTL. Preferably, 0.5<CT_Max/CG_Max<1 may be satisfied.

$$1 < CT\_Max / CT\_Min < 3 \qquad [ Equation 32 ]$$

Equation 32 sets the difference in the center thicknesses of the lenses to less than 3, thereby improving the assembly of the lenses. Preferably, 1<CT_Max/CT_Min<2 may be satisfied.

$$( CT\_Max / CT\_Min ) < ( CA\_Max / CA\_Min ) \qquad [ Equation 33 ]$$

Equation 33 sets the difference in the effective diameters of the lens surfaces to be greater than the difference in the center thicknesses of the lenses, thereby reducing the influence of optical characteristics and inhibiting deterioration in assembly in an optical system with 5 or fewer or 4 or fewer lenses. Here, the difference in effective diameter between the object-side and sensor-side surfaces of the first lens 111 may be greater than the difference in effective diameter between the object-side and sensor-side surfaces of the second, third, and fourth lenses 112, 113, and 114. Furthermore, the difference in effective diameter between the object-side and sensor-side surfaces of the second lens 112 may be 3 mm or less. The difference in effective diameter between the object-side and sensor-side surfaces of the third lens 113 may be 3 mm or less. Furthermore, the difference in effective diameter between the object-side and sensor-side surfaces of the fourth lens 114 may be 3 mm or less. In this way, by adjusting the effective diameter and curvature radius of the object-side and sensor-side surfaces of each lens, the angle of refraction of light traveling through five or fewer or four or fewer lenses may be adjusted.

$$1 < Σ C T / Σ C G < 4 \qquad [ Equation 34 ]$$

In Equation 34, ΣCT is the sum of the center thicknesses of the lenses, and ΣCG is the sum of the center distances between adjacent lenses. When Equation 34 is satisfied, the optical system can have good optical performance at a focal length at a set field of view and can reduce the TTL. Preferably, the embodiment may satisfy 1.5<ΣCT/ΣCG<3.

$$1 < Σ N d < 10 \qquad [ Equation 35 ]$$

When Equation 35 is satisfied, the TTL may be controlled and improved resolution may be achieved in an optical system 1000 comprising a mixture of aspherical lenses and spherical lenses. Furthermore, by arranging glass lenses with relatively high refractive indices and spherical lenses with relatively large center distances in the optical axis direction, the number of lenses may be reduced. Equation 35 can preferably satisfy: 5<ΣNd<8.

$$10 < Σ V d / Σ N d < 30 \qquad [ Equation 36 ]$$

If Equation 36 is satisfied, the optical system 1000 can have improved aberration characteristics and resolution. In Equation 36, the optical characteristics may be controlled by setting the Abbes sum and the sum of the refractive indices of the lenses, and preferably, 17<ΣVd/ΣNd<27 may be satisfied.

$$1 < CA 11 / CA\_Min < 4 \qquad [ Equation 37 ]$$

If Equation 37 is satisfied, the optical system can control incident light, maintain optical performance, and provide a slimmer module. Equation 37 preferably satisfies: 2<CA11/CA_Min<3.5. Furthermore, since CA11 is CA_Max, the conditions may satisfy: 1<CA_Max/CA_Min<4 or 2<CA_Max/CA_Min<3.5.

$$1 < CA\_ST1 / CA\_ST2 < 4 \qquad [ Equation 38 ]$$

CA_ST1 is the hole diameter of the upper aperture stop ST1 positioned around the object-side surface of the first lens 111, and CA_ST2 is the hole diameter of the inner aperture stop ST2 positioned around the perimeter between the second and third lenses 112 and 113. By adjusting the hole diameters of the upper and inner apertures ST1 and ST2, unnecessary light may be blocked and the amount of internal light may be controlled. Preferably, 3<CA_ST1/CA_ST2<4 may be satisfied.

$$1 < CA\_ST1 / CA 11 < 1.6 \qquad [ Equation 39 ]$$

Equation 39 can establish the relationship between the hole diameter of the upper aperture stop ST1 and the effective diameter of the object-side surface of the first lens 111. Accordingly, the upper aperture stop ST1 can block light that exceeds the 1.0 field area of the image sensor 300 on the object-side surface of the first lens 111. Preferably, 1.1<CA_ST1/CA11<1.5 may be satisfied.

$$0.5 < CA\_ST2 / C A 22 < 1.5 \qquad [ Equation 40 ]$$

Equation 40 can establish a relationship between the hole diameter of the inner aperture stop ST2 and the effective diameter of the sensor-side surface of the second lens 112. Accordingly, the inner aperture stop ST2 can control the amount of light passing through the sensor-side surface of the second lens 112. Preferably, 0.8<CA_ST2/CA22<1.2 may be satisfied.

$$1 < CA\_Max / ( 2 * ImgH ) < 3 \qquad [ Equation 41 ]$$

Equation 41 may be set to the maximum effective diameter CA_Max of the lens surfaces and the diagonal length of the image sensor. If this is satisfied, the optical system can maintain good optical performance and be sized for a slim and compact structure. Preferably, 2<CA_Max/(2*ImgH)<3 may be satisfied.

$$1 < T D / CA\_Max < 3 \qquad [ Equation 42 ]$$

TD is the optical axis distance from the center of the object-side surface of the first lens 111 to the center of the sensor-side surface of the fourth lens 114. Specifically, TD is the maximum optical axis distance of the lenses. If Equation 42 is satisfied, the total optical axis distance of the lenses and the maximum effective diameter of the lens surfaces may be set, thereby sizing the system for good optical performance. Equation 42 preferably satisfies: 1<TD/CA_Max<2.

$$TD > S D 1 \qquad [ Equation 42 - 1 ]$$

The SD1 is the optical axis distance from the position of the upper aperture stop ST1 to the center of the sensor-side surface of the last lens. The upper aperture stop ST1 may be positioned lower than the apex of the object-side surface of the first lens 111. The position of the upper aperture stop ST1 may be positioned between a straight line perpendicular to the apex of the object-side surface of the first lens 111 and the edge of the object-side surface of the first lens 111.

$$TD > S D 2 \qquad [ Equation 42 - 2 ]$$

The SD2 is the optical axis distance from the position of the inner aperture stop ST2 to the center of the sensor-side surface of the last lens.

$$0 < CT\_Max / TD < 0.7 \qquad [ Equation 43 ]$$

Equation 43 sets the maximum center thickness and maximum optical axis distance TD of the lenses, thereby improving optical performance. Preferably, 0.1<CT_Max/TD<0.5 may be satisfied.

$$0 < F / C A 41 < 0.5 \qquad Equation 44 ]$$

F may be 10 mm or less, for example, in the range of 1 mm to 10 mm. Equation 44 sets the relationship between the effective focal length and the effective diameter of the object-side surface of the last aspherical lens, thereby controlling the effect on optical system demagnification, such as TTL. Equation 44 preferably satisfies 0<F/CA41<0.2.

$$0 < F / L 1 R 1 < 0.3 \qquad [ Equation 45 ]$$

In Equation 44, the effective focal length of the optical system and the radius of curvature of the object-side surface of the first lens are set, allowing for adjustment of the influence on incident light and TTL. Equation 45 preferably satisfies 0<F/L1R1<0.2.

$$1 < Max ( C T / E T ) < 3 \qquad [ Equation 46 ]$$

If Equation 46 is satisfied, the optical system can adjust the influence on the effective focal length and improve assembly. Equation 46 preferably satisfies: 1<Max (CT/ET)<1.5.

$$0 < E PD / L 1 R 1 < 1 \qquad [ Equation 47 ]$$

If the optical system 1000 satisfies Equation 47, the optical system 1000 can control the incident light. Equation 47 preferably satisfies: 0<EPD/L1R1<0.5. It can also satisfy: EPD<BFL.

$$0.5 < \vert F 1 / F 4 \vert < 1.5 \qquad [ Equation 48 ]$$

If Equation 48 is satisfied, the resolution may be improved by controlling the power of the first and fourth lenses, and the TTL and effective focal length F may be influenced. Preferably, 0.8<|F1/F4|<1.2 may be satisfied. Accordingly, the power of each lens may be controlled to effectively guide light to the aspherical lens. The inner aperture stop ST2 is arranged on the sensor-side surface of the second lens 112. The focal lengths of the lenses arranged on both sides of the inner aperture stop ST2 are greater than 0. In the embodiment of the present invention, the focal length F2 of the second and third lenses 112 and 113 must be designed to be greater than 0. In this case, since the second lens 112 has a meniscus shape convex toward the sensor, the third lens 113 has a meniscus shape convex toward the object, and the center distance between the second and third lenses 112 and 113 is narrow, the effective diameter of the object-side surface of the third lens 113 may be maintained without increasing. The composite focal length F34 of the third and fourth lenses 113 and 114 can have positive power. That is, the composite focal length F34 of the two lenses positioned closer to the sensor than the inner aperture stop ST2 is designed to be greater than 0. In this case, the optical system may be miniaturized by reducing the TTL at horizontal field of view (FOV_H) values of 90° or greater.

$$Po 3 * Po 4 > 0 \qquad [ Equation 49 ]$$

Po3 is the power value of the third lens, and Po4 is the power value of the fourth lens. That is, since the power of the third and fourth lenses has the same amount of power, aberrations may be improved, and light may be effectively guided by the aspherical lens.

$$0 < \vert Vd 3 - Vd 4 \vert < 10 \qquad [ Equation 50 ]$$

If Equation 50 is satisfied, the Abbe number difference between two adjacent lenses may be maintained above a certain value, improving chromatic aberration. Equation 50 preferably satisfies Vd3<Vd4.

$$1 < \vert F 12 / F 34 \vert < 3 \qquad [ Equation 51 ]$$

In Equation 51, the relationship between the composite focal length F12 of the first and second lenses and the composite focal length F34 of the third and fourth lenses is established, allowing the power of the lenses to be controlled, improving resolution, and providing a slim and compact optical system. Equation 51 preferably satisfies: 1.5<F12/F34<2.5.

$$20 mm < TTL < 40 mm \qquad [ Equation 52 ]$$

By setting the TTL in Equation 52 to less than 40 mm, a miniaturized vehicle optical system may be provided. Preferably, the condition may satisfy: 23 mm<TTL<37 mm.

$$2 mm < ImgH \qquad [ Equation 53 ]$$

Equation 53 can set the diagonal length of the image sensor 300 to half, providing an optical system having a vehicle sensor size. Equation 53 preferably satisfies 3 mm<ImgH<5 mm.

$$3 mm < BLF < 8 mm \qquad [ Equation 54 ]$$

In Equation 54, the BFL (Back Focal Length) is set to be greater than 3 mm and less than 8 mm, thereby securing installation space for the optical filter 501 or the optical filter and cover glass, improving the assembly of components through the distance between the image sensor 300 and the last lens, and enhancing joint reliability. Equation 54 preferably satisfies: 4 mm<BFL<7.5 mm. If the BFL falls below the range of Equation 54, some of the light traveling to the image sensor may not be transmitted to the image sensor, which may cause resolution degradation. If the BFL exceeds the range of Equation 54, stray light may be introduced, degrading the aberration characteristics of the optical system.

$$0.5 < BFL / CG 1 < 1.5 \qquad [ Equation 55 ]$$

In Equation 55, by setting the BFL (Back Focal Length) and the center distance CG1 between the first and second lenses, the joint reliability of the components may be improved depending on the installation space of the optical filter 501 and/or the cover glass and the spacing between the glass lenses. In Equation 55, 0.8<BFL/CG1<1.2 may be satisfied. The center distance CG1 between the first and second lenses may be the largest among the center distances between the lenses.

$$0 < C T 1 / BFL < 1 \qquad [ Equation 56 ]$$

In Equation 56, the BFL (Back Focal Length) is set to be greater than the center thickness of the first lens 111, thereby securing installation space for the optical filter 501 and/or cover glass, improving the assembling of components through the distance between the image sensor 300 and the last lens, and enhancing joint reliability. If the BFL does not satisfy Equation 56, some of the emitted light may not be transmitted to the effective region of the image sensor, thereby degrading the resolution. Preferably, 0.3<CT1/BFL<0.9 may be satisfied.

$$2 mm < F < 8 mm \qquad [ Equation 57 ]$$

Equation 57 can set the overall effective focal length (F) to suit a vehicle optical system. Equation 57 may satisfy the ranges: of 2 mm<F<6 mm or 3 mm<F<5 mm.

$$80 degrees < FOV < 150 degrees \qquad [ Equation 58 ]$$

The FOV (Field of View) refers to the diagonal field of view (Degree) of the optical system 1000, and a vehicle optical system can provide a field of view exceeding 80 degrees. Preferably, the FOV may satisfy the condition: 90 degrees<FOV<135 degrees. The FOV may be a minimum value for the reception performance range. Here, the horizontal field of view of the optical system 1000 is less than the diagonal field of view and may exceed 90 degrees, and the vertical field of view is less than the horizontal field of view and may exceed 70 degrees. These horizontal and vertical field of view can improve the reception performance range.

$$1 < T T L / CA\_Max < 3 \qquad [ Equation 59 ]$$

Equation 59 establishes the relationship between the total optical axis length of the optical system and the maximum effective diameter, thereby providing an improved vehicle optical system. Equation 59 preferably satisfies: 1.2<TTL/CA_Max<2, where CA_Max is the effective diameter of the object-side surface of the first lens.

$$2 < TTL / CA 12 < 5 \qquad [ Equation 59 - 1 ]$$

Equation 59-1 satisfies: 3<TTL/CA12<4.5. When Equation 59-1 is satisfied, the amount of light traveling between the first and second lenses may be controlled.

$$5 < TTL / ImgH < 10 \qquad [ Equation 60 ]$$

Equation 60 can set the total optical axis length (TTL) of the optical system and the diagonal length (ImgH) from the optical axis of the image sensor 300. If the optical system 1000 according to the embodiment satisfies Equation 60, the optical system 1000 can have a TTL for application to the vehicle image sensor 300, thereby providing improved image quality. Equation 60 preferably satisfies: 6<TTL/ImgH<9.

$$1 < BFL / ImgH < 3 \qquad [ Equation 61 ]$$

Equation 61 can set the relationship between the optical axis distance (BFL) between the image sensor 300 and the last lens and the diagonal length from the optical axis of the image sensor 300. When the optical system 1000 according to the embodiment satisfies Equation 61, the optical system 1000 can secure a BFL suitable for the size of the vehicle image sensor 300, set the distance between the last lens and the image sensor 300, and have good optical characteristics at the center and periphery of the FOV. Equation 61 preferably satisfies: 1.2<BFL/ImgH<2, and may satisfy the condition: BFL>ImgH.

$$1 < TTL / BFL < 10 \qquad [ Equation 62 ]$$

Equation 62 can set the total optical axis length (TTL) of the optical system and the optical axis distance (BFL) between the image sensor 300 and the last lens. When the optical system 1000 according to the embodiment satisfies Equation 62, the optical system 1000 can secure a back focal length (BFL). That is, by setting the TTL to less than 40 mm, a sufficient BFL may be secured to provide an optical system for a vehicle. Equation 62 preferably satisfies: 3<TTL/BFL<8.

$$5 < TTL / F < 15 \qquad [ Equation 63 ]$$

Equation 63 can set the overall focal length (F) and overall optical axis length (TTL) of the optical system 1000. Accordingly, an optical system for a driver assistance system or driver monitoring may be provided. Equation 63 preferably satisfies: 6<TTL/F<10. When the optical system 1000 according to the embodiment satisfies Equation 63, the optical system 1000 can have an appropriate focal length within the set TTL range, and can provide an optical system that can maintain an appropriate focal length and form an image even when the temperature changes from low to high temperatures. If it is below the lower limit of Equation 63, the power of the lenses needs to be increased, making it difficult to correct spherical aberration or distortion aberration. If it is above the upper limit of Equation 63, the effective diameter or TTL of the lenses may become longer, which may cause the problem of the imaging lens system becoming larger.

$$0 < F / BFL < 2 \qquad [ Equation 64 ]$$

Equation 64 can set the overall effective focal length (F) of the optical system 1000 and the optical axis distance (BFL) between the image sensor 300 and the last lens. If the optical system 1000 according to the embodiment satisfies Equation 64, the optical system 1000 can have a set field of view and an appropriate focal length, and an optical system for a vehicle may be provided. Additionally, the optical system 1000 can minimize the distance between the last lens and the image sensor 300, thereby achieving excellent optical characteristics at the periphery of the FOV. Equation 64 preferably satisfies: 0.4<F/BFL<1.

$$0 < F / ImgH < 2 \qquad [ Equation 65 ]$$

Equation 65 can set the total effective focal length (F) of the optical system 1000 and a value of half (ImgH) of the diagonal length of the image sensor 300. This optical system 1000 can have improved aberration characteristics for the size of the vehicle image sensor 300. Equation 65 preferably satisfies: 0.5<F/ImgH<1.2.

$$0 < F / EPD < 2 \qquad [ Equation 66 ]$$

Equation 66 can set the overall effective focal length (F) and entrance pupil diameter of the optical system 1000. Accordingly, the overall brightness of the optical system may be controlled. Preferably, 0.5<F/EPD<1.5 may be set for Equation 66.

$$0 < BFL / TD < 0.5 \qquad [ Equation 67 ]$$

Equation 67 can set the relationship between the optical axis distance (TD) and the back focal length (BFL) of the lenses of the optical system 1000. Accordingly, the overall size of the optical system may be controlled while maintaining the resolution. Preferably, 0.1<BFL/TD<0.4 may be satisfied for Equation 67. If the conditional value of BFL/TD exceeds 0.5, the BFL is designed to be large relative to the TD, increasing the size of the entire optical system. This makes miniaturization of the optical system difficult. Furthermore, the distance between the third lens and the image sensor increases, which can lead to an increase in unnecessary light through the fourth lens and the image sensor. This can result in deteriorated aberration characteristics and reduced resolution.

$$0 < EPD / ImgH / FOV < 0.2 \qquad [ Equation 68 ]$$

Equation 68 can establish the relationship between the EPD, the length of half (ImgH) of the diagonal length of the image sensor, and the diagonal field of view. Accordingly, the overall size and brightness of the optical system may be controlled. Preferably, Equation 68 satisfies: 0<EPD/ImgH/FOV<0.05.

$$50 < FOV / F \# \qquad [ Equation 69 ]$$

Equation 69 can set the relationship between the diagonal field of view and the F number of an optical system. Preferably, Equation 69 satisfies: 70<FOV/F #. Here, F # is provided to be 2.0 or less, thereby providing a bright image.

$$80 < TTL * nL < 150 \qquad [ Equation 70 ]$$

Equation 70 can set the number of lenses by multiplying the total length of the optical system by the total number (nL) of lenses. Preferably, Equation 70 satisfies: 100<TTL*nL<140. Color dispersion and refraction angles may be controlled by glass lenses in an optical system with a TTL of less than 40 mm.

$$80 < TTL * nGL < 150 \qquad [ Equation 70 - 1 ]$$

Equation 72 can set the number of TTL and glass lenses, and can control chromatic dispersion and refraction angles using glass lenses in an optical system with a TTL of less than 40 mm.

$$12 < ImgH * nL < 20 \qquad [ Equation 71 ]$$

Equation 71 is a value obtained by multiplying half of the diagonal length of the image sensor by the number (nL) of lenses, and can set the length of the image sensor according to the number of lenses. Preferably, Equation 71 satisfies: 14<ImgH*nL<18. Color dispersion and refraction angles may be controlled using glass lenses in an optical system with an ImgH of less than 5 mm.

$$2 < Nss / Nass < 5 \qquad [ Equation 72 ]$$

Equation 72 can set the number of spherical surfaces (Nss) and aspherical surfaces (Nass) among the lens surfaces. When mathematical equation 72 is satisfied, light may be guided to the entire region of the image sensor by adjusting the spherical and aspherical lens surfaces of the lenses.

The optical system 1000 according to the second embodiment may satisfy at least one or two or more mathematical equations from mathematical equations 1 to 36 disclosed above. At least one or two or more of mathematical equations 1 to 36 may satisfy at least one or two or more of mathematical equations 37 to 72. The optical system 1000 has improved optical characteristics and improved resolution, and can improve aberration and distortion characteristics.

Table 3 shows the items of the Equations described above in the optical system 1000 of the embodiment, including the TTL (Total track length) (mm), BFL (Back focal length), effective focal length F (mm), ImgH (mm), effective diameter CA (mm), thickness (mm), TTL (mm), TD (mm), which is the optical axis distance from the first surface S1 to the eighth surface S8, the focal lengths F1, F2, F3, and F4 (mm) of each of the first to third lenses, the sum of the refractive indices, the sum of the Abbe numbers, the sum of the center thicknesses of each lens (mm), the sum of the spacings between adjacent lenses, the diagonal FOV (Degree), the edge thickness ET, the focal lengths of the first and second lens groups, and the F number, etc. of the optical system 1000.

TABLE 3

| Items | Embodiment | Items | Embodiment |
|---|---|---|---|
| F | 3.883 | ET1 | 5.038 |
| F1 | −9.780 | ET2 | 3.258 |
| F2 | 123.295 | ET3 | 2.935 |
| F3 | 15.602 | ET4 | 3.618 |
| F4 | 9.029 | F-number | 1.100 |
| FLG1 | −13.984 | FOV (Diagonal) | 124.280 |
| FLG2 | 7.386 | EPD | 3.530 |
| ΣNd | 6.669 | BFL | 6.172 |
| ΣAd | 150.008 | TD | 23.828 |
| ΣCT | 16.360 | ImgH | 4.000 |
| ΣCG | 7.468 | SD | 9.483 |
| ΣET | 14.850 | TTL | 30.000 |

Table 4 shows the results of Equations 1 to 72 described above in the optical system 1000 of the second embodiment. Referring to Table 4, it may be seen that the optical system 1000 satisfies at least one or two or more of Equations 1 to 36. It may be seen that the optical system 1000 satisfies at least one or two or more of Equations 37 to 72. The optical system may satisfy at least one or two or more of Equations 1 to 72. Accordingly, the optical system 1000 can have good optical performance and superior optical characteristics at the center and periphery of the FOV.

TABLE 4

| Equations | | Values |
|---|---|---|
| 1 | 1 < CT1/CT2 < 2 | 1.182 |
| 2 | 1 < CG1/CT1 < 3 | 2.586 |
| 3 | Po1 < 0 | Satisfaction |
| 4 | 1.75 < Nd4 < 2.2 | 1.62 |
| 5 | L1R1 > 0 | 21.096 |
| 6 | L1R1/L1R2 > \|L2R2/L2R1\| | Satisfaction |
| 7 | 0.5 < CG1/BFL < 1.5 | 1.059 |
| 8 | 1 < CA11/CA12 < 4 | 2.346 |
| 9 | 1 < (CA12*CT1)/(CA21*CT2) < 3 | 1.497 |
| 10 | 0.1 < CT1/(CT3 + CT4) < 1 | 0.471 |
| 11 | 0.5 < CT4/CT3 < 1.5 | 1.218 |
| 12 | 1 < CA11/CA41 < 3 | 1.997 |
| 13 | 1 < CA2/CT2 < 5 | 2.074 |
| 14 | 0.5 < CA22/CA31 < 1.5 | 0.786 |
| 15 | 3 < CT2/CG2 < 12 | 8.716 |
| 16 | 3 < CT3/CG3 < 12 | 7.428 |
| 17 | 0.5 < Max_Sag11/Max_Sag12 < 1.5 | 0.789 |
| 18 | 1.5 < CG1/Max_Sag12 < 3 | 2.136 |
| 19 | 5 < \|Max_Sag42/Max_Sag41\| < 20 | 11.876 |
| 20 | \|Max_Sag22\| < Max_Sag31\| | Satisfaction |
| 21 | CA2/(Imgh*2) < CA3/(Imgh*2) | Satisfaction |
| 22 | CA21 < (Imgh*2) < CA12 | Satisfaction |
| 23 | 1 < DLG1/DLG2 < 2 | 1.524 |
| 24 | 0 < CG1/TTL < 0.3 | 0.137 |
| 25 | 0 < CT3/TTL < 0.3 | 0.132 |
| 26 | 0 < \|L2R1/L3R2\| < 1 | 0.178 |
| 27 | 1 < L4R1/CT4 < 10 | 5.116 |
| 28 | 1 < L1R1/L1R2 < 10 | 4.933 |
| 29 | 0.5 < \|L2R2/L3R1\| < 1.5 | 1.045 |
| 30 | (Nd1*Vd1) < (Nd4*Vd4) | Satisfaction |
| 31 | 0 < CT_Max/CG_Max < 1 | 0.735 |
| 32 | 1 < CT_Max/CT_Min < 3 | 1.378 |
| 33 | (CT_Max/CT_Min) < (CA_Max/CA_Min) | Satisfaction |
| 34 | 1 < ΣCT/ΣCG < 4 | 2.191 |
| 35 | 1 < ΣNd < 10 | 6.669 |
| 36 | 10 < ΣVd/ΣNd < 30 | 22.493 |
| 37 | 1 < CA11/CA_Min < 4 | 2.97 |
| 38 | 1 < CA_ST1/CA_ST2 < 4 | 3.455 |
| 39 | 1 < CA_ST1/CA11 < 1.6 | 1.375 |
| 40 | 0.5 < CA_ST2/CA22 < 1.5 | 0.992 |
| 41 | 1 < CA_Max/(2*ImgH) < 3 | 2.45 |
| 42 | 1 < TD/CA_Max < 3 | 1.216 |
| 43 | 0 < CT_Max/TD < 0.7 | 0.202 |
| 44 | 0 < F/CA41 < 0.5 | 0.112 |
| 45 | 0 < F/L1R1 < 0.3 | 0.052 |
| 46 | 1 < Max (CT/ET) < 3 | 1.344 |
| 47 | 0 < EPD/L1R1 < 1 | 0.167 |
| 48 | 0.5 < \|F1/F4\| < 1.5 | 1.083 |
| 49 | Po3 * Po4 > 0 | Satisfaction |
| 50 | 0 < \|Vd3 − Vd4\| < 10 | 4.624 |
| 51 | 1 < \|F12/F34\| < 3 | 1.893 |
| 52 | 20 < TTL < 40 | 30 |
| 53 | 2 < ImgH | 4 |
| 54 | 3 < BFL < 8 | 6.172 |
| 55 | 0.5 < BFL/CG1 < 1.5 | 0.944 |
| 56 | 0 < CT1/BFL < 1 | 0.668 |
| 57 | 2 < F < 8 | 3.883 |
| 58 | 80 < FOV < 150 | 124.28 |
| 59 | 1 < TTL/CA_Max < 3 | 1.531 |
| 60 | 5 < TTL/ImgH < 10 | 7.5 |
| 61 | 1 < BFL/ImgH < 3 | 1.543 |
| 62 | 1 < TTL/BFL < 10 | 4.861 |
| 63 | 5 < TTL/F < 15 | 7.726 |
| 64 | 0 < F/BFL < 2 | 0.629 |
| 65 | 0 < F/ImgH < 2 | 0.971 |
| 66 | 0 < F/EPD < 2 | 1.1 |
| 67 | 0 < BFL/TD < 0.5 | 0.259 |
| 68 | 0 < EPD/Imgh/FOV < 0.2 | 0.009 |
| 69 | 50 < FOV/F# | 112.981 |
| 70 | 80 < TTL*nL < 150 | 120 |
| 71 | 12 < ImgH*nL < 20 | 16 |
| 72 | 2 < Nss/Nass < 5 | 3 |

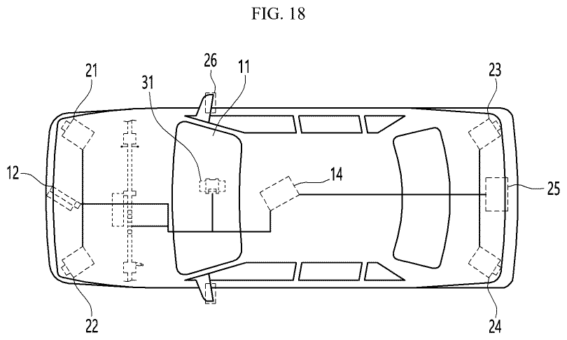

FIG. 18 is an example of a plan view of a vehicle to which a camera module or optical system according to an embodiment of the invention is applied. Referring to FIG. 18, a vehicle camera system according to an embodiment of the invention includes an image generation unit 11, a first information generation unit 12, a second information generation unit 21, 22, 23, 24, 25, and 26, and a control unit (14). The image generation unit (11) may include at least one camera module (31) disposed in the vehicle, and may capture images of the front of the vehicle and/or the driver to generate a front image or an interior image of the vehicle. The image generation unit (11) may capture images of the surroundings of the vehicle in one or more directions as well as the front of the vehicle using the camera module (31), to generate an image of the surroundings of the vehicle. Here, the front image and the surrounding images may be digital images, and may include color images, black and white images, infrared images, etc. In addition, the front image and the surrounding images may include still images and moving images. The image generation unit 11 provides driver images, forward images, and surrounding images to the control unit 14. Next, the first information generation unit 12, which may include at least one radar and/or camera installed in the vehicle, detects the area ahead of the vehicle and generates first detection information. Specifically, the first information generation unit 12 is installed in the vehicle and detects the location and speed of vehicles located in front of the vehicle, the presence and location of pedestrians, and other factors to generate first detection information.

Using the first detection information generated by the first information generation unit 12, the vehicle may be controlled to maintain a constant distance between the vehicle and the preceding vehicle. This can enhance vehicle operation stability in specific, preset situations, such as when the driver changes lanes or when backing up. The first information generation unit 12 provides the first detection information to the control unit 14. The second information generation unit 21, 22, 23, 24, 25, and 26 detects each side of the own vehicle based on the front image generated by the image generation unit 11 and the first detection information generated by the first information generation unit 12 to generate second detection information. Specifically, the second information generation unit 21, 22, 23, 24, 25, and 26 may include at least one radar and/or camera disposed in the own vehicle, and may detect the position and speed of vehicles located on the side of the own vehicle or capture images. Here, the second information generation units 21, 22, 23, 24, 25, and 26 may be disposed at each of the front corners, side mirrors, and the rear center and rear corners of the own vehicle.

At least one information generation unit of these vehicle camera systems may include the optical system and the camera module having the same as described in the above-described embodiments, and may provide or process information acquired through the front, rear, each side, or corner region of the vehicle to a user to enable autonomous driving or to protect the vehicle and objects from surrounding safety. The optical system of the camera module according to the embodiment of the invention may be applied to a camera or sensing device for LiDAR to recognize the surrounding environment of a moving object such as a vehicle in real time. In addition, the camera module according to the embodiment of the invention may be installed in multiple units in a vehicle to enhance safety regulations, autonomous driving functions, and increase convenience by using an Advanced driving assistance system (ADAS). In addition, the optical system of the camera module is applied in a vehicle as a component for control such as a lane keeping assistance system (LKAS), a lane departure warning system (LDWS), and a driver monitoring system (DMS). The optical system and camera module including the optical system disclosed in the embodiments of the invention can achieve stable optical performance even under ambient temperature changes and provide a cost-competitive module, thereby ensuring the reliability of vehicle components.

Features, structures, effects, etc. described in the embodiments above are included in at least one embodiment of the invention, and are not necessarily limited to only one embodiment. Furthermore, the features, structures, and effects illustrated in each embodiment may be combined or modified with respect to other embodiments by those skilled in the art in the field to which the embodiments belong. Therefore, contents related to these combinations and variations should be construed as being included in the scope of the invention. In addition, although described based on the embodiments, this is only an example, this invention is not limited, and it will be apparent to those skilled in the art that various modifications and applications not illustrated above are possible without departing from the essential characteristics of this embodiment. For example, each component specifically shown in the embodiment may be modified and implemented. And the differences related to these modifications and applications should be construed as being included in the scope of the invention as defined in the appended claims.

1. An optical system comprising:
first to third lenses aligned along an optical axis from an object toward an image sensor; and
an optical filter disposed between the second and third lenses,
wherein the first lens has a negative power,
wherein the first to third lenses include at least one spherical lens adjacent to the object and at least one aspherical lens adjacent to the image sensor,
wherein a number of spherical lenses among the first to third lenses is greater than a number of aspherical lenses,
wherein a center distance between the first and second lenses is greater than a center thickness of the first lens,
wherein the second lens has a biconvex shape on the optical axis,
wherein refractive indices of the first to third lenses are less than 1.9, and
wherein a lens closest to the image sensor has a biconvex shape on the optical axis.

2. The optical system of claim 1, wherein between the second and third lenses a center distance is less than an edge distance.

3. The optical system of claim 1, wherein the first lens includes a concave sensor-side surface on the optical axis, and
wherein between the first lens and the second lens a center distance is greater than an edge distance.

4. The optical system of claim 1, wherein the third lens has a biconvex shape on the optical axis, and
wherein a sensor-side surface of the third lens has a critical point between the optical axis and an end of an effective region.

5. The optical system of claim 1, comprising an inner aperture stop disposed around a region between the first lens and the second lens.

6. The optical system of claim 5, wherein an object-side surface of the first lens is convex on the optical axis, and
wherein the optical system comprises an upper aperture stop disposed around the object-side surface of the first lens.

7. The optical system of claim 6, wherein the upper aperture stop is disposed between a straight line perpendicular to an apex of the object-side surface of the first lens and a straight line perpendicular to an edge of the object-side surface of the first lens.

8. The optical system of claim 1, wherein the first to third lenses are made of glass,
wherein the first and second lenses are spherical lenses,
wherein the third lens is an aspherical lens, and
wherein an average refractive index of the lenses in the optical system is 1.7 or more.

9. The optical system of claim 1, wherein an optical axis distance from a center of an object-side surface of the first lens to a surface of the image sensor is TTL,
wherein an optical axis distance from a center of a sensor-side surface of the third lens to the surface of the image sensor is BFL,
wherein the following equation satisfies: 3<TTL/BFL<8.

10. The optical system of claim 1, wherein an optical axis distance from a center of an object-side surface of the first lens to a surface of the image sensor is TTL,
wherein half of a diagonal length of the image sensor is ImgH,
wherein the following equation satisfies: 5<TTL/ImgH<10.

11. An optical system comprising:
first to fourth lenses aligned along an optical axis from an object toward an image sensor,
wherein a power of the first lens is negative,
wherein the first to fourth lenses include at least one spherical lens adjacent to the object and at least one aspherical lens adjacent to the image sensor,
wherein a number of spherical lenses among the first to fourth lenses is greater than a number of aspherical lenses,
wherein a distance between the first lens and the second lens is such that a center distance is greater than an edge distance,
wherein the third lens includes a convex object-side surface and a concave sensor-side surface on the optical axis, and
wherein a lens closest to the image sensor has a biconvex shape on the optical axis.

12. The optical system of claim 11, wherein a distance between the second and third lenses is such that a center distance is smaller than an edge distance.

13. The optical system of claim 11, wherein the first lens includes a sensor-side surface that is concave on the optical axis, and the second lens includes an object-side surface that is concave on the optical axis.

14. The optical system of claim 11, wherein the aspherical lens is the fourth lens and is the lens closest to the image sensor, and an object-side surface of the fourth lens has a critical point between the optical axis and an end of an effective region.

15. The optical system of claim 11, comprising an inner aperture stop arranged around a region between the second lens and the third lens.

16. The optical system of claim 11,
wherein the first to fourth lenses are made of glass,
wherein the first to third lenses are spherical lenses, and
wherein the fourth lens is an aspherical lens,
wherein an average refractive index of the spherical lenses is smaller than a refractive index of the aspherical lens.

17. The optical system of claim 11,
wherein an optical axis distance from a center of an object-side surface of the first lens to a surface of the image sensor is TTL,
wherein an optical axis distance from a center of a sensor-side surface of the fourth lens to the surface of the image sensor is BFL,
wherein the following Equation satisfies: 3<TTL/BFL<8.

18. The optical system of claim 1,
wherein an average Abbe number of the spherical lenses is less than an Abbe number of the aspherical lens.

19. The optical system of claim 1,
wherein an average refractive index of the spherical lenses is less than a refractive index of the aspherical lens.

20. The optical system of claim 1,
wherein the optical filter is disposed between a convex sensor-side surface of the second lens and a convex object-side surface of the third lens.
